(19) United States
(12) Patent Application Publication
(10) Pub. No.: US 2021/0035142 A1
(43) Pub. Date: Feb. 4, 2021

(54) SYSTEM AND METHOD FOR PROMOTING PRODUCT SALES

(71) Applicant: SV INC., Seoul (KR)

(72) Inventors: Yong Hyun Kang, Suwon-si (KR); Du Hyun Kim, Seoul (KR)

(21) Appl. No.: 17/073,185

(22) Filed: Oct. 16, 2020

Related U.S. Application Data
(63) Continuation-in-part of application No. 16/054,905, filed on Aug. 3, 2018, now abandoned.
Application No. 16/054,905 is a continuation of application No. PCT/KR2017/000761, filed on Jan. 23, 2017.
Application No. PCT/KR2017/000761 is a continuation-in-part of application No. 16/056,273, filed on Aug. 6, 2018.
Application No. 16/056,273 is a continuation of application No. PCT/KR2017/000762, filed on Jan. 23, 2017.
Application No. PCT/KR2017/000762 is a continuation-in-part of application No. 16/056,297, filed on Aug. 6, 2018.
Application No. 16/056,297 is a continuation of application No. PCT/KR2017/000765, filed on Jan. 23, 2017.
Application No. PCT/KR2017/000765 is a continuation-in-part of application No. 16/056,334, filed on Aug. 6, 2018, now abandoned.
Application No. 16/056,334 is a continuation of application No. PCT/KR2017/000766, filed on Jan. 23, 2017.
Application No. PCT/KR2017/000766 is a continuation-in-part of application No. 16/056,371, filed on Aug. 6, 2018, now abandoned.
Application No. 16/056,371 is a continuation of application No. PCT/KR2017/000767, filed on Jan. 23, 2017.
Application No. PCT/KR2017/000767 is a continuation-in-part of application No. 16/056,404, filed on Aug. 6, 2018.
Application No. 16/056,404 is a continuation of application No. PCT/KR2017/000768, filed on Jan. 23, 2017.

(30) Foreign Application Priority Data
Feb. 6, 2016 (KR) 10-2016-0015339
Apr. 22, 2016 (KR) 10-2016-0049633
May 2, 2016 (KR) 10-2016-0054321
Jun. 11, 2016 (KR) 10-2016-0072814
Jun. 13, 2016 (KR) 10-2016-0073451
Jun. 27, 2016 (KR) 10-2016-0080489
Jul. 4, 2016 (KR) 10-2016-0084447

(51) Int. Cl. G06Q 30/02; G06Q 40/02; G06Q 30/06; G06F 7/08

(52) U.S. Cl. CPC G06Q 30/0215; G06Q 30/0235; G06Q 30/0201; G06Q 40/04; G06Q 40/02; G06Q 30/0637; G06F 7/08; G06Q 30/0236

(57) ABSTRACT

The disclosed technology for distributing a portion of a sales profit to purchasers if a product selling event is successful, thereby promoting product sales, wherein the sales profit distribution system may include a product payment unit adapted to allow a payment for the product to be made through a terminal of the purchaser; and a profit distribution unit adapted to calculate an individual distribution profit to be distributed to the purchaser from the distribution profit, and the sales profit distribution method may include the steps of: (a) performing a payment for the product by a terminal of the purchaser through a product payment unit; and (b) calculating an individual distribution profit to be distributed to the purchaser from the distribution profit through a profit distribution unit.

### CROSS-REFERENCE TO RELATED APPLICATION(S)

This application is a continuation-in-part of U.S. patent application Ser. No. 16/054,905 filed on Aug. 3, 2018, which application claims priority to and the benefit of PCT Application No. PCT/KR2017/000761 filed on Jan. 23, 2017, which claims priorities to Korean Patent Application No. 10-2016-0015339 fled on Feb. 6, 2016 and Korean Patent Application No. 10-2016-0049633 filed on Apr. 22, 2016. This application is a continuation-in-part of U.S. patent application Ser. No. 16/056,273 filed on Aug. 6, 2018, which application claims priority to and the benefit of PCT Application No. PCT/KR2017/000762 filed on Jan. 23, 2017 which claims priorities to Korean Patent Application No. 10-2016-0015339 filed on Feb. 6, 2016 and Korean Patent Application No. 10-2016-0054321 filed on May 2, 2016. This application is a continuation-in-part of U.S. patent application Ser. No. 16/056,297 filed on Aug. 6, 2018, which application claims priority to and the benefit of PCT Application No. PCT/KR2017/000765 filed on Jan. 23, 2017 which claims priorities to Korean Patent Application No. 10-2016-0015339 filed on Feb. 6, 2016 and Korean Patent Application No. 10-2016-0072814 filed on Jun. 11, 2016. This application is a continuation-in-part of U.S. patent application Ser. No. 16/056,334 filed on Aug. 6, 2018, which application claims priority to and the benefit of PCT Application No. PCT/KR2017/000766 filed on Jan. 23, 2017 which claims priorities to Korean Patent Application No. 10-2016-0015339 filed on Feb. 6, 2016 and Korean Patent Application No. 10-2016-0073451 filed on Jun. 13, 2016. This application is a continuation-in-part of U.S. patent application Ser. No. 16/056,371 filed on Aug. 6, 2018, which application claims priority to and the benefit of PCT Application No. PCT/KR2017/000767 filed on Jan. 23, 2017 which claims priorities to Korean Patent Application No. 10-2016-0015339 filed on Feb. 6, 2016 and Korean Patent Application No. 10-2016-0080489 filed on Jun. 27, 2016. This application is a continuation-in-part of U.S. patent application Ser. No. 16/056,404 filed on Aug. 6, 2018, which claims priority to and the benefit of PCT Application No. PCT/KR2017/000768 filed on Jan. 23, 2017 which claims priorities to Korean Patent Application No. 10-2016-0015339 filed on Feb. 6, 2016 and Korean Patent Application No. 10-2016-0084447 filed on Jul. 4, 2016. The above applications are all hereby incorporated by reference for all purposes as if fully set forth herein.

### TECHNICAL FIELD

Some implementations of the disclosed technology relate to a system and method for promoting sales and/or distributing sale profits.

### BACKGROUND

A consumption behavior in a conventional economic system is carried out by paying for a product in cash to obtain the product. Under such a structure, as more consumption is made, the cash assets of a consumer are reduced, so that the consumer has to stop or cut down his or her consumption so as to increase or maintain his or her cash assets.

If an economic depression occurs, the consumer reduces his or her consumption, and thus, product sales are reduced. Subsequently, product sellers reduce the number of workers or their wage due to the decrease of their sales, and therefore, the consumer's income becomes reduced, so that he or she reduces the consumption more and more, thereby making such a vicious circle to be repeated under such a structure.

If the cash assets of the consumer are increased as he or she increases consumption, however, the opposite phenomena to those mentioned above may occur. In detail, the consumer increases his or her consumption more, and accordingly, product sales are drastically increased. Also, the product sellers increase the number of workers or their wage through the drastic increase of their sales. Therefore, the consumer's income increase as well, which allows his or her consumption to increase as well. If such an economic system is achieved and continued, the world economy will be in the boom years.

### SUMMARY

Various implementations of the disclosed technology are provided to schemes for distributing a portion of sales profits to increase the assets of the purchasers so that the product sales are promoted. In some implementations, the sales profits are also distributed to non-purchasers who satisfy certain conditions as well as the purchasers.

Some implementation of the disclosed technology provides a product sales promotion system including: an event configuration unit adapted to allow at least one of sales price of a product, a target period of time for product sales, a target amount of product sales to be inputted thereto through a terminal of a seller, to allow an event which is successful when the target amount of product sales is achieved for the target period of time for the product sales to be configured thereon through the terminal of the seller, and to allow at least one of an amount of distribution profit to be distributed to purchasers who purchase the product when the event is successful, a distribution way of the distribution profit, and a distribution rate of the distribution profit to be inputted thereto through the terminal of the seller; a product payment unit adapted to allow a payment for the product to be made through a terminal of the purchaser; an event management unit for activating the event and checking whether the number of payments for the product made by the product payment unit reaches the target amount of product sales; and a profit distribution unit for paying the distribution profit to the purchasers, when it is checked by the event management unit that the event is successful.

In some implementations, before the event is activated, the event management unit may transfer an event notification message of notifying a member joining in the product sales promotion system of a start date and a start time of the event activation to the terminal of the member. In some implementations, the event management unit may activate the event after a given period of a standby time from a start time of the event activation. In some implementations, the event configuration unit may receive a guaranteed amount lower than the sales price of the product from the terminal of the seller, and the payment made in the event management unit may be the payment for the guaranteed amount or for the sales price. In some implementations, the product sales promotion system may further include: a system account unit for depositing the amount made by the payment; and a member account unit applied to the member joining in the product sales promotion system to allow at least one of cyber money and cash to be deposited thereinto. In some implementations, before or at the same time the event activation starts, an event deposit of the seller having the same amount as the distribution profit may be transferred from the member account unit of the seller into the system account unit. In some implementations, the event management unit may transfer a sales price additional payment request to a terminal of the a purchaser who makes a payment only for the guaranteed amount (hereinafter, referred to as “guaranteed amount payment purchaser”), and when the guaranteed amount payment purchaser make a sales price additional payment through the terminal in the product payment unit, the event management unit may transfer the amount corresponding to the guaranteed amount from the amount deposited into the system account unit into the member account unit of a guaranteed amount payment purchaser who make the sales price additional payment (hereinafter, referred to as “sales price additional payment purchaser”). In some implementations, the product sales promotion system may further include a delivery management unit for transferring a delivery address of a purchaser who makes a payment for the sales price, without a payment for the guaranteed amount (hereinafter, referred to as “sales price payment purchaser”) and a delivery address of the sales price additional payment purchaser to the terminal of the seller.

In some implementations, the product sales promotion system may further include a purchase confirmation management unit for transferring a purchase confirmation request to the terminal of the sales price payment purchaser and the terminal of the sales price additional payment purchaser to receive the response to the purchase confirmation request from the terminal of the sales price payment purchaser and the terminal of the sales price additional payment purchaser, wherein when the response to the purchase confirmation request is a purchase cancel response. In some implementations, the profit distribution unit may transfer the amount corresponding to the sales price to the member account units of the sales price payment purchaser and the sales price additional payment purchaser, and when it is checked by the event management unit that the event is successful, the profit distribution unit may transfer the amount calculated by subtracting the amount corresponding to the guaranteed amount from the sales price to the member account units of the sales price payment purchaser and the sales price additional payment purchaser. In some implementations, the profit distribution unit may transfer the amount calculated by subtracting the amount corresponding to the guaranteed amount from the sales price to the member account units of the sales price payment purchaser and the sales price additional payment purchaser, and when it is checked by the event management unit that the event fails, the profit distribution unit may transfer the amount corresponding to the guaranteed amount to the member account units of the sales price payment purchaser and the sales price additional payment purchaser. In some implementations, when it is checked by the event management unit that the event is successful, the profit distribution unit may determine individual distribution profits to be distributed to the sales price payment purchaser and the sales price additional payment purchaser who perform the purchase confirmation response (hereinafter, referred to as “purchase confirmation purchasers”) by applying the distribution way of the distribution profit and the distribution rate of the distribution profit to the distribution profit, and the profit distribution unit may transfer the individual distribution profits from the amount kept in the system account unit into the member account units of the purchase confirmation purchasers.

In some implementations, the product sales promotion system may further include a minimum guaranteed amount calculation unit for notifying the terminal of the seller of a minimum guaranteed amount, when the event configuration unit receives the guaranteed amount from the terminal of the seller, the minimum guaranteed amount being calculated by dividing the largest amount among the individual distribution profits calculated when the event is successful into the target amount of product sales. In some implementations, the product sales promotion system may further include a minimum guaranteed amount calculation unit for notifying the terminal of the seller of a minimum guaranteed amount, when the event configuration unit receives the guaranteed amount from the terminal of the seller, the minimum guaranteed amount being calculated by dividing the event deposit into the target amount of product sales. In some implementations, the distribution way of the distribution profit may include the steps of: arranging the purchase confirmation purchasers in the order of payment; paying a first individual distribution profit calculated by multiplying the distribution profit and the distribution rate of the distribution profit to a first purchase confirmation purchaser who performs the most rapid payment among the purchase confirmation purchasers; and paying a second individual distribution profit calculated by multiplying the amount remaining by subtracting the first individual distribution profit from the distribution profit and the distribution rate of the distribution profit to a second purchase confirmation purchaser who performs the most rapid payment in the second order among the purchase confirmation purchasers.

In some implementations, the member account unit may include a cyber money account in which cyber money is deposited, and the distribution way of the distribution profit includes the steps of: arranging the purchase confirmation purchasers in the order of a value calculated by multiplying the cyber money amount of the cyber money accounts of the purchase confirmation purchasers and the number of payments of the purchase confirmation purchasers (hereinafter, referred to as “cyber money amount for order”); paying a first individual distribution profit calculated by multiplying the distribution profit and the distribution rate of the distribution profit to a first purchase confirmation purchaser who has the largest cyber money amount for order among the purchase confirmation purchasers; and paying a second individual distribution profit calculated by multiplying the amount remaining by subtracting the first individual distribution profit from the distribution profit and the distribution rate of the distribution profit to a second purchase confirmation purchaser who has the largest cyber money amount for order in the second order among the purchase confirmation purchasers.

In some implementations, when the payment is performed, the profit distribution unit may transfer expected distribution order in which the purchasers who perform the payment are arranged in order according to the distribution way of the distribution profit to the terminals of the purchasers who perform the payment. In some implementations, the expected distribution order may be made by arranging the purchasers who perform the payment in the order of the payment. In some implementations, the expected distribution order may be made by arranging the purchasers who perform the payment in the order of a value obtained by multiplying the cyber money amount deposited into the cyber money accounts included in the member account units of the purchaser who performs the payment and the number of payments. In some implementations, the expected distribution order may be made by arranging the purchasers who perform the payment in the order of the sales price payment. In some implementations, the expected distribution order may be made by arranging the purchasers who perform the payment in the order of the purchase confirmation response of the purchasers who perform the payment with respect to the purchase confirmation request transferred from the purchase confirmation management unit to the terminals of the purchasers who perform the payment.

Some implementation of the disclosed technology provides a product sales promotion method including the steps of: (a) inputting at least one of sales price of the product, a target period of time for product sales, a target amount of product sales to an event configuration unit through a terminal of the seller: (b) configuring an event which is successful when the target amount of product sales is achieved for the target period of time for product sales on the event configuration unit through the terminal of the seller, and inputting at least one of an amount of distribution profit to be distributed to the purchasers when the event is successful, a distribution way of the distribution profit, and a distribution rate of the distribution profit to the event configuration unit through the terminal of the seller; (c) activating the event through an event management unit; (d) performing a payment for the product by a terminal of the purchaser through a product payment unit; (e) checking whether the number of payments for the product made by the product payment unit reaches the target amount of product sales, through the event management unit; and (f) paying the distribution profit to the purchasers through a profit distribution unit when it is checked by the event management unit that the event is successful.

In some implementations, the product sales promotion method may further include, before the step (c), the step of transferring an event notification message that notifies a member joining in the product sales promotion system of a start date and a start time of the event activation to the terminal of the member, through the event management unit. In some implementations, the step (c) may include the step of activating the event after a given period of a standby time from a start time of the event activation, through the event management unit. In some implementations, the product sales promotion method may further include, before the step (c), the step of receiving a guaranteed amount lower than the sales price of the product from the terminal of the seller, through the event configuration unit, and the payment made in the event management unit is the payments for the guaranteed amount or for the sales price. In some implementations, the product sales promotion method may further include, before or at the same time the step (c), the step of transferring an event deposit of the seller having the same amount as the distribution profit from the member account unit of the seller into a system account unit. In some implementations, the product sales promotion method may further include, after the step (d), the step of depositing the amounts made by the payments into the system account unit. In some implementations, the step (d) may include the steps of: allowing the terminal of the purchaser to make a payment for the guaranteed amount of the product, through the product payment unit; transferring a sales price additional payment request to the terminal of the purchaser who makes a payment only for the guaranteed amount (hereinafter, referred to as “guaranteed amount payment purchaser”), through the event management unit; allowing the terminal of the guaranteed amount payment purchaser to make a sales price additional payment, through the product payment unit; and transferring the amount corresponding to the guaranteed amount from the amount deposited into the system account unit to the member account unit of the guaranteed amount payment purchaser who makes the sales price additional payment (hereinafter, referred to as “sales price additional payment purchaser”).

In some implementations, the product sales promotion method may further include, after the step (d), the step of transferring a delivery address of the purchaser who makes a payment for the sales price to purchase the product (hereinafter, referred to as “sales price payment purchaser”) and a delivery address of the sales price additional payment purchaser to the terminal of the seller, through a delivery management unit. In some implementations, the product sales promotion method may further include, after the step (d), the steps of: transferring a purchase confirmation request to the terminal of the sales price payment purchaser and the terminal of the sales price additional payment purchaser, through a purchase confirmation management unit; receiving the response to the purchase confirmation request from the terminal of the sales price payment purchaser and the terminal of the sales price additional payment purchaser through the purchase confirmation management unit; and when the response to the purchase confirmation request is a purchase cancel response, transferring the amount corresponding to the sales price to the member account units of the sales price payment purchaser and the sales price additional payment purchaser, through the profit distribution unit, and when it is checked by the event management unit that the event is successful, transferring the amount calculated by subtracting the amount corresponding to the guaranteed amount from the amount corresponding to the sales price to the member account units of the sales price payment purchaser and the sales price additional payment purchaser, through the profit distribution unit.

In some implementations, the product sales promotion method may further include, after the step (d), the steps of: transferring a purchase confirmation request to the terminal of the sales price payment purchaser and the terminal of the sales price additional payment purchaser, through a purchase confirmation management unit; receiving the response to the purchase confirmation request from the terminal of the sales price payment purchaser and the terminal of the sales price additional payment purchaser; and when the response to the purchase confirmation request is a purchase cancel response, transferring the amount calculated by subtracting the amount corresponding to the guaranteed amount from the sales price to the member account units of the sales price payment purchaser and the sales price additional payment purchaser, through the profit distribution unit, and when it is checked by the event management unit that the event fails, transferring the amount corresponding to the guaranteed amount to the member account units of the sales price payment purchaser and the sales price additional payment purchaser, through the profit distribution unit.

In some implementations, the product sales promotion method may further include, after the step (d), the steps of: transferring a purchase confirmation request to the terminal of the sales price payment purchaser and the terminal of the sales price additional payment purchaser, through a purchase confirmation management unit; and receiving the response to the purchase confirmation request from the terminal of the sales price payment purchaser and the terminal of the sales price additional payment purchaser through the purchase confirmation management unit, wherein the step (f) includes the steps of: when a purchase confirmation response is received through the purchase confirmation management unit and when it is checked by the event management unit that the event is successful, determining individual distribution profits to be distributed to the sales price payment purchaser and the sales price additional payment purchaser who perform the purchase confirmation response (hereinafter, referred to as “purchase confirmation purchasers”) by applying the distribution way of the distribution profit and the distribution rate of the distribution profit to the distribution profit, through the profit distribution unit; and transferring the individual distribution profits from the amount kept in the system account unit into the member account units of the purchase confirmation purchasers, through the profit distribution unit.

In some implementations, the product sales promotion method may further include the step of notifying the terminal of the seller of a minimum guaranteed amount, before the step of receiving the guaranteed amount lower than the sales price from the terminal of the seller through the event configuration unit, the minimum guaranteed amount being calculated by dividing the largest amount among the individual distribution profits calculated when the event is successful into the target amount of product sales. In some implementations, the product sales promotion method may further include the step of notifying the terminal of the seller of a minimum guaranteed amount, before the step of receiving the guaranteed amount lower than the sales price from the terminal of the seller through the event configuration unit, the minimum guaranteed amount being calculated by dividing the event deposit into the target amount of product sales. In some implementations, the distribution way of the distribution profit may include the step of: arranging the purchase confirmation purchasers in the order of payment; paying a first individual distribution profit calculated by multiplying the distribution profit and the distribution rate of the distribution profit to a first purchase confirmation purchaser who performs the most rapid payment among the purchase confirmation purchasers; and paying a second individual distribution profit calculated by multiplying the amount remaining by subtracting the first individual distribution profit from the distribution profit and the distribution rate of the distribution profit to a second purchase confirmation purchaser who performs the most rapid payment in the second order among the purchase confirmation purchasers.

In some implementations, the distribution way of the distribution profit may include the step of: arranging the purchase confirmation purchasers in the order of a value calculated by multiplying the cyber money amount of the cyber money accounts of the purchase confirmation purchasers and the number of payments of the purchase confirmation purchaser (hereinafter, referred to as “cyber money amount for order”); paying a first individual distribution profit calculated by multiplying the distribution profit and the distribution rate of the distribution profit to a first purchase confirmation purchaser who has the largest cyber money amount for order among the purchase confirmation purchasers; and paying a second individual distribution profit calculated by multiplying the amount remaining by subtracting the first individual distribution profit from the distribution profit and the distribution rate of the distribution profit to a second purchase confirmation purchaser who has the largest cyber money amount for order in the second order among the purchase confirmation purchasers. In some implementations, the distribution way of the distribution profit may include the step of: arranging the purchase confirmation purchasers in the order of sales price payment; paying a first individual distribution profit calculated by multiplying the distribution profit and the distribution rate of the distribution profit to a first purchase confirmation purchaser who performs the most rapid sales price payment among the purchase confirmation purchasers; and paying a second individual distribution profit calculated by multiplying the amount remaining by subtracting the first individual distribution profit from the distribution profit and the distribution rate of the distribution profit to a second purchase confirmation purchaser who performs the most rapid sales price payment in the second order among the purchase confirmation purchasers.

In some implementations, the distribution way of the distribution profit may include the step of: arranging the purchase confirmation purchasers in the order of purchase confirmation response; paying a first individual distribution profit calculated by multiplying the distribution profit and the distribution rate of the distribution profit to a first purchase confirmation purchaser who performs the most rapid purchase confirmation response among the purchase confirmation purchasers; and paying a second individual distribution profit calculated by multiplying the amount remaining by subtracting the first individual distribution profit from the distribution profit and the distribution rate of the distribution profit to a second purchase confirmation purchaser who performs the most rapid purchase confirmation response in the second order among the purchase confirmation purchasers. In some implementations, the step (d) may include the step of transferring expected distribution order in which the purchasers who perform the payment are arranged in order according to the distribution way of the distribution profit to the terminals of the purchasers who perform the payment, through the profit distribution unit, when the payment is performed. In some implementations, the expected distribution order may be made by arranging the purchasers who perform the payment in the order of the payment. In some implementations, the expected distribution order may be made by arranging the purchasers who perform the payment in the order of a value obtained by multiplying the cyber money amount deposited into the cyber money accounts included in the member account units of the purchaser who performs the payment and the number of payments. In some implementations, the expected distribution order may be made by arranging the purchasers who perform the payment in the order of the sales price payment. In some implementations, the expected distribution order may be made by arranging the purchasers who perform the payment in the order of the purchase confirmation response of the purchasers who perform the payment with respect to the purchase confirmation request transferred from the purchase confirmation management unit to the terminals of the purchasers who perform the payment.

Some implementation of the disclosed technology provides a sales profit distribution system adapted to distribute a distribution profit to a purchaser who purchases a product when a target amount of product sales is reached within a target period of time for the product sales and to include a product payment unit adapted to allow a payment for the product to be made through a terminal of the purchaser; and a profit distribution unit adapted to calculate an individual distribution profit to be distributed to the purchaser from the distribution profit.

In some implementations, the profit distribution unit may perform a method of calculating the individual distribution profit, the method including the steps of: arranging the purchasers in an order of payment; paying a first individual distribution profit calculated by multiplying the distribution profit by a distribution rate of the distribution profit to a first purchaser who performs an earliest payment among the purchasers; and paying a second individual distribution profit calculated by multiplying an amount remained after subtracting the first individual distribution profit from the distribution profit by the distribution rate of the distribution profit to a second purchaser who performs a second earliest payment among the purchasers.

In some implementations, the sales profit distribution system may further include a member account unit allocated to a member who is joined in the sales profit distribution system to deposit at least one of cyber money and cash thereinto, and the profit distribution unit may perform a method of calculating the individual distribution profit, the method including the steps of: arranging the purchasers in an order of a cyber money amount deposited into member account unit of the purchaser; paying a first individual distribution profit calculated by multiplying the distribution profit by the distribution rate of the distribution profit to a first purchaser who has a largest cyber money amount among the purchasers; and paying a second individual distribution profit calculated by multiplying an amount remained after subtracting the first individual distribution profit from the distribution profit by the distribution rate of the distribution profit to a second purchaser who has a second largest cyber money amount among the purchasers.

In some implementations, the sales profit distribution system may further include a member account unit allocated to a member who is joined in the sales profit distribution system to deposit at least one of cyber money and cash thereinto, and the profit distribution unit may perform a method of calculating the individual distribution profit, the method including the steps of: arranging the purchasers in an order of a value calculated by multiplying a cyber money amount deposited into the member account unit of the purchaser by the number of the payments of the purchaser (hereinafter, referred to as a “cyber money amount for order”); paying a first individual distribution profit calculated by multiplying the distribution profit by the distribution rate of the distribution profit to a first purchaser who has a largest cyber money amount for order among the purchasers; and paying a second individual distribution profit calculated by multiplying an amount remained after subtracting the first individual distribution profit from the distribution profit by the distribution rate of the distribution profit to a second purchaser who has a second largest cyber money amount for order among the purchasers.

In some implementations, the sales profit distribution system may further include a purchase confirmation management unit adapted to transmit a purchase confirmation request to a terminal of the purchaser and to receive a purchase confirmation response or a purchase cancel response as a response to the purchase confirmation request from the terminal of the purchaser, and the profit distribution unit may perform a method of calculating the individual distribution profit, the method comprising the steps of: arranging the purchasers in an order of purchase confirmation response, paying a first individual distribution profit calculated by multiplying the distribution profit by the distribution rate of the distribution profit to a first purchaser who transmits an earliest purchase confirmation response among the purchasers; and paying a second individual distribution profit calculated by multiplying an amount remained after subtracting the first individual distribution profit from the distribution profit by the distribution rate of the distribution profit to a second purchaser who transmits a second earliest purchase confirmation response among the purchasers.

Some implementation of the disclosed technology provides a sales profit distribution method distributing a distribution profit to a purchaser who purchases a product when a target amount of product sales is reached within a target period of time for the product sales and including the steps of: (a) performing a payment for the product by a terminal of the purchaser through a product payment unit; and (b) calculating an individual distribution profit to be distributed to the purchaser from the distribution profit through a profit distribution unit.

In some implementations, the step (b) may include the steps of: arranging the purchasers in an order of payment; paying a first individual distribution profit calculated by multiplying the distribution profit by a distribution rate of the distribution profit to a first purchaser who performs an earliest payment among the purchasers; and paying a second individual distribution profit calculated by multiplying an amount remained after subtracting the first individual distribution profit from the distribution profit by the distribution rate of the distribution profit to a second purchaser who performs a second earliest payment among the purchasers.

In some implementations, the step (b) may include the steps of: arranging the purchasers in an order of a cyber money amount deposited into member account unit of the purchaser; paying a first individual distribution profit calculated by multiplying the distribution profit by the distribution rate of the distribution profit to a first purchaser who has a largest cyber money amount among the purchasers; and paying a second individual distribution profit calculated by multiplying an amount remained after subtracting the first individual distribution profit from the distribution profit by the distribution rate of the distribution profit to a second purchaser who has a second largest cyber money amount among the purchasers.

In some implementations, the step (b) may include the steps of: arranging the purchasers in an order of a value calculated by multiplying a cyber money amount unit deposited into the member account of the purchaser by the number of the payments of the purchaser (hereinafter, referred to as a “cyber money amount for order”); paying a first individual distribution profit calculated by multiplying the distribution profit by the distribution rate of the distribution profit to a first purchaser who has a largest cyber money amount for order among the purchasers; and paying a second individual distribution profit calculated by multiplying an amount remained after subtracting the first individual distribution profit from the distribution profit by the distribution rate of the distribution profit to a second purchaser who has a second largest cyber money amount for order among the purchasers.

In some implementations, the sales profit distribution method may further include, before the step (b), the steps of transmitting a purchase confirmation request to a terminal of the purchaser and receiving a purchase confirmation response or a purchase cancel response as a response to the purchase confirmation request from the terminal of the purchaser through a purchase confirmation management unit, and the step (b) may include the steps of: arranging the purchasers in an order of purchase confirmation response; paying a first individual distribution profit calculated by multiplying the distribution profit by the distribution rate of the distribution profit to a first purchaser who transmits an earliest purchase confirmation response among the purchasers; and paying a second individual distribution profit calculated by multiplying an amount remained after subtracting the first individual distribution profit from the distribution profit by the distribution rate of the distribution profit to a second purchaser who transmits a second earliest purchase confirmation response among the purchasers.

Some implementation of the disclosed technology provides a product sales promotion system for selling products on online including: a product payment unit adapted to allow a payment for a sales price of a product to be made through a terminal of a purchaser; a member account unit allocated to a member who joins the product sales promotion system to allow cyber money to be deposited thereinto; an order calculation unit adapted to determine a distribution order in an order of a cyber money amount deposited in the member account unit; and a dividend distribution unit adapted to distribute cyber money corresponding to a portion of a dividend obtained by multiplying a paid amount for the sales price by a dividend distribution rate to the purchaser and to further distribute cyber money corresponding to a remaining dividend to members who rank ahead the purchaser in the distribution order (hereinafter, referred to as “priority members”) and the purchaser.

In some implementations, the dividend distribution unit may transfer a purchaser dividend obtained by multiplying the dividend by a purchaser distribution rate to the member account unit of the purchaser. In some implementations, the dividend distribution unit may distribute a priority member dividend obtained by subtracting the purchaser dividend from the dividend according to a priority member distribution way to transfer the priority member dividend to the member account units of the priority members and the purchaser.

In some implementations, the priority member distribution way may be configured to distribute the priority member dividend to the priority members and the purchaser equally. In some implementations, the order calculation unit may determine the distribution order in real time. In some implementations, the order calculation unit may determine the distribution order every time a period of time of order calculation elapses. In some implementations, the order calculation unit may determine the distribution order with respect to all of the members joined in the product sales promotion system. In some implementations, the order calculation unit may determine the distribution order with respect to only the purchasers who purchase the products. In some implementations, the member account unit may be adapted to allow the cyber money transferred directly from the member to be deposited thereinto.

Some implementation of the disclosed technology provides a product sales promotion method for selling products through a product sales promotion system including the steps of: (a) determining a first distribution order in an order of an amount of cyber money deposited into a member account unit allocated to a member who is joined in the product sales promotion system to deposit the cyber money thereinto, by an order calculation unit; (b) making the payment for a sales price of the product by a terminal of a purchaser, through a product payment unit; and (c) distributing cyber money corresponding to a portion of a dividend obtained by multiplying a paid amount for the sales price by a dividend distribution rate to the purchaser, and further distributing cyber money corresponding to a remaining dividend to members who rank ahead the purchaser in the first distribution order (hereinafter, referred to as “priority members”) and the purchaser, by a dividend distribution unit.

In some implementations, the step (c) may include the steps of: transferring a purchaser dividend obtained by multiplying the dividend by a purchaser distribution rate to the member account unit of the purchaser; distributing a priority member dividend obtained by subtracting the purchaser dividend from the dividend according to a priority member distribution way to transfer the priority member dividend to the member account units of the priority members and the purchaser; and determining a second distribution order made by updating the first distribution order on the basis of amounts of cyber money transferred to the member account unit of the purchaser and the member account units of the priority members, by the order calculation unit.

Some implementation of the disclosed technology provides a product sales promotion system for selling products on online including: a product payment unit adapted to allow a payment for a sales price of a product to be made through a terminal of a purchaser; a member account unit allocated to a member who joins the product sales promotion system to allow cyber money to be deposited thereinto; an order calculation unit adapted to determine a distribution order in an order of a cyber money amount deposited in the member account unit; and a dividend distribution unit adapted to distribute cyber money corresponding to a portion of a dividend obtained by multiplying a paid amount for the sales price by a dividend distribution rate to the purchaser and to further distribute cyber money corresponding to a remaining dividend to at least some of members who rank ahead the purchaser in the distribution order (hereinafter, referred to as “priority members”).

In some implementations, the dividend distribution unit may transfer a purchaser dividend obtained by multiplying the dividend by a purchaser distribution rate to the member account unit of the purchaser. In some implementations, the dividend distribution unit may distribute a priority member dividend obtained by subtracting the purchaser dividend from the dividend according to a priority member distribution way to transfer the priority member dividend to the member account units of the at least some of priority members.

Some implementation of the disclosed technology provides a product sales promotion method for selling products through a product sales promotion system including the steps of: (a) determining a first distribution order in an order of an amount of cyber money deposited into a member account unit allocated to a member who is joined in the product sales promotion system to deposit the cyber money thereinto, by an order calculation unit; (b) making the payment for a sales price of the product by a terminal of a purchaser, through a product payment unit; and (c) distributing cyber money corresponding to a portion of a dividend obtained by multiplying a paid amount for the sales price by a dividend distribution rate to the purchaser, and further distributing cyber money corresponding to a remaining dividend to at least some of members who rank ahead the purchaser in the first distribution order (hereinafter, referred to as “priority members”), by a dividend distribution unit.

In some implementations, the step (c) may include the steps of: transferring a purchaser dividend obtained by multiplying the dividend by a purchaser distribution rate to the member account unit of the purchaser; distributing a priority member dividend obtained by subtracting the purchaser dividend from the dividend according to a priority member distribution way to transfer the priority member dividend to the member account units of the at least some of priority members; and determining a second distribution order made by updating the first distribution order on the basis of amounts of cyber money transferred to the member account unit of the purchaser and the member account units of the at least some of priority members, by the order calculation unit.

Some implementation of the disclosed technology provides a product sales promotion system for selling products on online including: a product payment unit adapted to allow a payment for a sales price of a product to be made through a terminal of a purchaser; a member account unit allocated to a member who joins the product sales promotion system to allow cyber money to be deposited thereinto; an order calculation unit adapted to determine a distribution order in an order of a cyber money amount deposited in the member account unit; and a dividend distribution unit adapted to distribute cyber money corresponding to a purchaser dividend which is a portion of a dividend obtained by multiplying a paid amount for the sales price by a dividend distribution rate to the purchaser and to further distribute cyber money corresponding to a remaining dividend to members who rank ahead the purchaser in the distribution order (hereinafter, referred to as “priority members”) and the purchaser wherein after the dividend distribution unit distributes the cyber money corresponding to the purchaser dividend to the purchaser, the order calculation unit determines the distribution order.

In some implementations, the dividend distribution unit may transfer a purchaser dividend obtained by multiplying the dividend by a purchaser distribution rate to the member account unit of the purchaser. In some implementations, the dividend distribution unit may calculate individual priority member dividends from a priority member dividend obtained by subtracting the purchaser dividend from the dividend according to a priority member distribution way and transfer the individual priority member dividends to the member account units of the priority members and the purchaser.

Some implementation of the disclosed technology provides a product sales promotion method for selling products through a product sales promotion system including the steps of: (a) making the payment for a sales price of the product by a terminal of a purchaser, for a first period of time of order calculation, through a product payment unit; and (b) transferring cyber money corresponding to a portion of a dividend obtained by multiplying a paid amount for the sales price by a dividend distribution rate to a member account unit of the purchaser, through a dividend distribution unit; (c) determining a first distribution order according to a cyber money amount deposited into the member account unit, through an order calculation unit; and (d) transferring cyber money corresponding to a remaining dividend to the member account units of members who rank ahead the purchaser in the first distribution order (hereinafter, referred to as “priority members”) and the purchaser, by a dividend distribution unit.

In some implementations, the portion of the dividend at the step (b) may be a purchaser dividend calculated by multiplying the dividend by a purchaser dividend rate, and the remaining dividend at the step (d) may be a priority member dividend calculated by subtracting the purchaser dividend from the dividend. The priority member dividend may be divided into individual priority member dividends according to a priority member distribution way, and the individual priority member dividends may be transferred to the member account units of the priority members and the purchaser. In some implementations, the order calculation unit may determine a second distribution order, for a second period of time of order calculation, on the basis of the purchaser dividends transferred for the second period of time of order calculation and the individual priority member dividends transferred for the first period of time of order calculation. In some implementations, the priority member distribution way may include the steps of: arranging the priority members and the purchaser according to the first distribution order; distributing a first individual priority member dividend obtained by multiplying the priority member dividend by a priority member distribution rate to a first member who is a first in the first distribution order; and distributing a second individual priority member dividend obtained by multiplying an amount remained after subtracting the first individual priority member dividend from the priority member dividend by the priority member distribution rate to a second member who is a second in the first distribution order.

Some implementation of the disclosed technology provides a product sales promotion system for selling products on online including: a product payment unit adapted to allow a payment for a sales price of a product to be made through a terminal of a purchaser; a member account unit allocated to a member who joins the product sales promotion system to allow cyber money to be deposited thereinto; an order calculation unit adapted to determine a distribution order in an order of a cyber money amount deposited in the member account unit; and a dividend distribution unit adapted to distribute cyber money corresponding to a purchaser dividend which is a portion of a dividend obtained by multiplying a paid amount for the sales price by a dividend distribution rate to the purchaser and to further distribute cyber money corresponding to a remaining dividend to at least some of members who rank ahead the purchaser in the distribution order (hereinafter, referred to as “priority members”), wherein after the dividend distribution unit distributes the cyber money corresponding to the purchaser dividend to the purchaser, the order calculation unit determines the distribution order.

Some implementation of the disclosed technology provides a product sales promotion method for selling products through a product sales promotion system including the steps of: (a) making the payment for a sales price of the product by a terminal of a purchaser, for a first period of time of order calculation, through a product payment unit; and (b) transferring cyber money corresponding to a portion of a dividend obtained by multiplying a paid amount for the sales price by a dividend distribution rate to a member account unit of the purchaser, through a dividend distribution unit; (c) determining a first distribution order according to a cyber money amount deposited into the member account unit, through an order calculation unit; and (d) transferring cyber money corresponding to a remaining dividend to the member account units of at least some of members who rank ahead the purchaser in the first distribution order (hereinafter, referred to as “priority members”), by a dividend distribution unit. In some implementations, the portion of the dividend at the step (b) may be a purchaser dividend calculated by multiplying the dividend by a purchaser dividend rate, and the remaining dividend at the step (d) may be a priority member dividend calculated by subtracting the purchaser dividend from the dividend. The priority member dividend may be divided into individual priority member dividends according to a priority member distribution way, and the individual priority member dividends may be transferred to the member account units of the at least some of priority members.

In some implementations, the order calculation unit may determine a second distribution order, for a second period of time of order calculation, on the basis of the purchaser dividends transferred for the second period of time of order calculation and the individual priority member dividends transferred for the first period of time of order calculation.

### BRIEF DESCRIPTION OF THE DRAWINGS

FIG. 1 is an exemplary view showing a configuration of a product sales promotion system according to an implementation of the disclosed technology.

FIG. 2 is an exemplary view showing processes of selling products and distributing sales profit in the product sales promotion system according to an implementation of the disclosed technology, wherein a purchaser makes a payment for the guaranteed amount on an event configured by a seller and performs a purchase confirmation response.

FIG. 3 is an exemplary view showing processes of selling products and distributing sales profit in the product sales promotion system according to an implementation of the disclosed technology, wherein a purchase confirmation management unit at step S230 of FIG. 2 receives a purchase cancel response from a sales price additional payment purchaser.

FIG. 4 is an exemplary view showing processes of selling products and distributing sales profit in the product sales promotion system according to an implementation of the disclosed technology, wherein the purchaser makes a payment for the sales price on the event configured by the seller and performs the purchase confirmation response.

FIG. 5 is an exemplary view showing processes of selling products and distributing sales profit in the product sales promotion system according to an implementation of the disclosed technology, wherein the purchase confirmation management unit at step S500 of FIG. 4 receives the purchase cancel response from the purchaser who makes a payment for the sales price.

FIG. 6 is an exemplary block diagram showing a configuration of a sales profit distribution system according to an implementation of the disclosed technology.

FIG. 7 is an exemplary block diagram showing a configuration of a sales profit distribution system according to another implementation of the disclosed technology.

FIG. 8 is an exemplary flowchart showing processes of selling products and distributing a sales profit in the sales profit distribution system according to another implementation of the disclosed technology, wherein a purchaser makes a payment for a sales price on an event configured by a seller and performs a purchase confirmation response.

FIG. 9 is an exemplary flowchart showing processes of selling products and distributing a sales profit in the sales profit distribution system according to another implementation of the disclosed technology, wherein a purchaser makes a payment for a sales price on the event configured by the seller and performs a purchase cancel response.

FIG. 10 is an exemplary block diagram showing a configuration of a product sales promotion system according to an implementation of the disclosed technology.

FIG. 11 is an exemplary flowchart showing processes of selling products and distributing a dividend in the product sales promotion system according to an implementation of the disclosed technology.

FIG. 12 is an exemplary table showing first distribution order according to the amounts of cyber money of 10 purchasers who purchase clothing through the product sales promotion system according to an implementation of the disclosed technology.

FIG. 13 is an exemplary table showing purchase amounts of 10 purchasers who purchase clothing for three days through the product sales promotion system according to an implementation of the disclosed technology.

FIG. 14 is an exemplary table showing the dividends for the purchasers for a first order calculation period of time.

FIG. 15 is an exemplary table showing the dividends for the purchasers for a second order calculation period of time.

FIG. 16 is an exemplary table showing the dividends for the purchasers for a third order calculation period of time.

FIG. 17 is an exemplary table showing cyber money profit rates to the purchase amounts of the purchasers during an event.

FIG. 18 is an exemplary flowchart showing processes of selling products and distributing a dividend in the product sales promotion system according to an implementation of the disclosed technology.

FIG. 19 is an exemplary table showing the dividends for the purchasers for a first order calculation period of time.

FIG. 20 is an exemplary table showing the dividends for the purchasers for a second order calculation period of time.

FIG. 21 is an exemplary table showing the dividends for the purchasers for a third order calculation period of time.

FIG. 22 is an exemplary table showing cyber money profit rates to the purchase amounts of the purchasers during an event.

FIG. 23 is an exemplary flowchart showing processes of selling products and distributing a dividend in the product sales promotion system according to an implementation of the disclosed technology.

FIG. 24 is an exemplary table showing the purchaser dividends transferred to the purchasers for a first period of time of order calculation and the amounts of cyber money retained updated on the basis of the purchaser dividends, which will be a standard for the first distribution order.

FIG. 25 is an exemplary table showing the first distribution order.

FIG. 26 is an exemplary table showing amounts transferred to the purchasers and profit rates of the purchasers for the first period of time of order calculation.

FIG. 27 is an exemplary table showing the purchaser dividends transferred to the purchasers for a second period of time of order calculation and the amounts of cyber money retained updated on the basis of the sum of individual priority member dividends for the first period of time of order calculation and the purchaser dividends for the second period of time of order calculation, which will be a standard for the second distribution order.

FIG. 28 is an exemplary table showing the second distribution order.

FIG. 29 is an exemplary table showing amounts transferred to the purchasers and profit rates of the purchasers for the second period of time of order calculation.

FIG. 30 is an exemplary table showing the purchaser dividends transferred to the purchasers for a third period of time of order calculation and the amounts of cyber money retained updated on the basis of the sum of individual priority member dividends for the second period of time of order calculation and the purchaser dividends for the third period of time of order calculation, which will be a standard for the third distribution order.

FIG. 31 is an exemplary table showing the third distribution order.

FIG. 32 is an exemplary table showing amounts transferred to the purchasers and profit rates of the purchasers for the third period of time of order calculation.

FIG. 33 is an exemplary table showing cyber money profit rates to the purchase amounts of the purchasers during an event.

FIG. 34 is an exemplary flowchart showing processes of selling products and distributing a dividend in the product sales promotion system according to an implementation of the disclosed technology.

FIG. 35 is an exemplary table showing amounts transferred to the purchasers and profit rates of the purchasers for the first period of time of order calculation.

FIG. 36 is an exemplary table showing the purchaser dividends transferred to the purchasers for a second period of time of order calculation and the amounts of cyber money retained updated on the basis of the sum of individual priority member dividends for the first period of time of order calculation and the purchaser dividends for the second period of time of order calculation, which will be a standard for the second distribution order.

FIG. 37 is an exemplary table showing the second distribution order.

FIG. 38 is an exemplary table showing amounts transferred to the purchasers and profit rates of the purchasers for the second period of time of order calculation.

FIG. 39 is an exemplary table showing the purchaser dividends transferred to the purchasers for a third period of time of order calculation and the amounts of cyber money retained updated on the basis of the sum of individual priority member dividends for the second period of time of order calculation and the purchaser dividends for the third period of time of order calculation, which will be a standard for the third distribution order.

FIG. 40 is an exemplary table showing the third distribution order.

FIG. 41 is an exemplary table showing amounts transferred to the purchasers and profit rates of the purchasers for the third period of time of order calculation.

FIG. 42 is an exemplary table showing cyber money profit rates to the purchase amounts of the purchasers during an event.

### DETAILED DESCRIPTION

Hereinafter, various implementations of the disclosed technology will be described in detail with reference to the accompanying drawings so that those skilled in the art can easily carry out the disclosed technology. In the following detailed description of the embodiments of the disclosed technology, a detailed description of known functions or configurations will be omitted. The same reference numerals are used throughout the drawings for portions having similar functions and actions. Hereinafter, a product sales promotion system and method according to an embodiment of the present invention will now be described in detail with reference to the attached drawings.

In addition, in the entire specification, when a part is referred to as being “connected” with another part, it is not only a case where it is directly connected, but also a case where it is indirectly connected with another element therebetween. Also, “comprising” and “including” mean that other components may be included, rather than excluding other components, unless specifically stated otherwise. The term “unit” as used in this patent document may include software, hardware, or a combination thereof depending on the context in which the term is used. For example, the software may be machine code, firmware, embedded code, application software, or a combination thereof. Also, for example, the hardware may be a circuit, a processor, a computer, an integrated circuit, integrated circuit cores, or a combination thereof. The units may be implemented in one computer in some applications, or may be distributed in more than one computers or servers linked to a communication network to allow communications between the units.

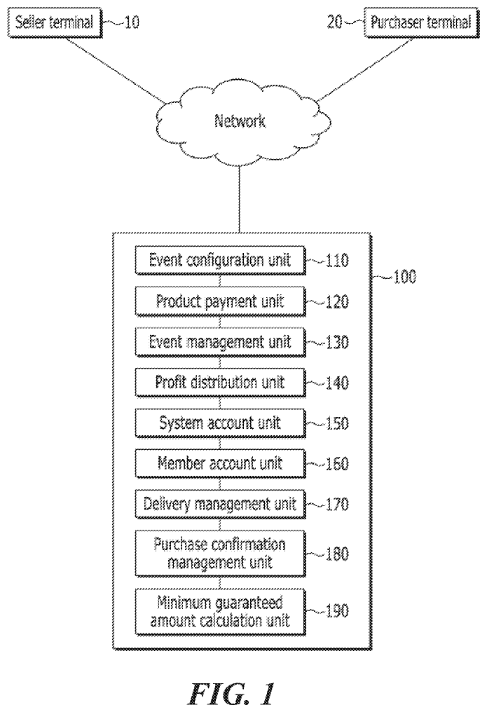

FIG. 1 is an exemplary view showing a configuration of a product sales promotion system according to an implementation of the disclosed technology.

A product sales promotion system 100 according to an implementation of the disclosed technology may include an event configuration unit 110, a product payment unit 120, an event management unit 130, a profit distribution unit 140, a system account unit 150, a member account unit 160, a delivery management unit 170, a purchase confirmation management unit 180, and a minimum guaranteed amount calculation unit 190.

A seller may be connected to the product sales promotion system 100 by using a seller terminal 10 through wired and wireless network. A purchaser may be connected to the product sales promotion system 100 by using a purchaser terminal 20 through the wired and wireless network. The seller terminal 10 and the purchaser terminal 20 may be or include devices for transmitting and receiving data to and from the product sales promotion system 100 connected thereto, and for example, desktop computers, laptops, smart phones, tablet computers, and so on may be used as the seller terminal 10 and the purchaser terminal 20. However, the seller terminal 10 and the purchaser terminal 20 are not limited to those mentioned above. The produce sales promotion system 100 which is communicatively connected with the seller terminal 10 and the purchaser terminal 20 to receive relevant information from the seller terminal and/or the purchaser terminal 20.

The seller and the purchaser are members who join in the product sales promotion system 100, and the members of the product sales promotion system 100 have cyber money accounts and cash accounts connected to their own accounts. The cyber money accounts and the cash accounts are included in the member account unit 160. The cyber money deposited into the cyber money accounts may be used to decide distribution amounts for the respective purchasers. Thus, the cyber money deposited into the cyber money accounts may provide a distribution standard for distributing a distribution profit as will be discussed later, and the distribution profit is put into the cyber money accounts in the form of cyber money. The cash in the cash accounts may be transferred into the cyber money accounts, exchanged with the cyber money in the ratio of 1:1 or in other predetermined ratio, and deposited into the cyber money accounts. Contrarily, the cyber money in the cyber money accounts may be transferred into the cash accounts, but in this case, desirably, a withdrawal fee at a given rate for the transferring money has to be paid. The withdrawal fee may be transferred into the system account unit 150 of the product sales promotion system 100, and the cash may be transferred into the cash accounts of the members. The cyber money may include reward points, mileages, coupons, credits, gifts, incentives, energy currency, etc.

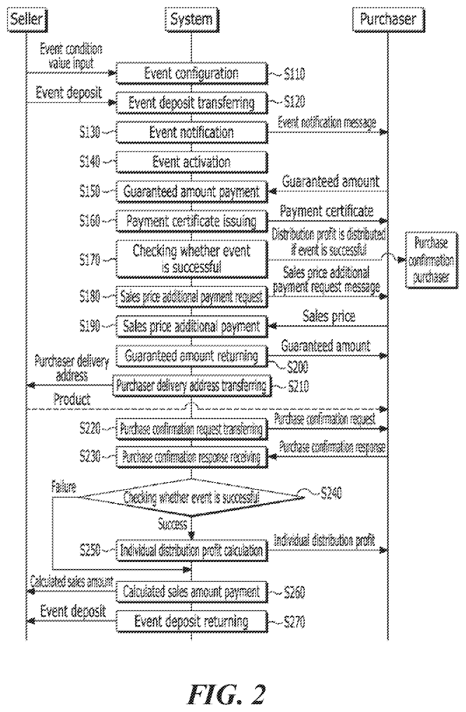

FIG. 2 is an exemplary view showing processes of selling products and distributing sales profit in the product sales promotion system according to an implementation of the disclosed technology, wherein a purchaser makes a payment for the guaranteed amount on an event configured by a seller and performs a purchase confirmation response.

The seller terminal 10 is connected to the product sales promotion system 100, and provide, to the product sales promotion system 100, event information on a sales event that a seller wishes to set by, for example, selecting an event configuration menu. The event information provided from the seller terminal 10 the product sales promotion system 100 may include at least one of event condition values, the sales price of a product that the seller wishes to sell, the target period of time for product sales, the target amount of product sales, a guaranteed amount, a distribution profit to be distributed to the purchasers who have purchased and received purchase confirmation when the event determined as successful, a distribution way of the distribution profit, and/or a distribution rate of the distribution profit. In some implementations, the event configuration unit 110 operates to display, on the seller terminal 10, an input screen which allows the seller terminal 10 provide the corresponding event information. The event information provided to the event configuration unit 110 from the seller terminal 10 is stored in the event configuration unit 110, thereby completing configuring the event (at step S110). Some of the event information is used to determine whether the event set by the seller terminal 10 is successful or not. In some implementations, the product sales promotion system 100 may determine an event as successful when a target amount of product sales is achieved for a target period of time for product sales.

Having the guaranteed amount for a product in addition to the sales price of the product, allows to reduce the payment burden on the purchasers. The guaranteed amount may be set less than the sales price, and the purchaser who wants to purchase the product may make a payment for the whole sales price of the product or for the guaranteed amount. If the payment for the sales price of the product or for the guaranteed amount is made, a payment certificate is issued by the event management unit 130. The payment certificate can be designed in various manners, for example, including a barcode for a respective purchaser, and If the number of payment certificates reaches the target amount of product sales, it is considered that the event is successful. The purchaser may make a payment for the total sales price of the product or only for the guaranteed amount so as to join in the event.

The event information such as the sales price of the product, the target period of time of product sales, the target amount of product sales, the guaranteed amount, the distribution profit, the distribution way of the distribution profit, and/or the distribution rate of the distribution profit may be arbitrarily determined by and received from the seller terminal 10. The product sales promotion system 100 may operate to provide some suggestions with appropriate values for at least some of the event information. In some implementations, the product sales promotion system 100 may include algorithms to calculate optimized values of some event information in advance and provide the calculated values to the seller terminal 10.

The minimum guaranteed amount calculation unit 190 may calculate a minimum guaranteed amount, and the calculated minimum guaranteed amount may be transferred to the seller terminal 10. The minimum guaranteed amount calculation unit 190 may perform the calculation of the minimum guaranteed amount based on various algorithms. Some of the algorithms are further discussed below.

In some implementations, the minimum guaranteed amount calculation unit 190 may calculate the minimum guaranteed amount as a value which is obtained by dividing the greatest distribution profit among the distribution profits distributed to the purchaser terminals 20 by the target amount of product sales. The different distribution profits are distributed to the respective purchaser terminals 20 when the event is determined as successful. The minimum guaranteed amount calculation unit 190 may provide the minimum guaranteed amount to the seller terminal 10. In response, if the seller terminal 10 selects, for a particular sales event that the seller is setting through the event configuration unit 110, the minimum guaranteed amount as provided from the product sales promotion system 100 (i.e., the greatest distribution profits/the target amount of product sales), even when all other purchasers cancel their purchases except only the purchaser who is supposed to have the largest individual distribution profit, the seller can still pay the individual distribution profit with the guaranteed amount to the purchaser, without any damages to the seller.

In some implementations, the minimum guaranteed amount calculation unit 190 may calculate the minimum guaranteed amount as a value which is obtained by dividing an event deposit by the target amount of product sales. The event deposit is the amount of money deposited by the seller terminal 10 for a particular sales event and more explanations are provided later. As mentioned below, if the purchaser cancels his/her purchase after the event is determined as successful, the product sales promotion system 100 operates to return the amount calculated by subtracting the guaranteed amount from the sales price to the purchaser, and the guaranteed amount is paid to the seller regardless of the cancellation of the purchase. If the seller terminal 10 selects, for a particular sales event that the seller is setting through the event configuration unit 110, the minimum guaranteed amount as provided from the product sales promotion system (i.e., the event deposit/the target amount of product sales), even if all of the purchasers cancel their purchase after the event is determined as successful, the whole guaranteed amount that is the same as the event deposit is paid to the seller, so that the seller can receive the event deposit back, without any damage.

In response to receiving the event information from the seller terminal 10, the event management unit 130 transfers. to the seller terminal 10, a message that the amount corresponding to the distribution profits to be distributed to the purchaser terminals 20 needs to be deposited into the system account unit 150 as an event deposit. Through the seller terminal 10, the seller requests the event management unit 130 to transfer the event deposit having the same amount as the distribution profit from the cyber money account or cash account connected to the seller's account into the system account unit 150, and the event management unit 130 transfers the event deposit from the cyber money account or cash account of the seller into the system account unit 150 (at step S20). The cash is transferred into the system account unit 150, and in case where the cash is transferred as the event deposit from the cyber money account into the system account unit 150, the withdrawal fee occurs so that the amount corresponding to the event deposit and the withdrawal fee is withdrawn from the cyber money account.

Before the event is activated, the event management unit 130 may transfer an event notification message notifying the terminals of the members enrolled or registered in the product sales promotion system 100 of the start date and start time of the event activation (at step S130). As the start date and start time of the event activation are in advance notified, it is possible to substantially increase the number of users who participate the event provided by the product sales promotion system 100. The event notification message that notifies the members of the event activation can ensure fairness in sales where the distribution of the distribution profits is made according to the order of payment (for example, the payment certificate issue order), the order of sales price payment, or the order of purchase confirmation response. As a result, the event notification message can prevent the first occupation in the distribution order of the distribution profit by the purchasers who in advance obtain the event information.

In some implementations, before the activation of the event, the event management unit 130 may notify the members of a period of time for a possible start date of the event activation instead of the exact particular start date. In this case, it is possible to start the activation of the event within the period of time without any further notice. For example, the event management unit 130 may notify the members of a period of time, for example, between May 1, 2016 and May 8, 2106, for a possible start date, and without any additional notification, the event may be activated on May 3, 2016, 1 pm.

The event management unit 130 activates the event configured through the event configuration unit 110 by the seller terminal 10 of the seller (at step S140). Before the event is activated by the seller, the event management unit 130 requests the seller terminal 10 to deposit a system usage fee, and if it is checked that the system usage fee is deposited into the system account unit 150, the event management unit 130 activates the event.

In some implementations, the event is activated without sending any event notification message to the members enrolled or registered in the product sales promotion system 100. Thus, the event notification message can be omitted before the activation of the event and it is possible that the event is activated on the start date and time of the event, without any notification.

The event management unit 130 may activate the event after a given period of standby time from the start time of the event, not on the exact start time of the event set in the event configuration unit 110 through the seller terminal 10 of the seller. In case where the distribution of the distribution profit is made according to the order of payment (for example, the payment certificate issue order), the order of sales price payment, or the order of purchase confirmation response, accordingly, fairness can be ensured. During the given period of standby time, the members can be provided the opportunities to obtain the event information, thereby preventing some purchasers who obtain the event information in advance from taking the advantages in the distribution order of the distribution profit.

If the event is activated, the product can be purchased through the purchaser terminal 20 of the purchaser. The purchaser may make a payment only for the guaranteed amount or for the total sales price of the product. Hereinafter, an explanation on the case where the purchaser makes a payment only for the guaranteed amount will be given.

To purchase the product, the purchaser makes a payment using the purchaser terminal 20 for the guaranteed amount on the payment screen provided through the product payment unit 120, and the product payment unit 120 deposits the paid guaranteed amount into the system account unit 150 (at step S150). The paid guaranteed amount is the cash withdrawn from the cyber money account or cash account of the purchaser, card sales amount received from a credit card company of the purchaser, and payment amount received from a smart phone communication company of the purchaser. The payment may be made in various ways including online/offline payment ways, and a detailed explanation on the payment ways will be omitted.

If the payment for the guaranteed amount is made, the event management unit 130 issues the payment certificate and transfers the payment certificate to the purchaser terminal 20 (at step S160).

After the event management unit 130 issues the payment certificates for the respective purchasers, the event management unit 130 checks whether the event is successful (at step S170). In some implementations, the event management unit 130 compares the target amount of product sales provided from the seller terminal 10 with the total amounts of the payment certificates that have been issued. If the target amount of product sales is equal to or less than that the total amounts of the payment certificates that have been issued, the event management unit 130 determines that the event is successful. If the event is determined as successful, the product sales promotion system 100 proceeds to distribute the distribution profit to appropriate purchasers The distribution of the distribution profit will be explained later.

The event management unit 130 transfers an additional payment request message to the purchaser terminal 20 of the purchaser (hereinafter, referred to as “purchaser with guaranteed amount payment”) who makes a payment only for the guaranteed amount (at step S180). The timing when the additional payment request message is sent can be modified in various manners. For example, the additional payment request message may be sent before the step 170, or after the step 170.

In response to receiving the additional payment request, the purchaser with guaranteed amount payment may make a payment for a sales price of the product. For this, the product payment unit 120 of the product sales promotion system 100 provides the payment screen to the purchaser terminal 20 (at step S190). If the additional payment for the sales price is not made by the purchaser terminal 20 corresponding to the purchaser with the guaranteed amount payment within a period of time, the event management unit 130 determines that the purchaser with guaranteed amount payment does not wish to complete the purchase and cancel his/her purchase, and the guaranteed amount paid from the purchaser with guaranteed amount payment may be provided to the cash account of the seller at the moment or after the event is finished.

If the purchaser with the guaranteed amount payment makes the payment for the sales price, the event management unit 130 returns the guaranteed amount which was already paid to the guaranteed amount payment purchaser (hereinafter, referred to as “purchaser with additional payment”) at step S200. The guaranteed amount is withdrawn from the amount kept in the system account unit 150 and is transferred into the cash account of the purchaser with additional payment.

The delivery management unit 170 transfers, to a seller terminal, a delivery address and a payment certificate for the purchaser with additional payment to allow the seller to deliver the product to the purchaser with additional payment (at step S210). A delivery can be made in various manners, for example, through a delivery service or a direct delivery from the seller to the purchaser. If the product is delivered directly to the purchaser, the seller may scan bar codes on the payment certificate provided to the purchaser with additional payment.

The purchase confirmation management unit 180 transfers a purchase confirmation request to the purchaser with additional payment who receives the product through the delivery service or directly receives the product from the seller (at step S220).

The purchase confirmation management unit 180 receives the response to the purchase confirmation request from the purchaser with additional payment (at step S230). The response to the purchase confirmation request is either the purchase confirmation response or the purchase cancel response. Hereinafter, an explanation on the case where the response to the purchase confirmation request is the purchase confirmation response will be given.

If the purchase confirmation management unit 180 receives the purchase confirmation response from the purchaser with additional payment, the event management unit 130 checks whether the event is successful (at step S240). As discussed above, the event management unit 130 previously checks whether the event is successful at the step 170. If the determination was made at step 170 as successful, the determination at step 240 may be omitted. If the determination was made at step 170 as not successful, the event management unit 130 checks again at step 240 that the event is successful or not. The event management unit 130 may make a comparison between the total amounts paid by the purchasers, which are obtained based on the number of the payment certificates issued by the payments (inclusive of the sales price payments and the guaranteed amount payments) for the products, and the target amount of product sales. If the event management unit 130 determines that the event is successful, the profit distribution unit 140 pays an individual distribution profit in cyber money to the purchaser with additional payment who responded to the purchase confirmation management unit 180 with the purchase confirmation response (at step S250). The profit distribution unit 140 determines and calculates the distribution profit. For this, the profit distribution unit 140 may apply algorithms and determine the distribution rate for the purchaser with additional payment. The individual distribution profit is withdrawn from the amount kept in the system account unit 150 and is transferred into the cyber money account of the purchaser with additional payment. The distribution profit is paid in cyber money, but it is possible that the distribution profit is transferred, in cash, into the cash account of the purchaser with additional payment.

After the individual distribution profit is paid to the purchasers through the profit distribution unit 140 (at the step S250), the event management unit 130 transfers the sales amount calculated by subtracting the sum of the paid individual distribution profits from the total sales amount (calculated by multiplying the sales price and the number of purchase confirmed products) into the cash account of the seller (at step S260) and returns the event deposit in the system account unit 150 to the cash account of the seller (at step S270). In this case, an explanation on the steps S250, S260 and S270 which are sequentially performed is paid, but the steps may be performed concurrently or in a reverse order to each other.

If it is determined by the event management unit 130 that the number of payment certificates issued by the payments (inclusive of the sales price payments and the guaranteed amount payments) for the products does not reach the target amount of product sales (at the step S240), it is determined that the event fails. If the event fails, the step of distributing the individual distribution profit (at the step S250) is not performed.

If the event fails, the event management unit 130 transfers the total sales amount (calculated by multiplying the sales price and the number of purchase confirmed products) into the cash account of the seller (at the step S260) and returns the event deposit in the system account unit 150 to the cash account of the seller (at the step S270). In this case, an explanation on the steps S260 and S270 which are sequentially performed is paid, but the steps may be performed concurrently or in a reverse order to each other.

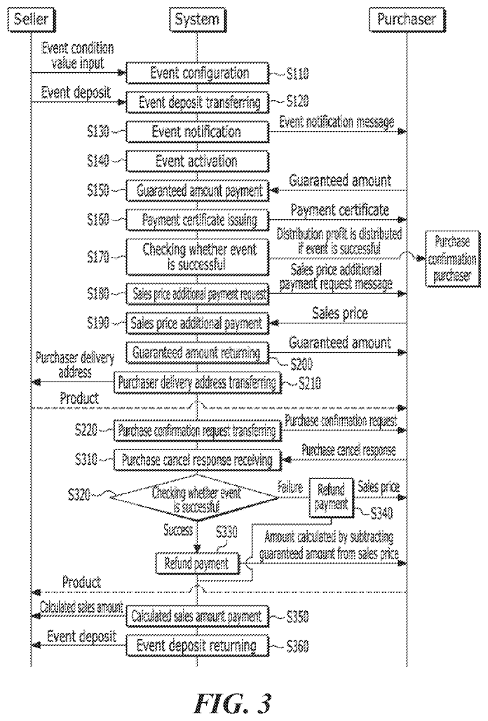

FIG. 3 is an exemplary view showing the case where the purchase confirmation management unit 180 at the step S230 of FIG. 2 receives the purchase cancel response from the purchaser with additional payment. Since the steps S110 to S220 are the same as FIG. 2, an explanation on them will be omitted, and accordingly, the step S230 of FIG. 2 (corresponding to step S310 of FIG. 3) and the steps after the step S230 will be explained below.

The purchase confirmation management unit 180 transfers the purchase confirmation request to the purchaser with additional payment (at the step S220).

The purchase confirmation management unit 180 receives the response to the purchase confirmation request from the purchaser with additional payment (at the step S230). The response to the purchase confirmation request is either the purchase confirmation response or the purchase cancel response. Hereinafter, an explanation on the case where the response to the purchase confirmation request is the purchase cancel response will be given. The purchase cancel response is the purchaser's willingness to get a refund.

If the purchase confirmation management unit 180 receives the purchase cancel response from the purchaser with additional payment (at step S310), the event management unit 130 checks whether the event is successful (at step S320). If the event management unit 130 may make a comparison between the total amount paid by the purchasers, which are obtained based on the number of the payment certificates issued by the payments (inclusive of the sales price payments and the guaranteed amount payments) for the products, and the target amount of product sales. If the target amount of product sales is equal to or less than the total amount paid by the purchasers, the event management unit 130 determines that the event is successful, and if the target amount of product sales is greater than the total amount paid by the purchasers, the event management unit 130 determines that the event is not successful and fails.

If it is determined at step 320 that the event is successful, the profit distribution unit 140 pays the amount calculated by subtracting the guaranteed amount from the sales price, as a refund, to the purchaser with additional payment who sent the purchase cancel response (at step S330). The refund is withdrawn from the amount kept in the system account unit 150 and is thus transferred into the cash account of the purchaser with additional payment who sent the purchase cancel response. The guaranteed amount is not returned to the purchaser with additional payment and used to pay the distribution profit according to the event success to other purchasers. Under this configuration, if the purchaser with additional payment cancels his/her purchase and the event successes, his or her guaranteed amount is not returned. Bo doing so, the system can discourage the purchasers not to cancel his/her purchase.

After the profit distribution unit 140 pays the individual distribution profits to the purchasers who perform the purchase confirmation response, the event management unit 130 pays the sales amount calculated by subtracting the sum of the paid individual distribution profits from the total sales amount (calculated by multiplying the sales price and the number of purchase confirmed products) to the cash account of the seller (at step S350) and returns the event deposit in the system account unit 150 to the cash account of the seller (at step S360).

In the above, it has been explained that the purchase confirmation management unit 180 receives the purchase cancel response from the purchaser with additional payment (at the step S310), and after the event management unit 130 checks that the event is successful (at the step S320), the profit distribution unit 140 may pay the refund calculated by subtracting the guaranteed amount from the sales price to the purchaser with additional payment who responded with the purchase cancel response (at the step S330). In some implementation, the order of some operations could be changed and the process proceeds in different manners. For example, when the purchase confirmation management unit 180 receives the purchase cancel response from the purchaser with additional payment, the profit distribution unit 140 may directly pay the refund calculated by subtracting the guaranteed amount from the sales price to the purchaser with additional payment who responded with the purchase cancel response, and then, the event management unit 130 checks whether the event is successful. If it is checked that the event is successful, the guaranteed amount is not additionally paid to the purchaser with additional payment who responded with the purchase cancel response. The guaranteed amount might be paid to the purchaser. If the event fails (at the step S320), the profit distribution unit 140 pays the amount corresponding to the sales price as the refund to the purchaser with additional payment who responded with the purchase cancel response (at step S340). The refund is withdrawn from the amount kept in the system account unit 150 and is thus transferred into the cash account of the purchaser with additional payment who responded with the purchase cancel response.

The event management unit 130 pays the total sales amount (calculated by multiplying the sales price and the number of purchase confirmed products) to the cash account of the seller (at the step S350) and returns the event deposit in the system account unit 150 to the cash account of the seller (at the step S360).

In the above, it has been described that the purchase confirmation management unit 180 receives the purchase cancel response from the purchaser with additional payment (at the step S310), and after the event management unit 130 checks that the event fails (at the step S320), the profit distribution unit 140 pays the refund corresponding to the sales price to the purchaser with additional payment who responded with the purchase cancel response (at the step S340). In some implementations, when the purchase confirmation management unit 180 receives the purchase cancel response from the purchaser with additional payment, the profit distribution unit 140 firstly pays the refund (calculated by subtracting the guaranteed amount from the sales price) to the purchaser with additional payment who responded with the purchase cancel response, and then, the event management unit 130 checks whether the event is successful. If it is checked that the event fails, the guaranteed amount may be secondarily paid to the purchaser with additional payment who responded with the purchase cancel response.

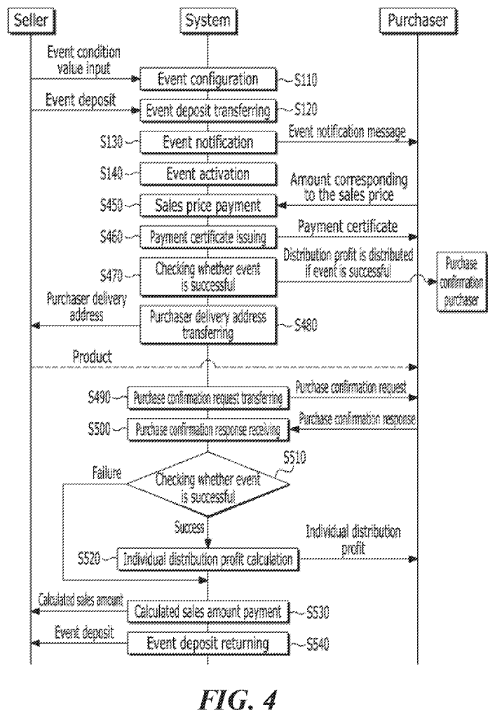

FIG. 4 is an exemplary view showing processes of selling products and distributing sales profit in the product sales promotion system according to an implementation of the disclosed technology, wherein the purchaser makes a payment for the sales price on the event configured by the seller and performs the purchase confirmation response.

Since the steps S110 to S140 are the same as FIG. 2, an explanation on them will be omitted, and accordingly, the step S150 of FIG. 2 (corresponding to step S450 of FIG. 4) and the steps after the step S150 will be in detail explained.

If the event is activated through the event management unit 130 (at the step S140), the purchaser may purchase the product through the purchaser terminal 20. The purchaser may make a payment only for the guaranteed amount or for the whole sales price, and hereinafter, an explanation on the case where the purchaser makes a payment for the sales price will be given.

To purchase the product, the purchaser makes a payment for the sales price on the payment screen provided by the product payment unit 120 through the purchaser terminal 20, and the product payment unit 120 deposits the paid amount of the sales price into the system account unit 150 (at step S450). The paid amount of sales price is the cash withdrawn from the cyber money account or cash account of the purchaser, card sales amount received from a credit card company of the purchaser, and payment amount received from a smart phone communication company of the purchaser. The payment may be made online or offline, and a detailed explanation on the payment will be omitted.

If the payment for the sales price is made, the event management unit 130 issues the payment certificate and transfers the payment certificate to the purchaser terminal 20 (at step S460).

Whenever the event management unit 130 issues the payment certificates for the respective purchasers, it checks whether the event is successful (at step S470). As the target amount of product sales is equal to or less than the total payment made by the purchasers for the sales price, it may be checked whether the event is successful. If it is checked that the event is successful, the product sales promotion system 100 proceeds to distribute the distribution profit to appropriate purchasers.

The delivery management unit 170 transfers a delivery address and a payment certificate for the purchaser (hereinafter, referred to as “sales price payment purchaser”) who makes a payment for the sales price to the seller terminal 10 to allow the seller to deliver the product to the sales price payment purchaser (at step S480). A delivery way includes a delivery service and a direct delivery to the purchaser, and if the product is delivered directly to the purchaser, the seller scans bar codes on the payment certificate provided by the sales price payment purchaser. After the sales price payment purchaser is identified, accordingly, the product is given to the sales price payment purchaser.

The purchase confirmation management unit 180 transfers the purchase confirmation request to the sales price payment purchaser who receives the product through the delivery service or directly receives the product from the seller (at step S490).

The purchase confirmation management unit 180 receives the response to the purchase confirmation request from the sales price payment purchaser (at step S500). The response to the purchase confirmation request is either the purchase confirmation response or the purchase cancel response. Hereinafter, an explanation on the case where the response to the purchase confirmation request is the purchase confirmation response will be given.

If the purchase confirmation management unit 180 receives the purchase confirmation response from the sales price payment purchaser, the event management unit 130 checks whether the event is successful (at step S510). If the event management unit 130 checks that the total amount the number of payment certificates issued by the payments (inclusive of the sales price payments and the guaranteed amount payments) for the products reaches the target amount of product sales, it is determined that the event is successful, and the profit distribution unit 140 pays an individual distribution profit calculated from the distribution profit, in cyber money, to the sales price payment purchaser who performs the purchase confirmation response (at step S520). The profit distribution unit 140 applies the distribution way of the distribution profit and the distribution rate of the distribution profit to the distribution profit to calculate the individual distribution profit. The individual distribution profit is withdrawn from the amount kept in the system account unit 150 and is transferred into the cyber money account of the sales price payment purchaser who performs the purchase confirmation response. The distribution profit is paid in cyber money, but it is possible that the distribution profit is transferred in cash into the cash account of the sales price payment purchaser who performs the purchase confirmation response.

After the individual distribution profit is paid through the profit distribution unit 140 (at the step S520), the event management unit 130 transfers the sales amount calculated by subtracting the sum of the paid individual distribution profits from the total sales amount (calculated by multiplying the sales price and the number of purchase confirmed products) into the cash account of the seller (at step S530) and returns the event deposit in the system account unit 150 to the cash account of the seller (at step S540). In this case, an explanation on the steps S510, S520, S530, and S540 which are sequentially performed is paid, but the steps may be performed concurrently or in a reverse order to each other.

If it is checked by the event management unit 130 that the number of payment certificates issued by the payments (inclusive of the sales price payments and the guaranteed amount payments) for the products does not reach the target amount of product sales (at the step S510), it is determined that the event fails. If the event fails, the step of distributing the individual distribution profit (at the step S520) is not performed.

If the event fails, the event management unit 130 transfers the total sales amount (calculated by multiplying the sales price and the number of purchase confirmed products) into the cash account of the seller (at the step S530) and returns the event deposit in the system account unit 150 to the cash account of the seller (at the step S540). In this case, an explanation on the steps S510, S530 and S540 which are sequentially performed is paid, but the steps may be performed concurrently or in a reverse order to each other.

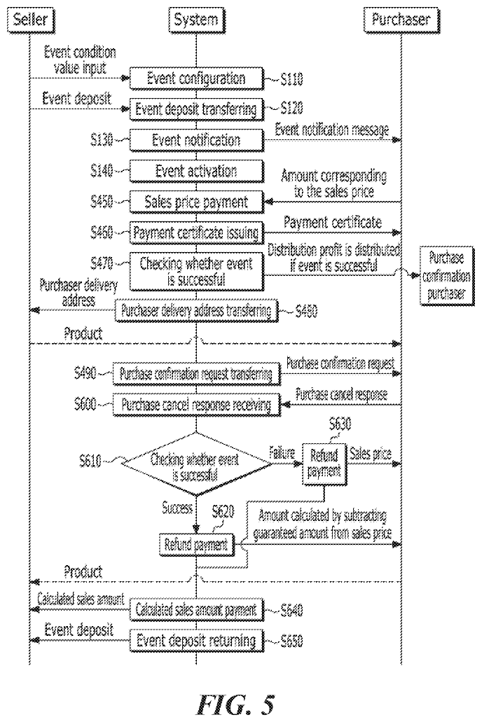

FIG. 5 is an exemplary view showing the case where the purchase confirmation management unit 180 at the step S500 of FIG. 4 receives the purchase cancel response from the sales price payment purchaser, wherein since the steps S110 to S140 and the steps S450 to S490 are the same as FIG. 4, an explanation on them will be avoided, and accordingly, the step S500 of FIG. 4 (corresponding to step S600 of FIG. 5) and the steps after the step S500 will be in detail explained.

The purchase confirmation management unit 180 transfers the purchase confirmation request to the sales price payment purchaser (at the step S490).

The purchase confirmation management unit 180 receives the response to the purchase confirmation request from the sales price payment purchaser (at step S600). The response to the purchase confirmation request is either the purchase confirmation response or the purchase cancel response. Hereinafter, an explanation on the case where the response to the purchase confirmation request is the purchase cancel response will be given. The purchase cancel response is the purchaser's willingness to get a refund.

If the purchase confirmation management unit 180 receives the purchase cancel response from the sales price payment purchaser (at the step S600), the event management unit 130 checks whether the event is successful (at step S610). If the event management unit 130 checks that the number of payment certificates issued by the payments (inclusive of the sales price payments and the guaranteed amount payments) for the products reaches the target amount of product sales, it is determined that the event is successful, and if the event management unit 130 checks that the number of payment certificates issued does not reach the target amount of product sales, it is determined that the event fails.

If the event is successful, the profit distribution unit 140 pays the amount calculated by subtracting the guaranteed amount from the sales price, as s refund, to the sales price payment purchaser who performs the purchase cancel response (at step S620). The refund is withdrawn from the amount kept in the system account unit 150 and is thus transferred into the cash account of the sales price payment purchaser who performs the purchase cancel response. The reason why the guaranteed amount is subtracted from the sales price is that it can be used to pay the distribution profit according to the event success to other purchasers who perform the purchase confirmation response. If the sales price payment purchaser performs the purchase cancel even upon the event success, his or her guaranteed amount is lost, which makes it difficult for he or she to cancel the purchase.

After the profit distribution unit 140 pays the individual distribution profits to the purchasers who perform the purchase confirmation response, the event management unit 130 pays the sales amount calculated by subtracting the sum of the paid individual distribution profits from the total sales amount (calculated by multiplying the sales price and the number of purchase confirmed products) to the cash account of the seller (at step S640) and returns the event deposit in the system account unit 150 to the cash account of the seller (at step S650).

In this case, the purchase confirmation management unit 180 receives the purchase cancel response from the sales price payment purchaser (at the step S600), and after the event management unit 130 checks that the event is successful (at the step S610), the profit distribution unit 140 pays the refund calculated by subtracting the guaranteed amount from the sales price to the sales price payment purchaser who performs the purchase cancel response (at the step S620). If the purchase confirmation management unit 180 receives the purchase cancel response from the sales price payment purchaser, however, the profit distribution unit 140 directly pays the refund calculated by subtracting the guaranteed amount from the sales price to the sales price payment purchaser who performs the purchase cancel response, and then, the event management unit 130 checks whether the event is successful. If it is checked that the event is successful, the guaranteed amount is not additionally paid to the sales price payment purchaser who performs the purchase cancel response. The guaranteed amount is just paid to the purchaser.

If the event fails (at the step S610), the profit distribution unit 140 pays the amount corresponding to the sales price as a refund to the sales price payment purchaser who performs the purchase cancel response (at step S630). The refund is withdrawn from the amount kept in the system account unit 150 and is thus transferred into the cash account of the sales price payment purchaser who performs the purchase cancel response. The reason why the guaranteed amount is not subtracted from the sales price is opposite to the reason why the guaranteed amount is subtracted from the sales price upon the event success.

The event management unit 130 pays the total sales amount (calculated by multiplying the sales price and the number of purchase confirmed products) to the cash account of the seller (at the step S640) and returns the event deposit in the system account unit 150 to the cash account of the seller (at the step S650).

In this case, the purchase confirmation management unit 180 receives the purchase cancel response from the sales price payment purchaser (at the step S600), and after the event management unit 130 checks that the event fails (at the step S610), the profit distribution unit 140 pays the refund corresponding to the sales price to the sales price payment purchaser who performs the purchase cancel response (at the step S630). If the purchase confirmation management unit 180 receives the purchase cancel response from the sales price payment purchaser, however, the profit distribution unit 140 firstly pays the refund (calculated by subtracting the guaranteed amount from the sales price) to the sales price payment purchaser who performs the purchase cancel response, and then, the event management unit 130 checks whether the event is successful. If it is checked that the event fails, the guaranteed amount is secondarily paid to the sales price payment purchaser who performs the purchase cancel response.

An expected distribution order in the product sales promotion system and method according to an implementation of the disclosed technology may be calculated even before the purchase confirmation responses of the guaranteed amount payment purchasers and the sales price payment purchasers are completed. Whenever the payment certificates are issued by the event management unit 130, the profit distribution unit 140 calculates the expected distribution order of the guaranteed amount payment purchasers and the sales price payment purchasers in real time to transfer the real time expected distribution order to the terminals 20 of the guaranteed amount payment purchasers and the sales price payment purchasers.

In this case, of course, the profit distribution unit 140 does not publish the real time expected distribution order until the event is successful, and after the event is successful, the profit distribution unit 140 may transfer the real time expected distribution order to the terminals 20 of the guaranteed amount payment purchasers and the sales price payment purchasers. Until the event is successful, as a result, the guaranteed amount payment purchasers and the sales price payment purchasers cannot obtain the information on their real time expected distribution order, so that such uncertainty in the real time expected distribution order makes purchase desires more stimulated, thereby allowing the event to be successful within more rapid period of time.

The distribution way of the distribution profit in the product sales promotion system and method according to an implementation of the disclosed technology may be selected freely by the seller. For example, the distribution way of the distribution profit is determined according to the order of payment (that is, the payment certificate issue order), an amount of cyber money retained, the order of sales price payment, or the order of purchase confirmation response.

The distribution way of the distribution profit according to the order of payment is carried out by arranging the purchasers (hereinafter, referred to as “purchase confirmation purchasers”) who perform the purchase confirmation responses in the order of payment. In this case, the payment includes both of the guaranteed amount payment and the sales price payment. First, a first individual distribution profit calculated by multiplying the distribution profit and a distribution profit distribution rate is paid to a first purchase confirmation purchaser who performs the most rapid payment among the purchase confirmation purchasers, and next, a second individual distribution profit calculated by multiplying the amount remaining by subtracting the first individual distribution profit from the distribution profit and the distribution profit distribution rate is paid to a second purchase confirmation purchaser who performs the most rapid payment in second order among the purchase confirmation purchasers.

The distribution way of the distribution profit according to the amount of cyber money retained is carried out by arranging the purchase confirmation purchasers in the order according to values (hereinafter, referred to as “cyber money amount for order”) calculated by multiplying the cyber money amount of the cyber money accounts assigned to the accounts of the purchase confirmation purchasers and the number of payment certifications issued to the purchase confirmation purchasers. In this case, at least one selected from the group of the cyber money that is obtained by exchanging the cash of the purchase confirmation purchaser, the cyber money deposited as distribution profit from other events and the cyber money generated by activities of the member joined in the product sales promotion system 100 may be included in the cyber money account. First, a first individual distribution profit calculated by multiplying the distribution profit and a distribution profit distribution rate is paid to a first purchase confirmation purchaser who has the largest cyber money amount for order among the purchase confirmation purchasers, and next, a second individual distribution profit calculated by multiplying the amount remaining by subtracting the first individual distribution profit from the distribution profit and the distribution profit distribution rate is paid to a second purchase confirmation purchaser who has the largest cyber money amount for order in the second order among the purchase confirmation purchasers. For example, if one purchase confirmation purchaser receives five payment certificates, the cyber money amount for order of the purchase confirmation purchaser is calculated as “the amount of cyber money retained*5.”

The distribution way of the distribution profit according to the order of sales price payment is carried out by arranging the purchase confirmation purchasers in the order of sales price payment. In this case, the sales price payment includes both of the sales price payment after the payment of the guaranteed amount and the sales price payment having no guaranteed amount payment. First, a first individual distribution profit calculated by multiplying the distribution profit and a distribution profit distribution rate is paid to a first purchase confirmation purchaser who performs the most rapid sales price payment among the purchase confirmation purchasers, and next, a second individual distribution profit calculated by multiplying the amount remaining by subtracting the first individual distribution profit from the distribution profit and the distribution profit distribution rate is paid to a second purchase confirmation purchaser who performs the most rapid sales price payment in the second order among the purchase confirmation purchasers.

The distribution way of the distribution profit according to the order of purchase confirmation response is carried out by arranging the purchase confirmation purchasers in the order of purchase confirmation response. First, a first individual distribution profit calculated by multiplying the distribution profit and a distribution profit distribution rate is paid to a first purchase confirmation purchaser who performs the most rapid purchase confirmation response among the purchase confirmation purchasers, and next, a second individual distribution profit calculated by multiplying the amount remaining by subtracting the first individual distribution profit from the distribution profit and the distribution profit distribution rate is paid to a second purchase confirmation purchaser who performs the most rapid purchase confirmation response in the second order among the purchase confirmation purchasers.

In the distribution ways of the distribution profit as mentioned above, examples only for the first and second purchase confirmation purchasers are suggested, but in the same manner as above, individual distribution profits are of course paid to the purchase confirmation purchasers in the post-order. For example, a third individual distribution profit calculated by multiplying the amount remaining by subtracting the first individual distribution profit and the second individual distribution profit from the distribution profit and the distribution profit distribution rate is paid to a third purchase confirmation purchaser.

If the distribution profit remains even after the individual distribution profits are paid to all of the purchase confirmation purchasers, the distribution profit calculated by multiplying the remaining distribution profit and the distribution profit distribution rate is paid to the purchase confirmation purchasers again in the order of the purchase confirmation response in the same manner as above. If the remaining distribution profit is less than a given amount, however, the profit distribution unit 140 transfers the remaining distribution profit into the system account unit 150 and finishes the distribution of the distribution profit.

Now, an explanation on the effects obtained by the product sales promotion system and method according to an implementation of the disclosed technology will be given with a given example.

Any one sales agency of a computer manufacturing company A sells a laptop computer X for a retail price of 2,000 dollars. The average number of laptop computers X sold for a month in the sales agency is 50. Actually, the laptop computer is sold at the lowest price of 1,800 dollars on on-line markets.

The sales agency determines that they sell the laptop computer X for 1,800 dollars, which is the lowest price on on-line markets, through the product sales promotion system 100 according to an implementation of the disclosed technology, and the event is configured with the following conditions.
Sales price: 1,800 dollars
Target period of product sales: one month
Target number of computers sold: 2,000
Guaranteed amount: 20 dollars
Distribution profit to be distributed to purchasers if the event is successful: 780,000 dollars
Distribution way of distribution profit: distribution according to the amounts of cyber money retained in the cyber money accounts of purchase confirmation purchasers
Distribution rate of distribution profit: 0.1%

The sales agency can accomplish the number of laptop computers X sold which is more increased by 40 times than the number of laptop computers X sold for one month in the past, for only one month, which is the same period as in the past, so that the sales agency obtains additional cash of 3,510,000 dollars (=1,800 dollars*1,950) greater than cash of 100,000 dollars for one month in the past. The distribution profit of 780,000 dollars corresponding to about 22% of the additional cash is distributed to the purchasers (If it is desired for the sales agency to sell 1,950 laptop computers X in the conventional manner, a period of three years and three months is needed).

A purchaser B is a first purchaser having the largest cyber money account amount among the 2,000 purchasers, a purchaser C is a second purchaser having the largest cyber money account amount in the second order among the purchasers, a purchaser D is a 500th purchaser having the largest cyber money account amount in the 500th order among the purchasers, and a purchaser E is a 2000th purchaser having the largest cyber money account amount in the 2000th order among the purchasers. In this case, the cyber money to be distributed to the purchasers B, C, D and E will be calculated as follows.

[Amount to be Paid to Purchaser B]

Individual distribution profit of 780 dollars (=distribution profit of 780,000 dollars*distribution rate of distribution profit of 0.1%)

[Amount to be Paid to Purchaser C]

Individual distribution profit of 779 dollars (=amount of 779,220 dollars calculated by subtracting the first individual distribution profit of 780 dollars from distribution profit of 780,000 dollars*distribution rate of distribution profit of 0.1%)

[Amount to be Paid to Purchaser D]

Individual distribution profit of 473 dollars (=amount of 473,449 dollars calculated by subtracting the individual distribution profits of up to 499th purchasers from distribution profit of 780,000 dollars*distribution rate of distribution profit of 0.1%) [Amount to be paid to purchaser E]

Individual distribution profit of 106 dollars (=amount of 105,562 dollars calculated by subtracting the individual distribution profits of up to 1999th purchasers from distribution profit of 780,000 dollars*distribution rate of distribution profit of 0.1%)

The guaranteed amount of 20 dollars is paid back to the purchasers B, C, D and E, respectively, and the purchasers B, C, D and E purchase the laptop computer X of 1,800 dollars, which is the lowest price on on-line markets. According to the event success, furthermore, the purchasers B, C, D and E have got the respective individual distribution profits of 780 dollars, 779 dollars, 473 dollars, and 106 dollars in the form of cyber money. With a payment of the withdrawal fee, the cyber money in the cyber money account can be transferred into the cash account or cash can be withdrawn directly from the cyber money account, thereby increasing the cash assets of the purchaser. Further, since the order of the cyber money retention of the purchaser is raised by the cyber money distributed through this purchase, a larger amount of individual distribution profit can be distributed to the purchaser at the time of next purchase.

If the payment of the purchaser is made through the use of an interest-free installment program provided by a credit card company, the profit of the purchaser will be maximized. If the purchaser buys a 2,000 dollar laptop computer in the conventional purchase system, he or she just prepares 2,000 dollars, which makes him or her feel burdened so that he or she does not purchase the laptop computer. Through the product sales promotion system 100, the sales price is paid in interest-free installments, and next, the installment amount is paid with the individual distribution profit, thereby making the purchase burden of the purchase disappear. Such an advantage is obtained because the value of time is turned into the cyber money. Particularly, if the distribution rate of the distribution profit is raised by the seller, the amount of the distribution profit to be distributed to the top-order purchasers is increased, so that the consumption willingness and event join willingness of the members become high. An example of such a case will be explained later.

For a short period of time, of course, the seller accomplishes a substantially larger amount of sales than an amount of sales in the past, thereby obtaining a great sales profit, and even if the distribution profit is distributed, an amount of sales over several months to years can be obtained within the short period of time, so that no damage occurs. So as to improve the possibility of event success, further, if the distribution profit or the distribution rate of the distribution profit is raised by the seller, the event join desires of the members can be strongly stimulated, thereby rapidly and reliably achieving the target amount of product sales.

The product sales promotion system 100 can obtain profits with the system usage fee received from the seller when the event is activated by the seller and with the withdrawal fees received from the members when the cyber money is withdrawn from the cyber money accounts by the members. Further, if the number of events activated by numerous sellers over the world is uncountably large, the cash balance in the system account unit 150, which is obtained by the events, is kept to a very large amount of money. Therefore, a cyber money mortgage or secondary outsourcing investment can be conducted by means of the use of the system usage fees, the withdrawal fees, and the cash balance in the system account, thereby creating great profits.

The members withdraw the cyber money from their cyber money accounts and encash the cyber money, or they get a loan against their cyber money from the product sales promotion system 100. The members can encash their cyber money with a payment of the withdrawal fees, but in this case, an amount of cyber money retained in the cyber money account is decreased to cause the distribution order of the distribution profit of the event to be undesirably lowered. So as to perform the encashing of the cyber money in the state where the amount of cyber money retained is kept, accordingly, the product sales promotion system 100 pays in cash of the system account unit 150 for the loaned money against the cyber money of the members. As a result, the product sales promotion system 100 does a financial business.

Now, an explanation on more improved effects obtained by increasing the distribution profit and the distribution rate of the distribution profit through the seller in the product sales promotion system 100 and method according to an implementation of the disclosed technology will be given with a given example.

A famous fitness center A has sold a three-year membership X for a retail price of 3,000 dollars. The maximum number of three-year memberships X sold for a day in the fitness center A is 10. Actually, the three-year membership X is sold at the lowest price of 2,800 dollars on on-line markets, and the sales profit obtained when one three-year membership X is sold in the fitness center A is 1,650 dollars.

The fitness center A determines that they sell the three-year membership X for 2,800 dollars, which is the lowest price on on-line markets, through the product sales promotion system according to an implementation of the disclosed technology, and the event is configured with the following conditions.
Sales price: 2,800 dollars
Target period of product sales: one day
Target number of memberships sold: 1,000
Guaranteed amount: 1,300 dollars
Distribution profit to be distributed to purchasers if the event is successful: 1,300,000 dollars
Distribution way of distribution profit: distribution according to the payment order of purchase confirmation purchasers
Distribution rate of distribution profit: 0.6%

The fitness center A can accomplish the number of memberships sold that is more increased by 100 times than the number of memberships sold for one day in the past, for only one day, which is the same period as in the past, so that the fitness center A obtains additional cash of 2,772,000 dollars (=2,800 dollars*990) greater than cash of 30,000 dollars for one day in the past.

Further, the fitness center A obtains additional sales profit of 1,633,500 dollars (=1,650 dollars*990) greater than a sales profit of 16,500 dollars for one day in the past.

The distribution profit of 1,300,000 dollars corresponding to about 78% of the additional sales profit is distributed to the purchasers (If it is desired for the fitness center to sell 990 three-year memberships in the conventional manner, a period of at least about three months is needed, and even after about the three months, of course, selling of the 990 three-year memberships cannot be ensured).

A purchaser B is a first purchaser who is in the first payment order among the 1,000 purchasers, a purchaser C is a second payment order, a purchaser D is in the 500th payment order, and a purchaser E is in 1,000th payment order. In this case, the cyber money to be distributed to the purchasers B, C, D and E will be calculated as follows.

[Amount to be Paid to Purchaser B]

Individual distribution profit of 7,800 dollars (=distribution profit of 1,300,000 dollars*distribution rate of distribution profit of 0.6%)

[Amount to be Paid to Purchaser C]

Individual distribution profit of 7,753 dollars (=amount of 1,292,200 dollars calculated by subtracting the first individual distribution profit of 7,800 dollars from distribution profit of 1,300,000 dollars*distribution rate of distribution profit of 0.6%)

[Amount to be Paid to Purchaser D]

Individual distribution profit of 387 dollars (=amount of 64,528 dollars calculated by subtracting the individual distribution profits of up to 499th purchasers from distribution profit of 1,300,000 dollars*distribution rate of distribution profit of 0.6%)

[Amount to be Paid to Purchaser E]

Individual distribution profit of 19 dollars (=amount of 3,184 dollars calculated by subtracting the individual distribution profits of up to 999th purchasers from distribution profit of 1,300,000 dollars*distribution rate of distribution profit of 0.6%)

The guaranteed amount of 1,300 dollars is paid back to the purchasers B, C, D and E, respectively, and the purchasers B, C, D and E purchase the three-year memberships of 2,800 dollars, which is the lowest price on on-line markets. According to the event success, furthermore, the purchasers B, C, D and E have got the respective individual distribution profits of 7,800 dollars, 7,753 dollars, 387 dollars, and 19 dollars in the form of cyber money.

With a payment of the withdrawal fee, the cyber money in the cyber money account may be transferred into the cash account or cash may be withdrawn directly from the cyber money account, thereby increasing the cash assets of the purchaser. Further, the purchasers B and C who in the first and second distribution order of the distribution profit can earn a great amount of money, even if the price of the three-year membership is subtracted from the distribution profit. Their wealth is increased through their consumption.

Through the two examples as mentioned above, it can be appreciated that the product sales promotion system 100 according to an implementation of the disclosed technology provides a consuming-tech (consumption+financial technology) system that increases wealth through consumption, and as large consumption is made, wealth is increased, so that consumption, deal and turnover ratio are optimized to achieve the advancement into a new economic paradigm unlike the conventional economic paradigm.

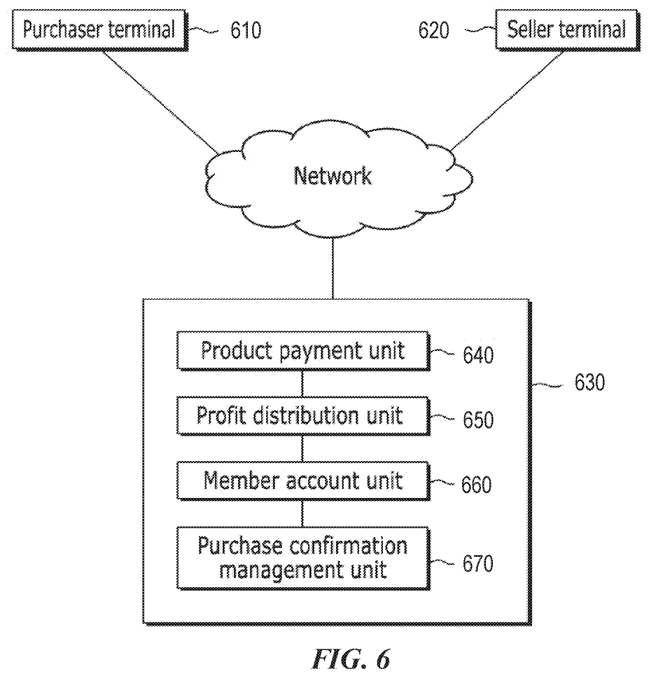

FIG. 6 is an exemplary block diagram showing a configuration of a sales profit distribution system according to an implementation of the disclosed technology.

A sales profit distribution system according to an implementation of the disclosed technology relates to a system for distributing a distribution profit to a purchaser who purchases a product when a target amount of product sales is reached within a target period of time for the product sales, and may include a product payment unit 640 and a profit distribution unit 650. The profit distribution unit 650 may be adapted to calculate an individual distribution profit to be distributed to the purchaser from the distribution profit. The event may be configured by a seller or the system.

A purchaser may be connected to the sales profit distribution system as shown in FIG. 6 by using a purchaser terminal 610 through the wired and wireless network. The purchaser terminal 610 may be or include devices for transmitting and receiving data to and from the sales profit distribution system connected thereto, and for example, desktop computers, laptops, smart phones, tablet computers, and so on may be used as the purchaser terminal 610. However, the purchaser terminal 610 is not limited to those mentioned above.

If the event is activated, the purchaser may purchase the product through the purchaser terminal 610. So as to purchase the product, the purchaser may make a payment for the sales price of the product on a payment screen provided by the product payment unit 640 through the purchaser terminal 610.

If the number of products sold for a target period of time for product sales reaches the target amount of product sales to thus finish the event, the profit distribution unit 650 may calculate an individual distribution profit to be distributed to the purchaser from a distribution profit.

The profit distribution unit 650 may distribute the distribution profit according to the order of payment. The profit distribution unit 650 arranges the purchasers in the order of payment. Next, the profit distribution unit 650 pays a first individual distribution profit calculated by multiplying the distribution profit by a distribution rate of the distribution profit to a first purchaser who performs the earliest payment among the purchasers, and then pays a second individual distribution profit calculated by multiplying an amount remained after subtracting the first individual distribution profit from the distribution profit by the distribution rate of the distribution profit to a second purchaser who performs the second earliest payment among the purchasers.

The sales profit distribution system according to an implementation of the disclosed technology may further include a member account unit 660.

The purchaser may be a member who joins the sales profit distribution system 100, and the members of the sales profit distribution system may have cyber money accounts and cash accounts connected to their own accounts. The cyber money accounts and the cash accounts may be included in the member account unit 660. The cyber money deposited into the cyber money accounts may be used as a distribution standard when a distribution profit is distributed, and the individual distribution profit is put into the cyber money accounts in the form of cyber money. However, the individual distribution profit may be transferred to the cash account in the form of cash.

The profit distribution unit 650 may distribute the distribution profit according to the amount of cyber money retained. The profit distribution unit 650 arranges the purchasers in the order of the cyber money amount deposited into the member account unit 660 of the purchaser. Next, the profit distribution unit 650 pays a first individual distribution profit calculated by multiplying the distribution profit by the distribution rate of the distribution profit to a first purchaser who has the largest cyber money amount among the purchasers, and then pays a second individual distribution profit calculated by multiplying an amount remained after subtracting the first individual distribution profit from the distribution profit by the distribution rate of the distribution profit to a second purchaser who has the second largest cyber money amount among the purchasers.

Further, the profit distribution unit 650 may distribute the distribution profit according to the amount of cyber money retained and the number of payments. The profit distribution unit 650 arranges the purchasers in the order of a value calculated by multiplying a cyber money amount deposited into the member account unit of the purchaser by the number of the payments of the purchaser (hereinafter, referred to as a “cyber money amount for order”). Next, the profit distribution unit 650 pays a first individual distribution profit calculated by multiplying the distribution profit by the distribution rate of the distribution profit to a first purchaser who has the largest cyber money amount for order among the purchasers, and then pays a second individual distribution profit calculated by multiplying an amount remained after subtracting the first individual distribution profit from the distribution profit by the distribution rate of the distribution profit to a second purchaser who has the second largest cyber money amount for order among the purchasers. For example, if one purchaser makes five payments, the cyber money amount for order of the purchaser is calculated as the amount of cyber money retained*5.

The sales profit distribution system according to an implementation of the disclosed technology may further include a purchase confirmation management unit 670. The purchase confirmation management unit 670 may transmit a purchase confirmation request to the purchaser who receives the purchased product and may receive a purchase confirmation response or a purchase cancel response as a response to the purchase confirmation request from the purchaser terminal 610. The purchase confirmation response is the purchaser's willingness to get no refund, and the purchase cancel response is the purchaser's willingness to get a refund.

The profit distribution unit 650 may distribute the distribution profit according to the order of purchase confirmation response. The profit distribution unit 650 arranges the purchasers in the order of purchase confirmation response. Next, the profit distribution unit 650 pays a first individual distribution profit calculated by multiplying the distribution profit by the distribution rate of the distribution profit to a first purchaser who transmits the earliest purchase confirmation response among the purchasers, and then pays a second individual distribution profit calculated by multiplying an amount remained after subtracting the first individual distribution profit from the distribution profit by the distribution rate of the distribution profit to a second purchaser who transmits the second earliest purchase confirmation response among the purchasers.

In the distribution ways of the distribution profit as mentioned above, examples only for the first and second purchase confirmation purchasers are suggested, but in the same manner as above, individual distribution profits may be paid to the purchase confirmation purchasers in the post-order. For example, a third individual distribution profit calculated by multiplying the amount remained after subtracting the first individual distribution profit and the second individual distribution profit from the distribution profit by the distribution rate of the distribution profit may be paid to a third purchase confirmation purchaser.

If the distribution profit remains after the individual distribution profits are paid to all of the purchase confirmation purchasers, another first individual distribution profit calculated by multiplying the remaining distribution profit by the distribution rate of the distribution profit may be paid to the first purchase confirmation purchasers again and then the distribution of the remaining distribution profit may proceed in the same manner as above. If the remaining distribution profit is less than a predetermined amount, however, the profit distribution unit 650 may finish the distribution of the individual distribution profit. The sales profit distribution system according to an implementation of the disclosed technology may be applied to a variety of online sales systems.

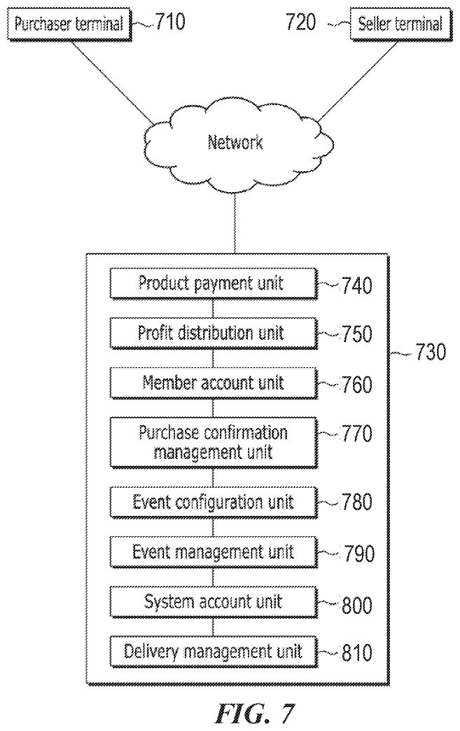

FIG. 7 is an exemplary block diagram showing a configuration of a sales profit distribution system according to another implementation of the disclosed technology.

A sales profit distribution system according to another implementation of the disclosed technology may include a product payment unit 740, a profit distribution unit 750, a member account unit 760, a purchase confirmation management unit 770, an event configuration unit 780, an event management unit 790, a system account unit 800 and a delivery management unit 810.

A purchaser may be connected to the sales profit distribution system by using a purchaser terminal 710 through the wired and wireless network. A seller may be connected to the sales profit distribution system by using a seller terminal 720 through wired and wireless network. The purchaser terminal 710 and the seller terminal 720 may be devices for transmitting and receiving data to and from the sales profit distribution system connected thereto, and for example, desktop computers, laptops, smart phones, tablet computers, and so on may be used as the seller terminal 720 and the purchaser terminal 710. However, the purchaser terminal 710 and the seller terminal 720 are not limited to those mentioned above.

The seller and the purchaser may be members who join the sales profit distribution system, and the members of the sales profit distribution system may have cyber money accounts and cash accounts connected to their own accounts. The cyber money accounts and the cash accounts may be included in the member account unit 760. The cyber money deposited into the cyber money accounts may be used to decide distribution amounts for the respective purchasers. Thus, the cyber money deposited into the cyber money accounts may provide a distribution standard for distributing a distribution profit, which will be discussed later, and the distribution profit are put into the cyber money accounts in the form of cyber money. However, the distribution profit may be transferred to the cash account in the form of cash. The cash in the cash accounts may be transferred to the cyber money accounts, exchanged with the cyber money in the ratio of 1:1 or in a predetermined ratio, and deposited into the cyber money accounts. Contrarily, the cyber money in the cyber money accounts may be transferred to the cash accounts, but in this case, a withdrawal fee at a predetermined percentage for the transferring money may be paid. The cyber money may be referred to as different names, for example, reward points, mileages, coupons, credits, gifts, incentives, energy currency, etc.

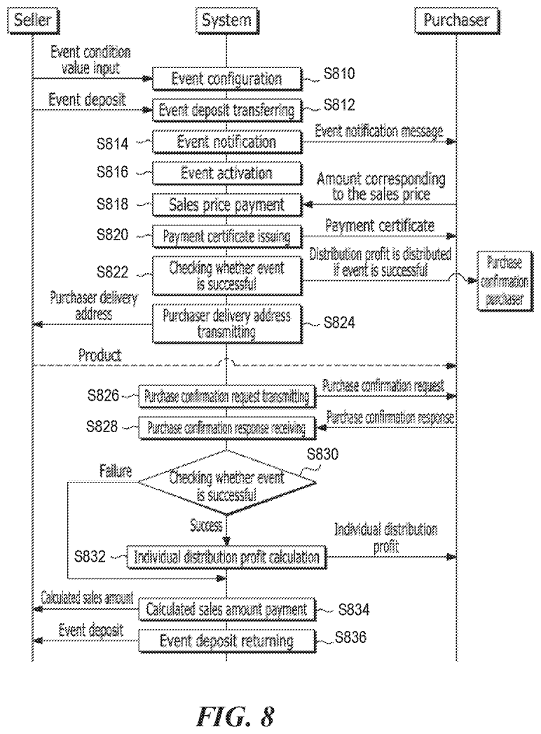

FIG. 8 is an exemplary flowchart showing the processes of selling products and distributing sales profit in the sales profit distribution system according to another implementation of the disclosed technology, wherein the purchaser makes a payment for a sales price on an event configured by the seller and performs a purchase confirmation response.

The seller is connected to the sales profit distribution system by using the seller terminal and he or she selects an event configuration menu so as to configure an event to be successful when a target amount of product sales is achieved for a target period of time for product sales. The event configuration unit 780 displays, on the seller terminal, an input screen where, as event condition values, the sales price of a product, the target period of time for product sales, the target amount of product sales, distribution profit to be distributed to the purchasers performing purchase confirmation responses if the event is successful, a distribution way of the distribution profit, and a distribution rate of the distribution profit are inputted, and the seller inputs, on the seller's terminal, the sales price of the product to be sold through the sales profit distribution system, the target period of time for product sales, the target amount of product sales, the distribution profit, the distribution way of the distribution profit, and the distribution rate of the distribution profit. The values inputted to the event configuration unit 780 through the seller terminal are stored in the event configuration unit 780, thereby completing configuring the event (at step S810).

If the payment for the sales price of the product is made, a payment certificate is issued by the event management unit 790, and if the number of payment certificates reaches the target amount of product sales, it is considered that the event is successful.

The sales price of the product, the target period of time of product sales, the target amount of product sales, distribution profit, the distribution way of the distribution profit, and the distribution rate of the distribution profit may be arbitrarily determined by the seller, and some of them may be suggested with appropriate values by means of the sales profit distribution system. Further, some of them may be in advance calculated as optimized values by means of the sales profit distribution system and provided as fixed values.

The event management unit 790 transmits, a message that the amount corresponding to the distribution profit, as the event deposit, must be deposited into the system account unit 800, to the seller terminal. Through the seller terminal, the seller requests the event management unit 790 to transfer the event deposit having the same amount as the distribution profit from the cyber money account or cash account connected to the seller's account to the system account unit 800, and the event management unit 790 transfers the event deposit from the cyber money account or cash account of the seller to the system account unit 800 (at step S812). The cash may be transferred to the system account unit 800, and in case where the cash is transferred as the event deposit from the cyber money account to the system account unit 800, the withdrawal fee may occur so that the amount corresponding to the event deposit and the withdrawal fee may be withdrawn from the cyber money account.

Before the event is activated, the event management unit 790 may transfer an event notification message of notifying the members joined in the sales profit distribution system of the start date and start time of the event activation to the terminals of the members (at step S814). As the start date and start time of the event activation are in advance notified, fair sales can be ensured in case where the distribution way of the distribution profit is determined according to the order of payment (that is, the payment certificate issue order) or the order of purchase confirmation response. As a result, the event notification message can prevent the first occupation in the distribution order of the distribution profit by the purchasers who in advance obtain the event information.

Before the activation of the event, further, the event management unit 790 may notify the members of a period of time during which it is possible to start the event, and it is possible to unexpectedly start the activation of the event within the period of time. For example, the event management unit 260 may notify the members of a period of time during which it is possible to start the event, for example, between May 1, 2016 and May 8, 2106, and without any additional notification, the event may be activated on May 3, 2016, 1 pm.

The event management unit 790 may activate the event configured through the event configuration unit 780 by the seller terminal 720 of the seller (at step S816). Before the event is activated by the seller, the event management unit 790 may request the seller terminal 720 to deposit a system usage fee, and if it is checked that the system usage fee is deposited into the system account unit 800, the event management unit 790 may activate the event.

In the state where the event notification message is not sent to the members joined in the sales profit distribution system before the activation of the event, it is possible that the event is activated on the start date and time of the event, without any notification.

The event management unit 790 may activate the event after a predetermined standby period from the start time of the event, not on the start time of the event set in the event configuration unit 780 through the seller terminal 720 of the seller. In case where the distribution way of the distribution profit is determined according to the order of payment (that is, the payment certificate issue order) or the order of purchase confirmation response, accordingly, fair sales can be ensured. For the predetermined standby period, in detail, the members can obtain the event information, thereby preventing the first occupation in the distribution order of the distribution profit by the purchasers who in advance obtain the event information.

If the event is activated through the event management unit 790 (at the step S816), the product may be purchased through the purchaser terminal 710 of the purchaser.

So as to purchase the product, the purchaser makes a payment for the sales price on the payment screen provided through the product payment unit 740 by the purchaser terminal 710, and the product payment unit 740 deposits the paid amount for the sales price into the system account unit 800 (at step S818). The paid amount for the sales price may be the cyber money and/or the cash withdrawn from the cyber money account and/or cash account of the purchaser, card sales amount received from a credit card company of the purchaser, and payment amount received from a smart phone communication company of the purchaser. The payment ways include known online payment ways, and a detailed explanation on the payment ways will be omitted.

If the payment for the sales price is made, the event management unit 790 may issue the payment certificate and may transmit the payment certificate to the purchaser terminal 710 (at step S820).

Whenever the event management unit 790 issues the payment certificates for the respective purchasers, it checks whether the event is successful (at step S822). As the target amount of product sales is accomplished through the purchaser who makes payment for the sales price, it may be checked whether the event is successful. If it is checked that the event is successful through the purchasers who make payments for the sales price, the distribution profit starts to be distributed to the other purchasers who have purchased the products, have performed the purchase confirmation responses, and have been waiting for the event success.

The delivery management unit 810 may transmit a delivery address and a payment certificate of the purchaser who makes a payment for the sale price to the seller terminal 720 to allow the seller to deliver the product to the purchaser (at step S824). A delivery way may include a delivery service and a direct delivery to the purchaser, and if the product is delivered directly to the purchaser, the seller scans bar codes on the payment certificate provided by the purchaser. After the purchaser is identified, accordingly, the product is taken over to the purchaser.

The purchase confirmation management unit 770 may transmit the purchase confirmation request to the purchaser who receives the product through the delivery service or directly receives the product from the seller (at step S826).

The purchase confirmation management unit 770 may receive the response to the purchase confirmation request from the purchaser (at step S828). The response to the purchase confirmation request is either the purchase confirmation response or the purchase cancel response. Hereinafter, an explanation on the case where the response to the purchase confirmation request is the purchase confirmation response will be given.

If the purchase confirmation management unit 770 receives the purchase confirmation response from the purchaser, the event management unit 790 may check whether the event is successful (at step S830). If the event management unit 790 checks that the number of payment certificates issued by the payments for the products reaches the target amount of product sales, it is determined that the event is successful, and the profit distribution unit 750 may pay an individual distribution profit calculated from the distribution profit, in cyber money, to the purchaser who performs the purchase confirmation response (at step S832). The profit distribution unit 750 may apply the distribution way of the distribution profit and the distribution rate of the distribution profit to the distribution profit to calculate the individual distribution profit. The individual distribution profit may be withdrawn from the amount kept in the system account unit 800 and may be transferred to the cyber money account of the purchaser who performs the purchase confirmation response. The distribution profit is paid in cyber money, but it is possible that the distribution profit is transferred, in cash, to the cash account of the purchaser who performs the purchase confirmation response.

After the individual distribution profit is paid through the profit distribution unit 750 (at the step S832), the event management unit 790 may transfer the sales amount calculated by subtracting the sum of the paid individual distribution profits from the total sales amount (calculated by multiplying the sales price by the number of purchase confirmed products) to the cash account of the seller (at step S834) and may return the event deposit in the system account unit 800 to the cash account of the seller (at step S836). In this case, an explanation on S830, S832, S834 and S836 which are sequentially performed is paid, but the steps may be performed concurrently or in a reverse order to each other.

If it is checked by the event management unit 260 that the number of payment certificates issued by the payments for the products does not reach the target amount of product sales (at the step S210), it is determined that the event fails. If the event fails, the step of distributing the individual distribution profit (at the step S220) is not performed.

If the event fails, the event management unit 790 may transfer the total sales amount (calculated by multiplying the sales price by the number of purchase confirmed products) to the cash account of the seller (at the step S834) and may return the event deposit in the system account unit 800 to the cash account of the seller (at the step S836). In this case, an explanation on the steps S830, S834 and S836 which are sequentially performed is paid, but the steps may be performed concurrently or in a reverse order to each other.

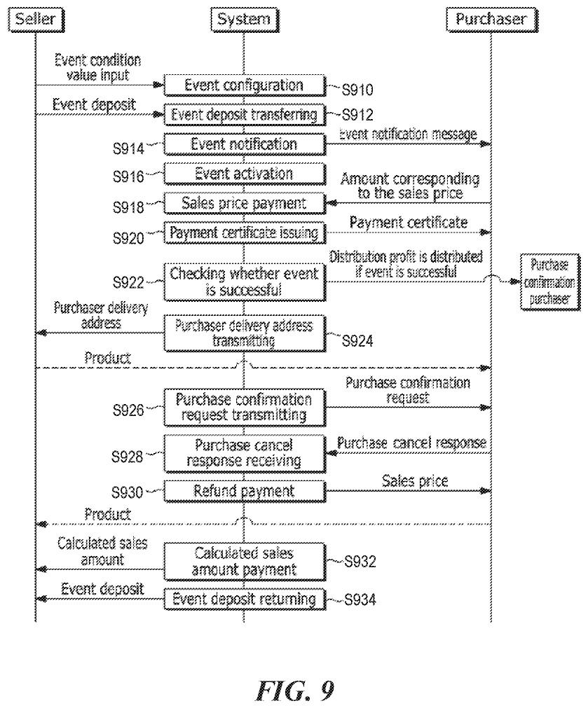

FIG. 9 is an exemplary flowchart showing the case where the purchase confirmation management unit 770 at the step S832 of FIG. 8 receives the purchase cancel response from the purchaser, wherein since the steps S910 to S926 are the same as S810 to S826 of FIG. 8, an explanation on them will be omitted.

The purchase confirmation management unit 770 may transmit the purchase confirmation request to the purchaser (at the step S926).

The purchase confirmation management unit 770 may receive the response to the purchase confirmation request from the purchaser (at the step S928). The response to the purchase confirmation request is either the purchase confirmation response or the purchase cancel response. Hereinafter, an explanation on the case where the response to the purchase confirmation request is the purchase cancel response will be given. The purchase cancel response is the purchaser's willingness to get a refund in case where the purchased product is unsatisfied.

If the purchase confirmation management unit 770 receives the purchase cancel response from the purchaser (at step S928), the profit distribution unit 750 pays the amount corresponding to the sales price, as a refund, to the purchaser who performs the purchase cancel response (at step S930). The refund may be withdrawn from the amount kept in the system account unit 800 and thus may be transferred to the cash account of the purchaser who performs the purchase cancel response.

After the profit distribution unit 750 pays the individual distribution profits to the purchasers who perform the purchase confirmation response, the event management unit 790 may transfer the sales amount calculated by subtracting the sum of the paid individual distribution profits from the total sales amount (calculated by multiplying the sales price and the number of purchase confirmed products) to the cash account of the seller (at step S932) and may return the event deposit in the system account unit 800 to the cash account of the seller (at step S934).

An expected distribution order in the sales profit distribution system and method according to an implementation of the disclosed technology may be calculated before the purchase confirmation responses of the purchasers are completed. Whenever the payment certificates are issued by the event management unit 790, the profit distribution unit 750 may calculate an expected distribution order of the purchasers in real time to transmit the real time expected distribution order to the terminals 710 of the purchasers.

In this case, of course, the profit distribution unit 750 may not publish the real time expected distribution order until the event is successful, and after the event is successful, the profit distribution unit 750 may transmit the real time expected distribution order to the terminals 710 of the purchasers. Until the event is successful, as a result, the purchasers cannot obtain the information on their real time expected distribution order, so that such uncertainty in the real time expected distribution order makes purchase desires more stimulated, thereby allowing the event to be successful within a shorter period of time.

The distribution way of the distribution profit in the sales profit distribution system and method according to another implementation of the disclosed technology may be selected by the seller. For example, the distribution way of the distribution profit may be determined according to the order of payment (that is, the payment certificate issue order), an amount of cyber money retained, or the order of purchase confirmation response.

The distribution way of the distribution profit according to the order of payment may be carried out by arranging purchasers who perform the purchase confirmation responses (hereinafter, referred to as “purchase confirmation purchasers”) in the order of payment. First, a first individual distribution profit calculated by multiplying the distribution profit by a distribution rate may be paid to a first purchase confirmation purchaser who performs the earliest payment among the purchase confirmation purchasers, and next, a second individual distribution profit calculated by multiplying the amount remained after subtracting the first individual distribution profit from the distribution profit by the distribution rate of the distribution profit may be paid to a second purchase confirmation purchaser who performs the payment in the second earliest among the purchase confirmation purchasers.

The distribution way of the distribution profit according to the amount of cyber money retained is carried out by arranging the purchase confirmation purchasers in the order of the cyber money amount of the cyber money account allocated to the account of the purchase confirmation purchaser. In this case, the cyber money deposited into the cyber money account may include the cyber money exchanged from the cash of the purchase confirmation purchaser, and the cyber money deposited as distribution profit transferred from other events. Next, a first individual distribution profit calculated by multiplying the distribution profit by the distribution rate of the distribution profit is paid to a first purchase confirmation purchaser who has the largest cyber money amount among the purchase confirmation purchasers, and a second individual distribution profit calculated by multiplying the amount remained after subtracting the first individual distribution profit from the distribution profit by the distribution rate of the distribution profit is paid to a second purchase confirmation purchaser who has the second largest cyber money amount among the purchase confirmation purchasers.

The distribution way of the distribution profit according to the amount of cyber money retained is carried out on the basis of the number of the payments of the purchase confirmation purchasers. The distribution way may be carried out by arranging the purchase confirmation purchasers in the order according to a value calculated by multiplying the cyber money amount of the cyber money accounts included in the account of the purchase confirmation purchaser by the number of payment certifications issued to the purchase confirmation purchaser (hereinafter, referred to as a “cyber money amount for order”). In this case, the cyber money deposited into the cyber money account may include the cyber money exchanged from the cash of the purchase confirmation purchaser, and the cyber money deposited as distribution profit transferred from other events. Then, a first individual distribution profit calculated by multiplying the distribution profit by the distribution rate of the distribution profit may be paid to a first purchase confirmation purchaser who has the largest cyber money amount for order among the purchase confirmation purchasers, and next, a second individual distribution profit calculated by multiplying the amount remained after subtracting the first individual distribution profit from the distribution profit by the distribution rate of the distribution profit may be paid to a second purchase confirmation purchaser who has the second largest cyber money amount for order among the purchase confirmation purchasers. For example, if one purchase confirmation purchaser receives five payment certificates, the cyber money amount for order of the purchase confirmation purchaser is calculated as the amount of cyber money retained*5. The distribution way of the distribution profit according to the order of purchase confirmation response may be carried out by arranging the purchase confirmation purchasers in the order of purchase confirmation response. First, a first individual distribution profit calculated by multiplying the distribution profit by the distribution rate of the distribution profit may be paid to a first purchase confirmation purchaser who performs the earliest purchase confirmation response among the purchase confirmation purchasers, and next, a second individual distribution profit calculated by multiplying the amount remained after subtracting the first individual distribution profit from the distribution profit by the distribution rate of the distribution profit may be paid to a second purchase confirmation purchaser who performs the purchase confirmation response in the second earliest among the purchase confirmation purchasers.

In the distribution ways of the distribution profit as mentioned above, examples only for the first and second purchase confirmation purchasers are suggested, but in the same manner as above, individual distribution profits may be paid to the purchase confirmation purchasers in the post-order. For example, a third individual distribution profit calculated by multiplying the amount remained after subtracting the first individual distribution profit and the second individual distribution profit from the distribution profit by the distribution rate of the distribution profit may be paid to a third purchase confirmation purchaser.

If the distribution profit remains after the individual distribution profits are paid to all of the purchase confirmation purchasers, another first individual distribution profit calculated by multiplying the remaining distribution profit by the distribution rate of the distribution profit may be paid to the first purchase confirmation purchasers again and then the distribution of the remaining distribution profit may proceed in the same manner as above. If the remaining distribution profit is less than a predetermined amount, however, the profit distribution unit 750 may transfer the remaining distribution profit into the system account unit 800 and may finish the distribution of the distribution profit.

Now, an explanation on the effects obtained by the sales profit distribution system and method according to an implementation of the disclosed technology will be given with a given example.

One sales agency of a computer manufacturing company A sells a laptop computer X at a retail price of 2,000 dollars. The average number of laptop computers X sold for a month in the sales agency is 50. Actually, the laptop computer is sold at the lowest price of 1,800 dollars on on-line markets. The sales agency determines that they sell the laptop computer X at the lowest price of 1,800 dollars through the sales profit distribution system according to an implementation of the disclosed technology, and the event is configured with the following conditions.
Sales price: 1,800 dollars
Target period of time for product sales: one month
Target amount of product sales: 2,000
Distribution profit to be distributed to purchasers if the event is successful: 780,000 dollars
Distribution way of the distribution profit: distribution according to cyber money amounts retained in the cyber money accounts of purchase confirmation purchasers
Distribution rate of the distribution profit: 0.1%

The sales agency can accomplish the number of laptop computers X sold which is more increased by 40 times than the number of laptop computers X sold for one month in the past, for only one month, which is the same period as in the past, so that the sales agency obtains additional cash of 3,510,000 dollars (=1,800 dollars*1,950) greater than cash of 100,000 dollars for one month in the past. The distribution profit of 780,000 dollars corresponding to about 22/of the additional cash is distributed to the purchasers (If it is desired for the sales agency to sell 1,950 laptop computers X in the conventional manner, a period of three years and three months is needed).

Purchaser B is a first purchaser having the largest cyber money amount among 2,000 purchasers, Purchaser C is a second purchaser having the second largest cyber money amount among the purchasers, Purchaser D is a 500th purchaser having the 500th largest cyber money amount among the purchasers, and Purchaser E is a 2000th purchaser having the 2000th largest cyber money amount among the purchasers. In this case, the cyber money to be distributed to Purchasers B, C, D and E will be calculated as follows.

[Amount to be Paid to Purchaser B]
Individual distribution profit of 780 dollars [=distribution profit of 780,000 dollars*distribution rate of 0.1%]

[Amount to be Paid to Purchaser C]
Individual distribution profit of 779 dollars [=(amount of 779,220 dollars calculated by subtracting the first individual distribution profit of 780 dollars from distribution profit of 780,000 dollars)*(distribution rate of 0.1%)]

[Amount to be Paid to Purchaser D]
Individual distribution profit of 473 dollars [=(amount of 473,449 dollars calculated by subtracting the individual distribution profits of up to 499th purchasers from distribution profit of 780,000 dollars)*(distribution rate of 0.1%)]

[Amount to be Paid to Purchaser E]
Individual distribution profit of 106 dollars [(=amount of 105,562 dollars calculated by subtracting the individual distribution profits of up to 1999th purchasers from distribution profit of 780,000 dollars)*(distribution rate of 0.1%)]

Purchasers B, C, D and E purchase the laptop computer X of 1,800 dollars, which is the same price as the lowest price sold on on-line markets. According to the event success, furthermore, Purchasers B, C, D and E have got the respective individual distribution profits of 780 dollars, 779 dollars, 473 dollars, and 106 dollars in the form of cyber money. With a payment of the withdrawal fee, the cyber money in the cyber money account may be transferred to the cash account or cash may be withdrawn directly from the cyber money account, thereby increasing the cash assets of the purchaser. Further, since the order of the cyber money retention of the purchaser is raised by the cyber money distributed through this purchase, a larger amount of individual distribution profit may be distributed to the purchaser at the time of next purchase.

If the payment of the purchaser is made through the use of an interest-free installment program provided by a credit card company, the profit of the purchaser will be maximized. If the purchaser buys a 2,000 dollar laptop computer in a conventional purchase system, he or she just prepares 2,000 dollars, which makes him or her feel burdened so that he or she does not purchase the laptop computer. Through the sales profit distribution system 200, the sales price is paid in interest-free installments, and next, the installment amount is paid with the individual distribution profit, thereby making the purchase burden of the purchase disappear. Such an advantage is obtained because the value of time is turned into the cyber money. Particularly, if the distribution rate of the distribution profit is raised by the seller, the amount of the distribution profit to be distributed to the top-order purchasers is increased, so that the consumption willingness and event join willingness of the members become high. An example of such a case will be explained later.

For a short period of time, of course, the seller accomplishes a significantly larger amount of sales than an amount of sales in the past, thereby obtaining a great sales profit, and even if the distribution profit is distributed, an amount of sales over several months to years can be obtained within the short period of time, so that no financial damage occurs. So as to improve the possibility of event success, further, if the distribution profit or the distribution rate of the distribution profit is raised by the seller, the event join desires of the members can be strongly stimulated, thereby rapidly and reliably achieving the target amount of product sales.

The sales profit distribution system can obtain profits with the system usage fee received from the seller when the event is activated by the seller and with the withdrawal fees received from the members when the cyber money is withdrawn from the cyber money accounts by the members. Further, if the number of events activated by numerous sellers over the world is uncountably large, the cash balance in the system account unit 270, which is obtained by the events, is kept to a very large amount of money. Therefore, a cyber money mortgage or secondary outsourcing investment can be conducted by means of the use of the system usage fees, the withdrawal fees, and the cash balance in the system account, thereby creating great profits.

The members may withdraw the cyber money from their cyber money accounts and encash the cyber money, or they may get a loan against their cyber money from the sales profit distribution system 200. The members can encash their cyber money with a payment of the withdrawal fees, but in this case, an amount of cyber money retained in the cyber money account is decreased to cause the distribution order of the event to be undesirably lowered. So as to perform the encashing of the cyber money in the state where the amount of cyber money retained is kept, accordingly, the sales profit distribution system 200 may lend cash to the members with their cyber money as collateral. As a result, the sales profit distribution system 200 may do a financial business.

Now, an explanation on more improved effects obtained by increasing the distribution profit and the distribution rate of the distribution profit through the seller in the sales profit distribution system 200 and method according to implementations of the disclosed technology will be given with a given example.

A famous fitness center A sells a three-year membership X at a retail price of 3,000 dollars. The maximum number of three-year memberships X sold for a day in the fitness center A is 10. Actually, the three-year membership X is sold at the lowest price of 2,800 dollars on on-line markets, and the sales profit obtained when one three-year membership X is sold at the fitness center A is 1,650 dollars.

The fitness center A determines that they sell the three-year membership X at the lowest price of 2,800 dollars through the sales profit distribution system according to implementations of the disclosed technology, and the event is configured with the following conditions.
Sales price: 2,800 dollars
Target period of time for product sales: one day
Target amount of product sales: 1,000
Distribution profit to be distributed to purchasers if the event is successful: 1,300,000 dollars
Distribution way of the distribution profit: distribution according to payment order of purchase confirmation purchasers
Distribution rate of the distribution profit: 0.6%

The fitness center A can accomplish the number of memberships sold that is more increased by 100 times than the number of memberships sold for one day in the past, for only one day, which is the same period as in the past, so that the fitness center A obtains additional cash of 2,772,000 dollars (=2,800 dollars*990) greater than cash of 30,000 dollars for one day in the past.

Further, the fitness center A obtains additional sales profit of 1,633,500 dollars (=1,650 dollars*990) greater than a sales profit of 16,500 dollars for one day in the past.

The distribution profit of 1,300,000 dollars corresponding to about 78% of the additional sales profit is distributed to the purchasers (If it is desired for the fitness center to sell 990 three-year memberships in the conventional manner, a period of at least about three months is needed, and even after about the three months, of course, selling of the 990 three-year memberships cannot be ensured).

Purchaser B is a first purchaser who is in the first payment order among the 1,000 purchasers, Purchaser C is a second payment order, Purchaser D is in the 500th payment order, and Purchaser E is in 1,000th payment order. In this case, the cyber money to be distributed to Purchasers B, C, D and E will be calculated as follows.

[Amount to be Paid to Purchaser B]
Individual distribution profit of 7,800 dollars [=distribution profit of 1,300,000 dollars*distribution rate of 0.6%)]

[Amount to be Paid to Purchaser C]
Individual distribution profit of 7,753 dollars [=(amount of 1,292,200 dollars calculated by subtracting the first individual distribution profit of 7,800 dollars from distribution profit of 1,300,000 dollars)*(distribution rate of 0.6%)]

[Amount to be Paid to Purchaser D]
Individual distribution profit of 387 dollars [=(amount of 64,528 dollars calculated by subtracting the individual distribution profits of up to 499th purchasers from distribution profit of 1,300,000 dollars)*(distribution rate of 0.6%)]

[Amount to be Paid to Purchaser E]
Individual distribution profit of 19 dollars [=(amount of 3,184 dollars calculated by subtracting the individual distribution profits of up to 999th purchasers from distribution profit of 1,300,000 dollars)*(distribution rate of 0.6%)]

Purchasers B, C, D and E purchase the three-year membership of 2,800 dollars, which is the same price as the lowest price sold on on-line markets. According to the event success, furthermore, Purchasers B, C, D and E have got the respective individual distribution profits of 7,800 dollars, 7,753 dollars, 387 dollars, and 19 dollars in the form of cyber money. With a payment of the withdrawal fee, the cyber money in the cyber money account may be transferred to the cash account or cash may be withdrawn directly from the cyber money account, thereby increasing the cash assets of the purchaser. Further, Purchasers B and C who are in the first and second distribution order can earn a great amount of money, which is more than the price of the three-year membership. Their wealth is increased through their consumption.

Through the two examples as mentioned above, it can be appreciated that the sales profit distribution system according to implementations of the disclosed technology provides a consuming-tech (consumption+financial technology) system that increases wealth through consumption, and as large consumption is made, wealth is increased, so that consumption, deal and turnover ratio are optimized to achieve the advancement into a new economic paradigm unlike the conventional economic paradigm.

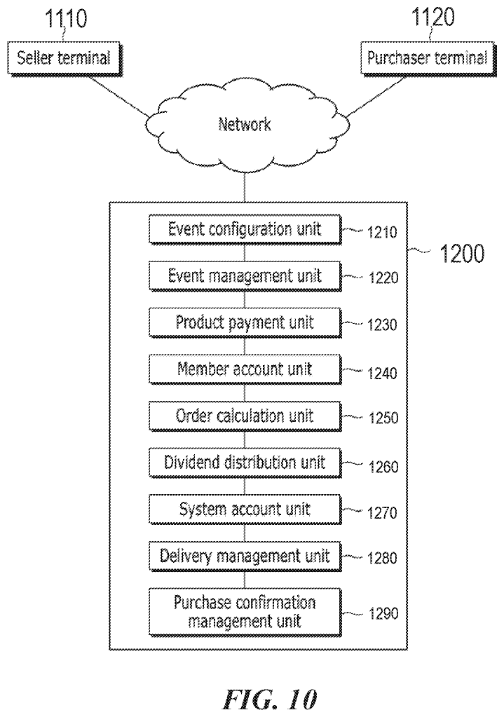

FIG. 10 is an exemplary block diagram showing a configuration of a product sales promotion system according to an implementation of the disclosed technology.

A product sales promotion system according to an implementation of the disclosed technology may include an event configuration unit 1210, an event management unit 1220, a product payment unit 1230, a member account unit 1240, an order calculation unit 1250, a dividend distribution unit 1260, a system account unit 1270, a delivery management unit 1280, and a purchase confirmation management unit 1290. The produce sales promotion system which is communicatively connected with the seller terminal 1110 and the purchaser terminal 1120 to receive relevant information from the seller terminal and/or the purchaser terminal 1120.

A seller may be connected to the product sales promotion system by using a seller terminal 1110 through wired and wireless network. A purchaser may be connected to the product sales promotion system by using a purchaser terminal 1120 through the wired and wireless network. The seller terminal 1110 and the purchaser terminal 1120 may be or include devices for transmitting and receiving data to and from the product sales promotion system connected thereto, and for example, desktop computers, laptops, smart phones, tablet computers, and so on may be used as the seller terminal 1110 and the purchaser terminal 1120. However, the seller terminal 1110 and the purchaser terminal 1120 are not limited to those mentioned above.

The seller and the purchaser may be members who join in the product sales promotion system, and the members of the product sales promotion system 100 may have a member account unit 1240 connected to their own accounts. The member account unit 1240 may include a cyber money account and a cash account. The cyber money deposited in the cyber money accounts may be used to decide distribution amounts for the respective purchasers. Thus, the cyber money deposited into the cyber money accounts may provide a distribution standard for distributing a dividend of a priority member, which will be discussed later, and the dividend of the purchaser and the dividend of the priority member are put into the cyber money accounts in the form of cyber money. The cash in the cash accounts may be transferred to the cyber money accounts, exchanged with the cyber money in the rate of 1:1 or in a predetermined ratio, and deposited into the cyber money accounts. Contrarily, the cyber money in the cyber money accounts may be transferred to the cash accounts, but in this case, desirably, a withdrawal fee at a given percentage for the transferring money has to be paid. The withdrawal fee may be transferred to the system account unit 1270 of the product sales promotion system, and the cash may be transferred to the cash accounts of the members. The cyber money may be referred to as different names, for example, reward points, mileages, coupons, credits, gifts, incentives, energy currency, etc.

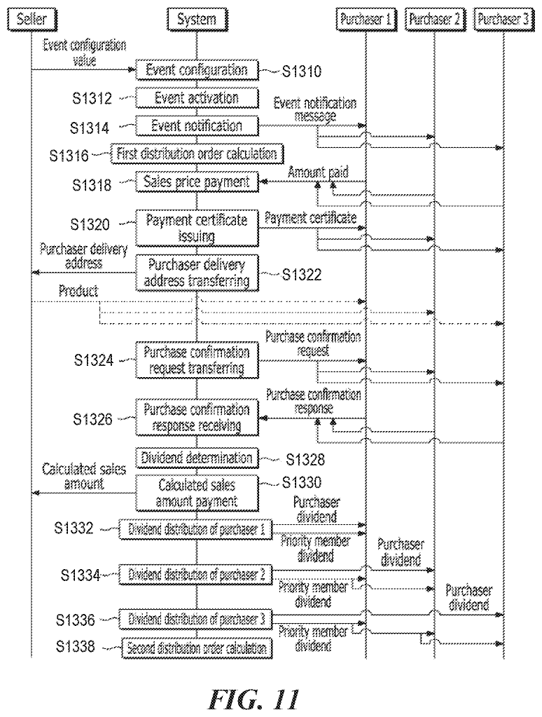

FIG. 11 is a flowchart showing processes of selling products and distributing a dividend in the product sales promotion system according to an implementation of the disclosed technology.

The seller is connected to the product sales promotion system by using the seller terminal 1110, and he or she selects an event configuration menu so as to set an event through which the dividend corresponding to a portion of the paid sales price is distributed to the purchaser and other members. The event configuration unit 1210 displays, on the seller terminal 1110, an input screen where, as event configuration values, a product category, a product name, the number of products to be sold, a period of time for product sales, a usage period of a product, a sales price of a product, a dividend distribution rate, a purchaser distribution rate, a priority member distribution rate, and an order calculation period of time, a priority member distribution range, or others are inputted, and the seller inputs, on the seller terminal 1110, the event configuration values as required through the seller terminal 1110. The values inputted to the event configuration unit 1210 through the seller terminal 1110 are stored in the event configuration unit 1210, thereby completing setting the event (at step S1310).

The event configuration values may be arbitrarily determined by the seller, and some of them may be suggested with appropriate values by means of the product sales promotion system. Further, some of them are, in advance, calculated as optimized values by means of the product sales promotion system and provided as fixed values.

The event may be finished if the products to be sold are completely sold or the period of time for product sales ends, and it is possible that the number of products to be sold and the period of time for product sales are not set. The usage period of a product means a period of time during which a product (for example, coupon) can be effectively used. The sales price of the product may be a normal retail price of the product or a price discounted by a discount rate arbitrarily determined by the seller. The dividend distribution rate, the purchaser distribution rate, the priority member distribution rate, the order calculation period, the priority member distribution range will be explained later.

The event management unit 1220 activates the event set on the event configuration unit 110 by the seller through the seller terminal 1110 (at step S1312).

If the event is activated, the event management unit 1220 transmits an event notification message to the terminals of the members joined in the product sales promotion system (at step S1314). The members may register the products in which they are interested on member information, and the event management unit 1220 may transmit the event notification message only to the members who have registered the products under the event as their interested products.

The order calculation unit 1250 calculates first distribution order on the basis of the time when the event is activated (at step S1316). The first distribution order is the member order determined according to the amounts of cyber money deposited in the cyber money accounts of the members joined in the product sales promotion system. In this case, the members may change cash into cyber money and deposit the cyber money into the cyber money accounts, thereby increasing the amounts of cyber money in the cyber money accounts.

For the conveniences of the description, only purchasers 1, 2 and 3 are illustrated in FIG. 11, and the exemplary case wherein their first distribution order is determined in the order of the purchasers 1, 2 and 3 will be explained below. Further, the step S1316 is carried out before step S1318 of making a payment for the sales price, but there is no restriction in the processing sequence only if the step S1316 is carried out before the dividend distribution (Steps S1332 to S1336) to the purchasers.

So as to purchase the product, the purchaser makes a payment for the sales price of the product on the payment screen provided on the purchaser terminal 1120 by the product payment unit 1230 (at step S1318), and the paid amount for the sales price is deposited into the system account unit 1270. The payment may be made by the cyber money and/or the cash withdrawn from the cyber money account and/or cash account of the purchaser, the card sales amount received from a credit card company of the purchaser, and the payment amount received from a smart phone communication company of the purchaser. The payment may be made in various ways including online/offline payment ways, and a detailed explanation on the payment method will be omitted.

If the payment for the product is made, the event management unit 1220 issues a payment certificate and transfers the payment certificate to the purchaser terminal 1120 (at step S1320). The payment certificate may have a form of an electronic image.

The delivery management unit 1280 may transmit a delivery address and a payment certificate of the purchaser who makes a payment for the sales price of the product to the seller terminal 1110 to allow the seller to deliver the product to the purchaser (at step S1322). A delivery method may include a delivery service and a direct delivery to the purchaser, and if the product is delivered directly to the purchaser, the seller scans bar codes on the payment certificate provided by the purchaser. After the purchaser is identified, accordingly, the product is taken over to the purchaser.

The purchase confirmation management unit 1290 may transmit a purchase confirmation request to the purchaser who receives the product through the delivery service or directly receives the product from the seller (at step S1324).

The purchase confirmation management unit 1290 may receive the response to the purchase confirmation request from the purchaser (at step S1326). The response to the purchase confirmation request is either a purchase confirmation response or a purchase cancel response. The purchase cancel response is the purchaser's expression to get a refund in case where the product purchased is unsatisfied. In this case, the event management unit 1220 pays the paid amount as a refund to the purchaser who transmits the purchase cancel response. The refund is withdrawn from the amount kept in the system account unit 1270 and is thus transferred to the cash account of the purchaser who transmits the purchase cancel response. Hereinafter, an explanation on the case where the response to the purchase confirmation request is the purchase confirmation response will be given.

If the order calculation period of time ends after the event is activated, the dividend distribution unit 1260 multiplies the sum of the paid amounts of the purchaser who performs the purchase confirmation response within the order calculation period of time by the dividend distribution rate to determine the dividend generated by the purchaser (at step S1328). A portion of the dividend is distributed to the purchaser himself or herself, and the remaining dividend is distributed to all or some of the members who ranks ahead the purchaser (hereinafter, referred to as “priority members”) in the first distribution order and the purchaser according to a predetermined priority member distribution method. The dividend is transferred to the cyber money accounts of the purchasers and the priority members in the form of cyber money. Hereinafter, the dividend distributed to the purchaser is called “purchaser dividend.” The dividend distributed to all or some of the priority members and the purchaser according to the priority member distribution method, which is the amount calculated by subtracting the purchaser dividend from the dividend, is called “priority member dividend”, and the priority member dividend distributed to individual of the priority members is called “individual priority member dividend”.

The recipients of the priority member dividends may be selected among the all members joined in the product sales promotion system or only among the purchasers who purchase the products sold through the event. That is, the distribution order may be calculated with respect to the all members or only the purchasers who purchase the products sold through the event.

The order calculation period of time may be set with a given period of time or in real time, and the given period of time may be set with a period of 12 hours, one day, or one week. If the order calculation period of time ends, the distribution order is updated. If the order calculation period of time is set in real time, the distribution order is updated right after the payments are finished.

The event management unit 1220 may pay the amount of product sales calculated by subtracting the dividends from the total amount of product sales (which is calculated by multiplying the sales price by the number of purchase confirmed products) to the cash account of the seller (at step S1330).

The priority member distribution range means the range of the priority members who receive the distribution among the priority members, and “distribution to all of the priority members” and “distribution to some of the priority members” may be selected by the seller or the system. Hereinafter, an explanation on the case where the dividend distribution unit 160 distributes the priority member dividend to all of the priority members will be given.

The dividend distribution unit 1260 may multiply the dividend calculated by multiplying the sum of amounts paid by the purchaser 1 within the order calculation period of time by the dividend distribution rate by the purchaser distribution rate to calculate the purchaser dividend, and transfer the purchaser dividend to the cyber money account of the purchaser 1 (at step S1332). The dividend distribution unit 1260 may be scheduled to distribute the priority member dividend which is the remaining amount after subtracting the purchaser dividend from the dividend generated by the purchaser 1 to the priority members who rank ahead the purchaser 1 and the purchaser 1 according to the priority member distribution method. However, because there is no priority members who rank ahead the purchaser 1, the priority member dividend is distributed only to the purchaser 1 as the top priority member (at step S1332).

The dividend distribution unit 1260 may multiply the dividend calculated by multiplying the sum of amounts paid by the purchaser 2 within the order calculation period of time by the dividend distribution rate by the purchaser distribution rate to calculate the purchaser dividend, and transfer the purchaser dividend to the cyber money account of the purchaser 2 (at step S1334). The dividend distribution unit 1260 may distribute the priority member dividend which is the remaining amount after subtracting the purchaser dividend from the dividend generated by the purchaser 2 to the priority member (that is, the purchaser 1) who ranks ahead the purchaser 2 and the purchaser 2 according to the priority member distribution method (at step S1334).

The dividend distribution unit 1260 may multiply the dividend calculated by multiplying the sum of amounts paid by the purchaser 3 within the order calculation period of time by the dividend distribution rate by the purchaser distribution rate to calculate the purchaser dividend, and transfer the purchaser dividend to the cyber money account of the purchaser 3 (at step S1336). The dividend distribution unit 1260 may distribute the priority member dividend which is the remaining amount after subtracting the purchaser dividend from the dividend generated by the purchaser 3 to the priority members (that is, the purchaser 1 and the purchaser 2) who rank ahead the purchaser 3 and the purchaser 3 according to the priority member distribution method (at step S1336). The purchaser dividends and the priority member dividends are withdrawn from the amount kept in the system account unit 1270 and are transferred to the cyber money accounts of the purchasers. The purchaser dividends and the priority member dividends are paid in cyber money, but it is possible that those are transferred in cash to the cash accounts of the purchasers.

Although, the steps S1330 to S1336 are explained to be sequentially performed, the steps may be performed concurrently or in a reverse sequence to the explained.

The order calculation unit 1250 may determine second distribution order which is made by updating the first distribution order on the basis of the amounts of cyber money transferred to the cyber money accounts of the purchasers and the priority members (at step S1338), and next, the steps S1318 to S1336 are repeated. The second distribution order is used as a dividend distribution standard for a second order calculation period of time. Updating the distribution order is performed whenever the order calculation period of time ends and is finished in accordance with the finish of the event.

In the product sales promotion system and method according to an implementation of the disclosed technology, the priority member distribution method is freely determined by the seller or the system. A desirable example of the priority member distribution method may be as follows.

The dividend distribution unit 1260 may arrange the priority members and the purchasers in the order of the distribution. Next, a first individual priority member dividend calculated by multiplying the priority member dividend by the priority member distribution rate is paid to a first priority member who is the first in distribution order, and a second individual priority member dividend calculated by multiplying the amount remaining after subtracting the first individual priority member dividend from the priority member dividend by the priority member distribution rate is paid to a second priority member who is the second in the distribution order.

In this example, only the first and second priority members are exemplified, but in the same manner as above, the individual priority member dividends may be paid to the priority members who are next to the first and second priority members. For example, a third individual priority member dividend calculated by multiplying the amount remaining after subtracting the first individual priority member dividend and the second individual priority member dividend from the priority member dividend by the priority member distribution rate is paid to a third priority member who is the third in the distribution order.

If the priority member dividend remains even after the individual priority member dividends are paid to all of the priority members and the purchasers, the priority member dividend calculated by multiplying the remaining priority member dividend by the priority member distribution rate may be paid in the order of the priority members in the same manner as above. However, if the remaining priority member dividend is less than a predetermined amount, the dividend distribution unit 1260 may transfer the remaining priority member dividend to the system account unit 1270 and finish the priority member dividend distribution.

According to another desirable example of the priority member distribution method, the priority member dividend may be divided into N (wherein N=the number of priority members+1), and the divided priority member dividends may be paid equally to the priority members and the purchaser.

If the purchasers purchase the products during the event through the product sales promotion system and method according to an implementation of the disclosed technology, the purchaser dividends and the priority member dividends are continuously distributed, so that the assets of the purchasers are increased through their purchase and the purchase of other members. Now, the effects obtained by the system and method according to the disclosed technology will be explained with an exemplary case.

A seller A who sells clothing in America determines to sell 7 kinds of clothes at the lowest price on online through the product sales promotion system 100 according to an implementation of the disclosed technology, and the sales prices of the 7 kinds of clothes to be sold by the seller A are 5, 8, 10, 20, 50, 100 and 200 dollars respectively. The following event configuration values are inputted by the seller A.
Target period of product sales: three days
Order calculation period of time: one day
Dividend distribution rate: 10%
Purchaser distribution rate: 40%,
Priority member distribution method: Even distribution to N including purchasers

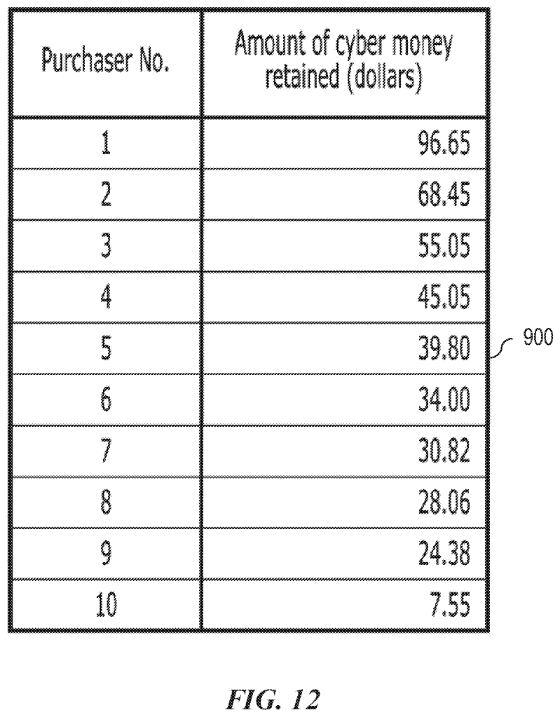

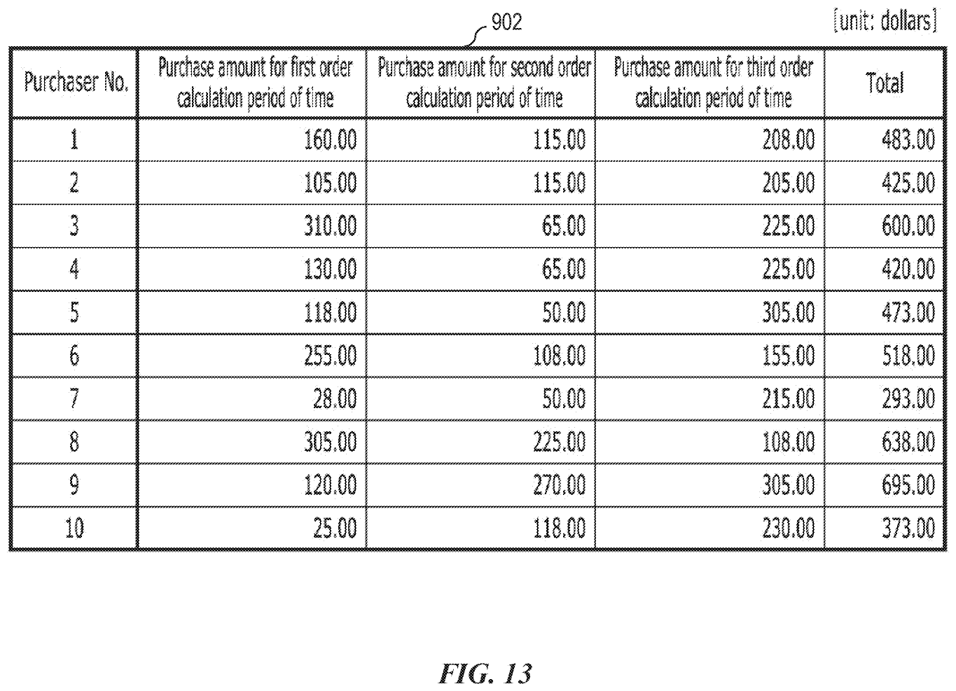

The first distribution order is determined according to the amounts of cyber money deposited into the cyber money accounts of 10 purchasers, and the amounts of cyber money of the 10 purchasers and the first distribution order determined according to the amounts of cyber money of the 10 purchasers are listed in FIG. 12. 10 purchasers randomly purchase three pieces of clothing every day for three days, and the purchase amounts of the 10 purchasers by one day are listed in FIG. 13.

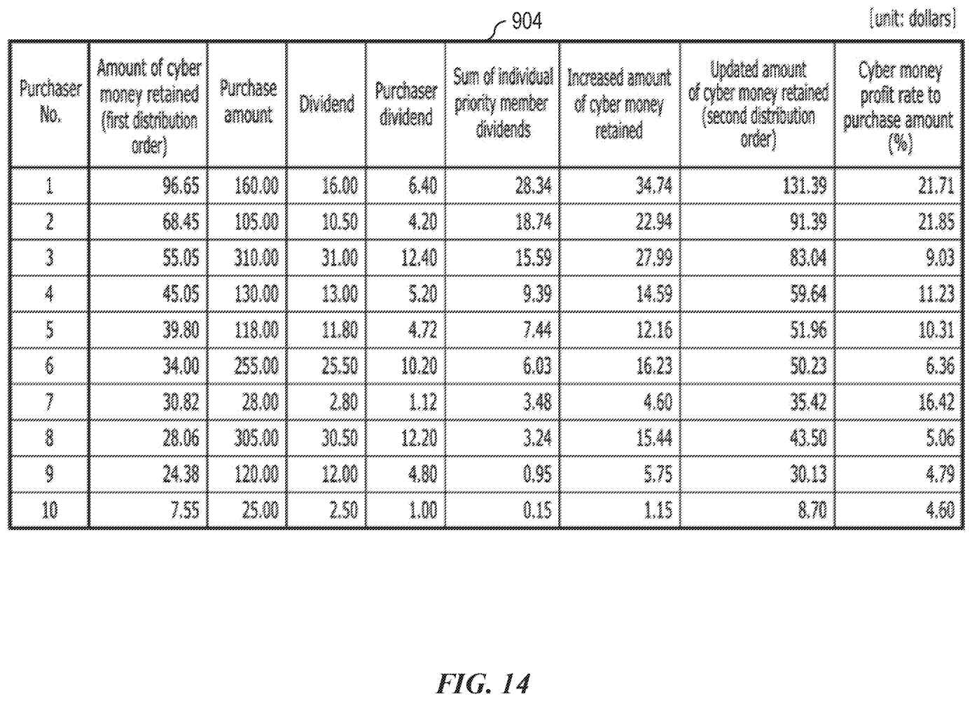

FIG. 14 shows the amounts distributed to the purchasers for the first order calculation period of time.

The purchaser 1 is the first ranker in the first distribution order and buys 160 dollars clothing within the first order calculation period of time. As soon as the first order calculation period of time ends, 16.00 dollars corresponding to 10% (dividend distribution rate) of 160 dollars paid by the purchaser 1 is determined as the dividend generated by the purchaser 1. Next, 6.40 dollars, as a purchaser dividend, corresponding to 40% (purchaser distribution rate) of the dividend is transferred to the cyber money account of the purchaser 1, and 9.60 dollars corresponding to the amount calculated by subtracting the purchaser dividend from the dividend is transferred only to the cyber money account of the purchaser 1 because there is no priority member who ranks ahead the purchaser 1. Also, the priority member dividend is calculated by subtracting the purchaser dividend from the dividend corresponding to 10% (dividend distribution rate) of the amount paid by each of the purchasers 2 to 10, and the individual priority member dividend is the amount calculated by dividing the priority member dividend into the number of the purchaser and the priority members (that is, the amounts divided into N parts, N=the number of priority members+1). The individual priority member dividends are transferred to the cyber money account of the purchaser 1. That is, the purchaser 1 has 28.34 dollars as the sum of the individual priority member dividends (the priority member dividend of the purchaser 1 of 9.60 dollars, the individual priority member dividend of 3.15 dollars transferred from the purchaser 2, the individual priority member dividend of 6.20 dollars transferred from the purchaser 3, the individual priority member dividend of 1.95 dollars transferred from the purchaser 4, the individual priority member dividend of 1.42 dollars transferred from the purchaser 5, the individual priority member dividend of 2.55 dollars transferred from the purchaser 6, the individual priority member dividend of 0.24 dollars transferred from the purchaser 7, the individual priority member dividend of 2.29 dollars transferred from the purchaser 8, the individual priority member dividend of 0.80 dollars transferred from the purchaser 9, and the individual priority member dividend of 0.15 dollars transferred from the purchaser 10).

The purchaser 1 has purchased clothing of 160 dollars at the minimum price on online for the first order calculation period of time, so that his or her assets of 34.74 dollars (the sum of the purchaser dividend of 6.40 dollars and the sum of individual priority member dividends of 28.34 dollars) are increased. Also, a cyber money profit rate to the purchase amount of the purchaser 1 for the first order calculation period of time is 21.71%.

The purchaser 2 is the second ranker in the first distribution order and spends 105 dollars on clothing for the first order calculation period of time. As soon as the first order calculation period of time ends, 10.50 dollars corresponding to 10% (dividend distribution rate) of 105 dollars paid by the purchaser 2 is determined as the dividend generated by the purchaser 2. Next, 4.20 dollars, as a purchaser dividend, corresponding to 40% (purchaser distribution rate) of the dividend is transferred to the cyber money account of the purchaser 2, and 6.30 dollars corresponding to the amount calculated by subtracting the purchaser dividend from the dividend generated by the purchaser 2 is evenly distributed to the purchaser 1 who ranks ahead the purchaser 2 and the purchaser 2, so that 3.15 dollars are transferred to each of the purchaser 1 and the purchaser 2. Also, the priority member dividend is calculated by subtracting the purchaser dividend from the dividend corresponding to 10% (dividend distribution rate) of the amount paid by each of the purchasers 3 to 10, and the individual priority member dividend is the amount calculated by dividing the priority member dividend into the number of the purchaser and the priority members (that is, the amounts divided into N parts; N=the number of priority members+1). The individual priority member dividends are transferred to the cyber money account of the purchaser 2. That is, the purchaser 2 has 18.74 dollars as the sum of the individual priority member dividends (the individual priority member dividend of the purchaser 2 of 3.15 dollars, the individual priority member dividend of 6.20 dollars transferred from the purchaser 3, the individual priority member dividend of 1.95 dollars transferred from the purchaser 4, the individual priority member dividend of 1.42 dollars transferred from the purchaser 5, the individual priority member dividend of 2.55 dollars transferred from the purchaser 6, the individual priority member dividend of 0.24 dollars transferred from the purchaser 7, the individual priority member dividend of 2.29 dollars transferred from the purchaser 8, the individual priority member dividend of 0.80 dollars transferred from the purchaser 9, and the individual priority member dividend of 0.15 dollars transferred from the purchaser 10).

The purchaser 2 has purchased clothing with the amount less than the amount paid by the purchaser 1 for the first order calculation period of time, but a cyber money profit rate to the purchase amount of the purchaser 2 for the first order calculation period of time is 21.85%, which is higher than the cyber money profit rate to the purchase amount of the purchaser 1 of 21.71%. Further, the purchaser 7 has purchased clothing of 28 dollars for the first order calculation period of time, and that is, the 28 dollars are just the amount corresponding to 17.5% of the purchase amount of the purchaser 1. In this case, however, a cyber money profit rate to the purchase amount of the purchaser 7 is 16.42%. Therefore, the product sales promotion system according to an implementation of the disclosed technology has different technical structures and effects from the conventional point saving system in which points proportional to purchase amounts are simply saved. Under the product sales promotion system according to an implementation of the disclosed technology, even if the purchaser purchases the products with a relatively low purchase amount, his or her cyber money profit rate to the purchase amount can be higher than other purchasers.

Through such exceptionality of the cyber money profit rate to the purchase amount, even the low-rankers in the distribution order may expect that they may have the cyber money profit rate to the purchase amount higher than the high-rankers and may also expect that their ranking in the distribution order may be raised, so that all of the members who are joined in the product sales promotion system are promoted to purchase.

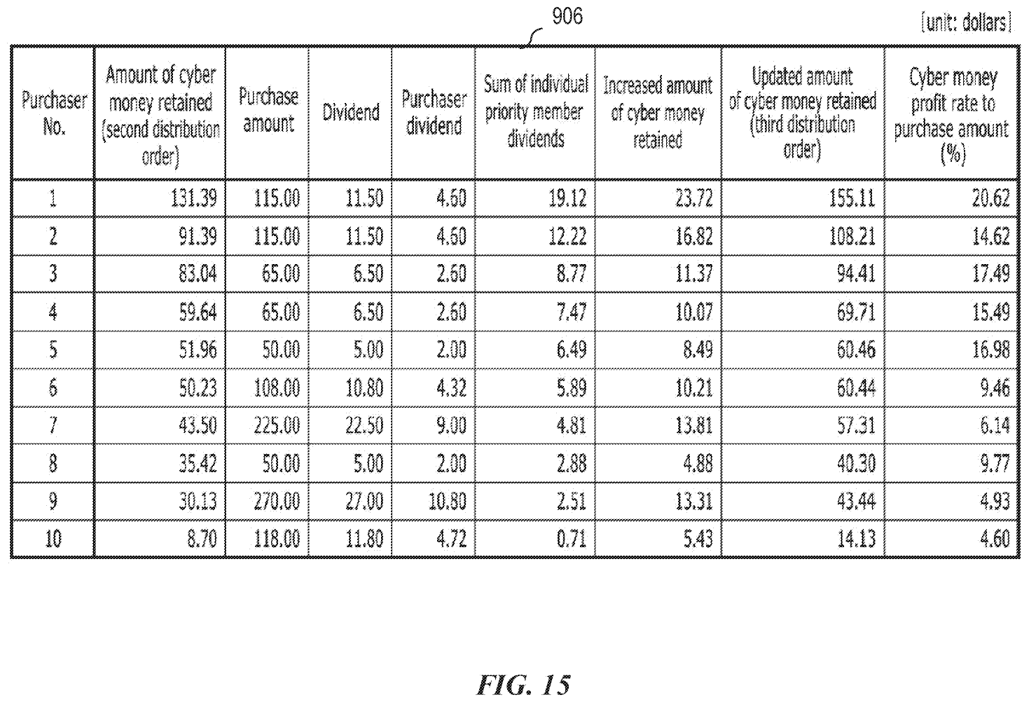

FIG. 15 shows the amounts to be distributed to the purchasers for the second order calculation period of time.

In the first distribution order, the amount of cyber money owned by the purchaser 7 is 30.82 dollars, and the amount of cyber money owned by the purchaser 8 is 28.06 dollars, so that the purchaser 7 ranks higher than the purchaser 8. After the dividend distribution for the first order calculation period of time, the amount of cyber money owned by the purchaser 7 is 35.42 dollars, and the amount of cyber money owned by the purchaser 8 is 43.50 dollars, so that the purchaser 8 becomes to rank higher than the purchaser 7 in the second distribution order which is the dividend distribution standard for the second order calculation period of time.

The purchaser 3 has purchased clothing of 65.00 dollars for the second order calculation period of time, and that is, the 65.00 dollars are just the amount corresponding to 56.5% of the purchase amount of 115.00 dollars of the purchaser 2. In this case, however, a cyber money profit rate to the purchase amount of the purchaser 3 is 17.49%, which is higher than the cyber money profit rate to the purchase amount of the purchaser 2 of 14.62%. In other words, even if the purchaser purchases the products with a relatively low purchase amount, his or her cyber money profit rate to the purchase amount may be higher than other purchasers. This feature also caused by the unique technical structures of the disclosed technology.

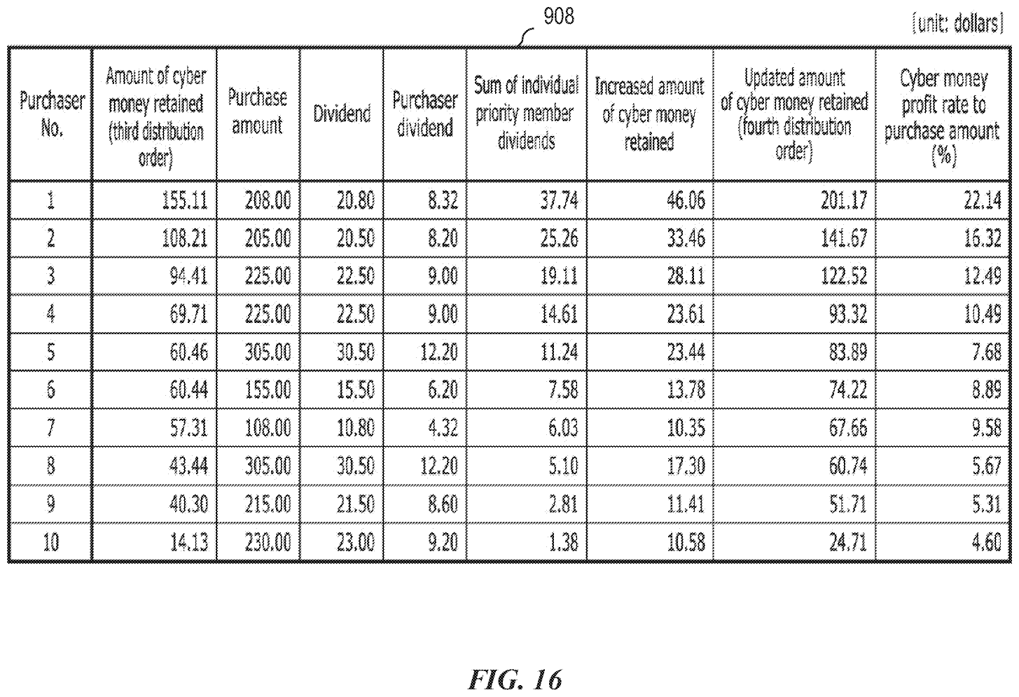

FIG. 16 shows the amounts to be distributed to the purchasers for the third order calculation period of time.

In the second distribution order, the amount of cyber money owned by the purchaser 7 is 35.42 dollars, and the amount of cyber money owned by the purchaser 9 is 30.13 dollars, so that the purchaser 7 ranks higher than the purchaser 9.

After the dividend distribution for the second order calculation period of time, the amount of cyber money owned by the purchaser 7 is 40.30 dollars, and the amount of cyber money owned by the purchaser 9 is 43.44 dollars, so that the purchaser 9 becomes to rank higher than the purchaser 7 in the third distribution order which is the dividend distribution standard for the third order calculation period of time.

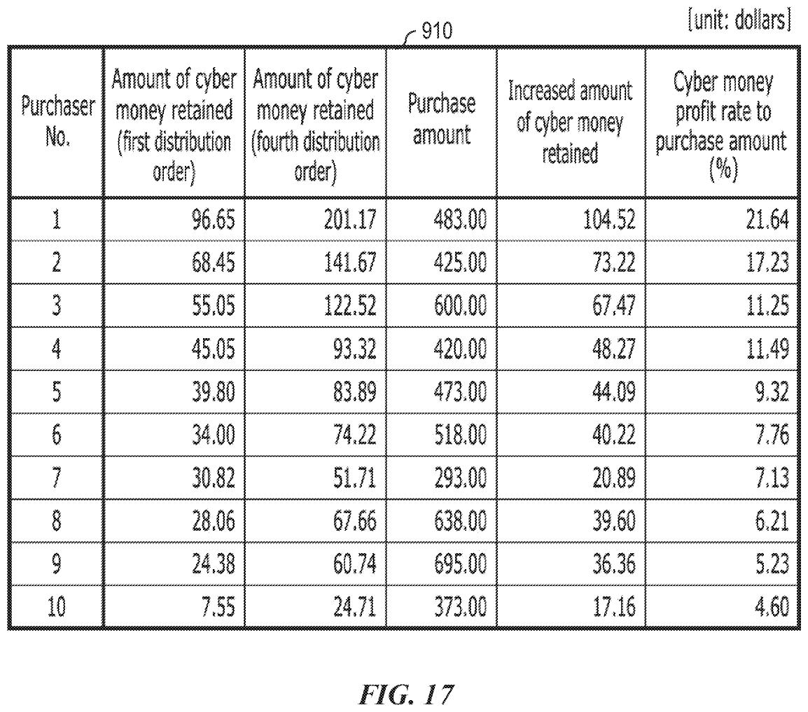

FIG. 17 is a table showing the cyber money profit rates to the purchase amounts of the purchasers during the event.

While the purchaser 1 owns the cyber money of 96.65 dollars before the event, he or she purchases 9 pieces of clothing at the minimum online price of 483.00 dollars during the event for three days and, additionally, the cyber money of the purchaser 1 is increased to 104.52 dollars. The cyber money profit rate to the purchase amount of the purchaser 1 is 21.64%. It is also confirmed that the amounts of cyber money of other purchasers are increased.

With a payment of the withdrawal fee, the cyber money may be transferred to the cash account from the cyber money account in the form of cash or may be withdrawn directly from the cyber money account in the form of cash, so that the cash assets of the purchaser may be increased. Further, the distribution order of the purchaser may be upgraded according to the amount of cyber money distributed to him or her. Therefore, the possibility to get a larger amount of dividend from another event is increased.

If the payment of the purchaser is made through the use of an interest-free installment program provided by a credit card company, the profit of the purchaser will be maximized. If the purchaser buys 483.00 dollar clothing in the conventional purchase system, he or she must prepare 483.00 dollars, which makes him or her feel burdened so that he or she is refrained from purchasing the clothing. Through the product sales promotion system 100 of the disclosed technology, the sales price is paid in interest-free installments, and next, the installment amount may be paid with the dividend distributed to the purchaser, thereby lessening the burden of the purchaser. Such an advantage is obtained because the value of time is turned into the cyber money. Particularly, if the dividend distribution rate is raised by the seller, the amounts to be distributed to the purchasers are increased, so that the consumption will and event join will of the members become high.

The seller accomplishes a substantially larger amount of sales than an amount of sales in the past, for a short period of time, thereby obtaining a great sales profit, and even if the dividend is distributed, an amount of sales over several months to years can be obtained within the short period of time, so that no damage occurs. Also, the dividend, as a sales agency commission, is the amount paid to the system provider of the conventional system, and therefore, the seller does not have any substantial damage even if seller distributes the dividend. So as to increase the amount of sales in a short period of time, the dividend distribution rate may be selectively raised by the seller, which strongly stimulates the event join desires of the members to rapidly and reliably achieve a desired amount of product sales.

The product sales promotion system of an implementation of the disclosed technology may obtain profits with the system usage fee received from the seller when the event is activated by the seller and with the withdrawal fees received from the members when the cyber money is withdrawn from the cyber money accounts by the members. Further, if the number of events activated by numerous sellers over the world is uncountably large, the cash balance in the system account unit 150, which is obtained by the events, is kept to a very large amount of money. Therefore, a cyber money mortgage or secondary outsourcing investment may be conducted by means of the system usage fees, the withdrawal fees, and the cash balance in the system account, thereby creating great profits.

The members may withdraw the cyber money from their cyber money accounts and exchange the cyber money into the cash, or they may get a loan with their cyber money as collateral from the product sales promotion system. The members may exchange their cyber money into the cash with a payment of the withdrawal fees, but in this case, the amount of cyber money retained in the cyber money account is decreased and this may cause a disadvantage in ranking of the dividend distribution order of an event. So as to allow the member to exchange the cyber money into the cash in the state where the amount of cyber money retained is kept, the product sales promotion system may lend the cash of the system account unit to the members with the cyber money of the members as collateral. As a result, the product sales promotion system may provide a financial business.

It may be appreciated that the product sales promotion system according to an implementation of the disclosed technology provides a consuming-tech (consumption+financial technology) system that increases wealth through consumption, and as increased consumption may increase wealth, so that consumption, commercial exchange, and turnover rate are optimized to achieve significant advance in E-commerce unlike the conventional one.

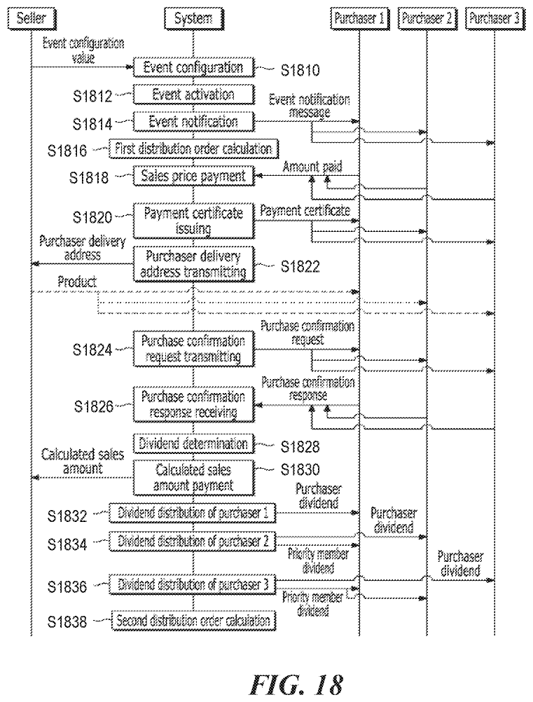

FIG. 18 is an exemplary flowchart showing processes of selling products and distributing a dividend in the product sales promotion system according to an implementation of the disclosed technology. FIG. 18 is different from FIG. 11 in the step 1836. The dividend distribution unit may distribute the priority member dividend which is the remaining amount after subtracting the purchaser dividend from the dividend generated by the purchaser 3 to the priority members (that is, the purchaser 1 and the purchaser 2) who rank ahead the purchaser 3 according to the priority member distribution method (at step S1836). Thus, at step S1836, the dividend distribution unit distributes the dividend to the priority member(s) only, not to the purchaser.

Under the above-mentioned manner, the priority member dividends generated by the respective purchasers may be distributed to all of the priority members to the respective purchasers. The purchaser dividends and the priority member dividends are withdrawn from the amount kept in the system account unit and are transferred to the cyber money accounts of the purchasers. The purchaser dividends and the priority member dividends are paid in cyber money, but it is possible that those are transferred in cash to the cash accounts of the purchasers.

Although, the steps S1830 to 1836 are explained to be sequentially performed, the steps may be performed concurrently or in a reverse sequence to the explained.

In some implementations, the dividend distribution unit may distribute the priority member dividend only to some of the priority members. In this case, the some of the priority members are selected according to the distribution order in the order from the top priority member or are randomly selected

An exemplary case where some of the priority members are selected as the priority member distribution range according to the distribution order from the top priority member will be explained. For example, the priority member dividend generated by the purchase who is the 100th in the distribution order is not distributed to all of the 99 priority members, but to some of the priority members such as the priority members who are first to 70th, first to 50th, or first to 30th are firstly selected, the priority member dividends may be distributed only to the selected priority members according to the priority member distribution method on the basis of the distribution order.

An exemplary case where some of the priority members are randomly selected as the priority member distribution range will be explained. For example, the priority member dividend generated by the purchase of the purchaser who is the 100th in the distribution order is not distributed to all of the 99 priority members, but to 70, 50, or 30 priority members who are randomly selected from the 99 priority members, the priority member dividends are distributed only to the selected priority members according to the priority member distribution method on the basis of the distribution order.

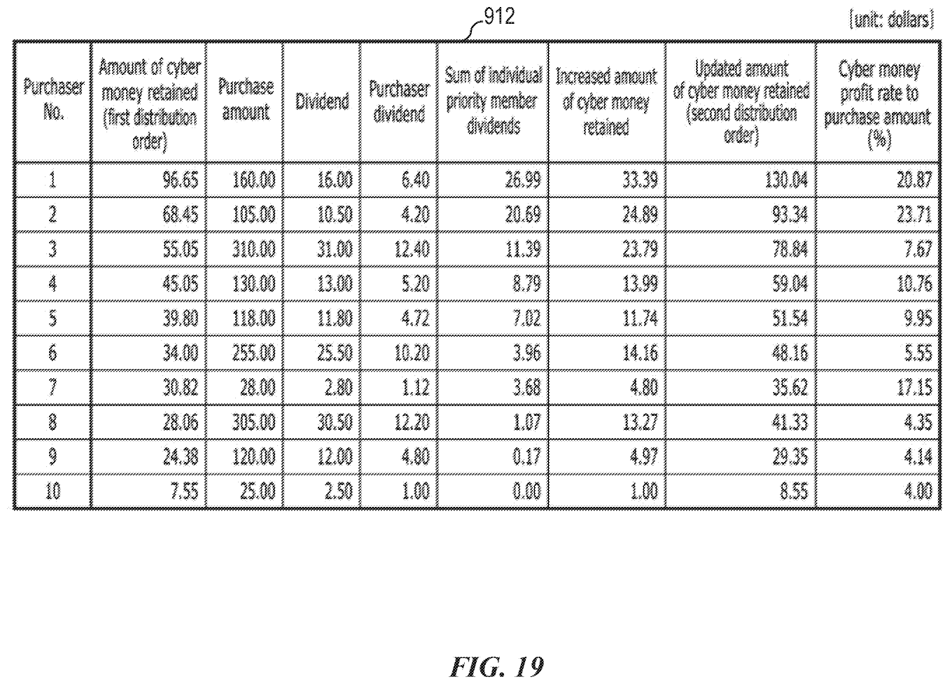

FIG. 19 shows the amounts distributed to the purchasers for the first order calculation period of time.

The purchaser 1 is the first ranker in the first distribution order and buys 160 dollars clothing within the first order calculation period of time. As soon as the first order calculation period of time ends, 16.00 dollars corresponding to 10% (dividend distribution rate) of 160 dollars paid by the purchaser 1 is determined as the dividend generated by the purchaser 1. Next, 6.40 dollars, as a purchaser dividend, corresponding to 40% (purchaser distribution rate) of the dividend is transferred to the cyber money account of the purchaser 1, and 9.60 dollars corresponding to the amount calculated by subtracting the purchaser dividend from the dividend is transferred to the system account unit because there is no priority member who ranks ahead the purchaser 1. Also, the priority member dividend is calculated by subtracting the purchaser dividend from the dividend corresponding to 10% (dividend distribution rate) of the amount paid by each of the purchasers 2 to 10, and the individual priority member dividend is the amount calculated by dividing the priority member dividend into the number of the priority members (that is, the amounts divided into N parts; N=the number of priority members). The individual priority member dividends are transferred to the cyber money account of the purchaser 1. That is, the purchaser 1 has 26.99 dollars as the sum of the individual priority member dividends (the individual priority member dividend of 6.30 dollars transferred from the purchaser 2, the individual priority member dividend of 9.30 dollars transferred from the purchaser 3, the individual priority member dividend of 2.60 dollars transferred from the purchaser 4, the individual priority member dividend of 1.77 dollars transferred from the purchaser 5, the individual priority member dividend of 3.06 dollars transferred from the purchaser 6, the individual priority member dividend of 0.28 dollars transferred from the purchaser 7, the individual priority member dividend of 2.61 dollars transferred from the purchaser 8, the individual priority member dividend of 0.90 dollars transferred from the purchaser 9, and the individual priority member dividend of 0.17 dollars transferred from the purchaser 10).

The purchaser 1 has purchased clothing of 160 dollars at the minimum price on online for the first order calculation period of time, so that his or her assets of 33.39 dollars (the sum of the purchaser dividend of 6.40 dollars and the sum of individual priority member dividends of 26.99 dollars) are increased. Also, a cyber money profit rate to the purchase amount of the purchaser 1 for the first order calculation period of time is 20.87%.

The purchaser 2 is the second ranker in the first distribution order and spends 105 dollars on clothing for the first order calculation period of time. As soon as the first order calculation period of time ends, 10.50 dollars corresponding to 10% (dividend distribution rate) of 105 dollars paid by the purchaser 2 is determined as the dividend generated by the purchaser 2. Next, 4.20 dollars, as a purchaser dividend, corresponding to 40% (purchaser distribution rate) of the dividend is transferred to the cyber money account of the purchaser 2, and 6.30 dollars corresponding to the amount calculated by subtracting the purchaser dividend from the dividend generated by the purchaser 2 is transferred to the cyber money account of the purchaser 1. Also, the priority member dividend is calculated by subtracting the purchaser dividend from the dividend corresponding to 10% (dividend distribution rate) of the amount paid by each of the purchasers 3 to 10, and the individual priority member dividend is the amount calculated by dividing the priority member dividend into the number of the priority members (that is, the amounts divided into N parts; N=the number of priority members). The individual priority member dividends are transferred to the cyber money account of the purchaser 2. That is, the purchaser 2 has 20.69 dollars as the sum of the individual priority member dividends (the individual priority member dividend of 9.30 dollars transferred from the purchaser 3, the individual priority member dividend of 2.60 dollars transferred from the purchaser 4, the individual priority member dividend of 1.77 dollars transferred from the purchaser 5, the individual priority member dividend of 3.06 dollars transferred from the purchaser 6, the individual priority member dividend of 0.28 dollars transferred from the purchaser 7, the individual priority member dividend of 2.61 dollars transferred from the purchaser 8, the individual priority member dividend of 0.90 dollars transferred from the purchaser 9, and the individual priority member dividend of 0.17 dollars transferred from the purchaser 10).

The purchaser 3 is the third purchaser in the first distribution order and spends 310 dollars on clothing for the first period of time of order calculation. As soon as the first period of time of order calculation passes, 31.00 dollars corresponding to 10% (dividend distribution rate) of 310 dollars paid by the purchaser 3 are determined as the dividend generated by the purchaser 3. Next, 12.40 dollars, as a purchaser dividend, corresponding to 40% (purchaser distribution rate) of the dividend are transferred to the cyber money account of the purchaser 3, and 18.60 dollars corresponding to the amount calculated by subtracting the purchaser dividend from the dividend are transferred to the cyber money accounts of the purchaser 1 and the purchaser 2 as the priority members, so that 9.30 dollars are transferred to the cyber money accounts of the purchaser 1 and the purchaser 2, respectively. Also, the priority member dividend is calculated by subtracting the purchaser dividend from the dividend corresponding to 10% (dividend distribution rate) of the amount paid by each of the purchasers 4 to 10, and the individual priority member dividend is the amount calculated by dividing the priority member dividend by the number of priority members (that is, the amounts divided by N parts; N=the number of the priority members). The individual priority member dividends are transferred to the cyber money account of the purchaser 3. That is, the purchaser 3 receives 11.39 dollars as the individual priority member dividend (the individual priority member dividend of 2.60 dollars transferred from the purchaser 4, the individual priority member dividend of 1.77 dollars transferred from the purchaser 5, the individual priority member dividend of 3.06 dollars transferred from the purchaser 6, the individual priority member dividend of 0.28 dollars transferred from the purchaser 7, the individual priority member dividend of 2.61 dollars transferred from the purchaser 8, the individual priority member dividend of 0.90 dollars transferred from the purchaser 9, and the individual priority member dividend of 0.17 dollars transferred from the purchaser 10).

The purchaser 4 is the fourth purchaser in the first distribution order and spends 130 dollars on clothing for the first period of time of order calculation. As soon as the first period of time of order calculation passes, 13.00 dollars corresponding to 10% (dividend distribution rate) of 130 dollars paid by the purchaser 4 are determined as the dividend generated by the purchaser 4. Next, 5.20 dollars, as a purchaser dividend, corresponding to 40% (purchaser distribution rate) of the dividend are transferred to the cyber money account of the purchaser 4, and 7.80 dollars corresponding to the amount calculated by subtracting the purchaser dividend from the dividend are transferred to the cyber money accounts of the purchaser 1, the purchaser 2 and the purchaser 3 as the priority members, so that 2.60 dollars are transferred into the cyber money accounts of the purchaser 1, the purchaser 2, and the purchaser 3, respectively. Also, the priority member dividend is calculated by subtracting the purchaser dividend from the dividend corresponding to 10% (dividend distribution rate) of the amount paid by each of the purchasers 5 to 10, and the individual priority member dividend is the amount calculated by dividing the priority member dividend by the number of priority members (that is, the amounts divided by N parts; N=the number of the priority members). The individual priority member dividends are transferred to the cyber money account of the purchaser 4. That is, the purchaser 4 has 8.79 dollars as the individual priority member dividend (the individual priority member dividend of 1.77 dollars transferred from the purchaser 5, the individual priority member dividend of 3.06 dollars transferred from the purchaser 6, the individual priority member dividend of 0.28 dollars transferred from the purchaser 7, the individual priority member dividend of 2.61 dollars transferred from the purchaser 8, the individual priority member dividend of 0.90 dollars transferred from the purchaser 9, and the individual priority member dividend of 0.17 dollars transferred from the purchaser 10).

The purchaser 4 has purchased clothing of 130 dollars for the first period of time of order calculation, and that is, the 130 dollars are just the amount corresponding to 41.9% of the purchase amount (310 dollars) of the purchaser 3. In this case, however, a cyber money profit rate to the purchase amount of the purchaser 4 is 10.76%, which is higher than the cyber money profit rate to the purchase amount of the purchaser 3 of 7.67%. The purchaser 7 has purchased clothing of 28 dollars for the first period of time of order calculation, and that is, the 28 dollars are just the amount corresponding to 17.5% of the purchase amount (160 dollars) of the purchaser 1. In this case, however, a cyber money profit rate to the purchase amount of the purchaser 7 is 17.15%. Therefore, the product sales promotion system according to an implementation of the disclosed technology has different structures and effects from the conventional point saving system in which points proportional to purchase amounts are simply saved. Under the product sales promotion system according to an implementation of the disclosed technology, even if the purchaser purchases the products with a relatively low purchase amount, his or her cyber money profit rate to the purchase amount can be higher than other purchasers.

Through such exceptionality of the cyber money profit rate to the purchase amount, even the low-rankers in the distribution order may expect that they may have the cyber money profit rate to the purchase amount higher than the high-rankers and may also expect that their ranking in the distribution order may be raised, so that all of the members who are joined in the product sales promotion system are promoted to purchase.

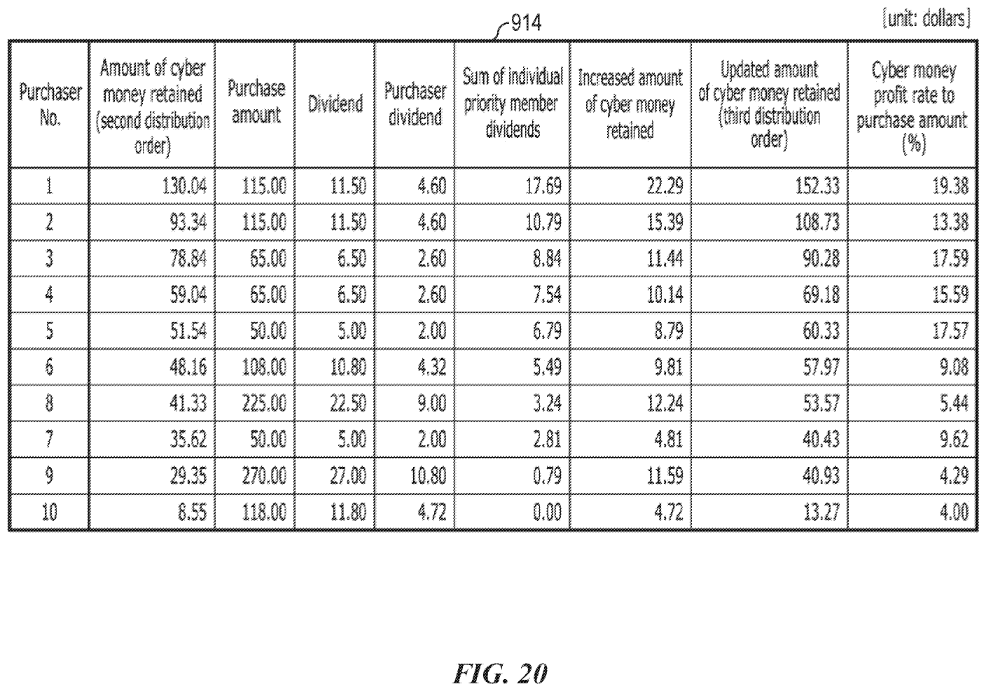

FIG. 20 shows the amounts to be distributed to the purchasers for the second order calculation period of time.

In the first distribution order, the amount of cyber money owned by the purchaser 7 is 30.82 dollars, and the amount of cyber money owned by the purchaser 8 is 28.06 dollars, so that the purchaser 7 ranks higher than the purchaser 8. After the dividend distribution for the first order calculation period of time, the amount of cyber money owned by the purchaser 7 is 35.42 dollars, and the amount of cyber money owned by the purchaser 8 is 43.50 dollars, so that the purchaser 8 becomes to rank higher than the purchaser 7 in the second distribution order which is the dividend distribution standard for the second order calculation period of time.

The purchaser 3 has purchased clothing of 65.00 dollars for the second order calculation period of time, and that is, the 65.00 dollars are just the amount corresponding to 56.5% of the purchase amount of 115.00 dollars of the purchaser 2. In this case, however, a cyber money profit rate to the purchase amount of the purchaser 3 is 17.59%, which is higher than the cyber money profit rate to the purchase amount of the purchaser 2 of 13.38%. The purchaser 5 has purchased clothing with the amount less than that of the purchaser 4, but a cyber money profit rate to the purchase amount of the purchaser 5 is higher than that of the purchaser 4. It can be appreciated again that under the product sales promotion system according to an implementation of the disclosed technology, therefore, even if the purchaser purchases the products with a relatively low purchase amount, his or her cyber money profit rate to the purchase amount can be higher than other purchasers.

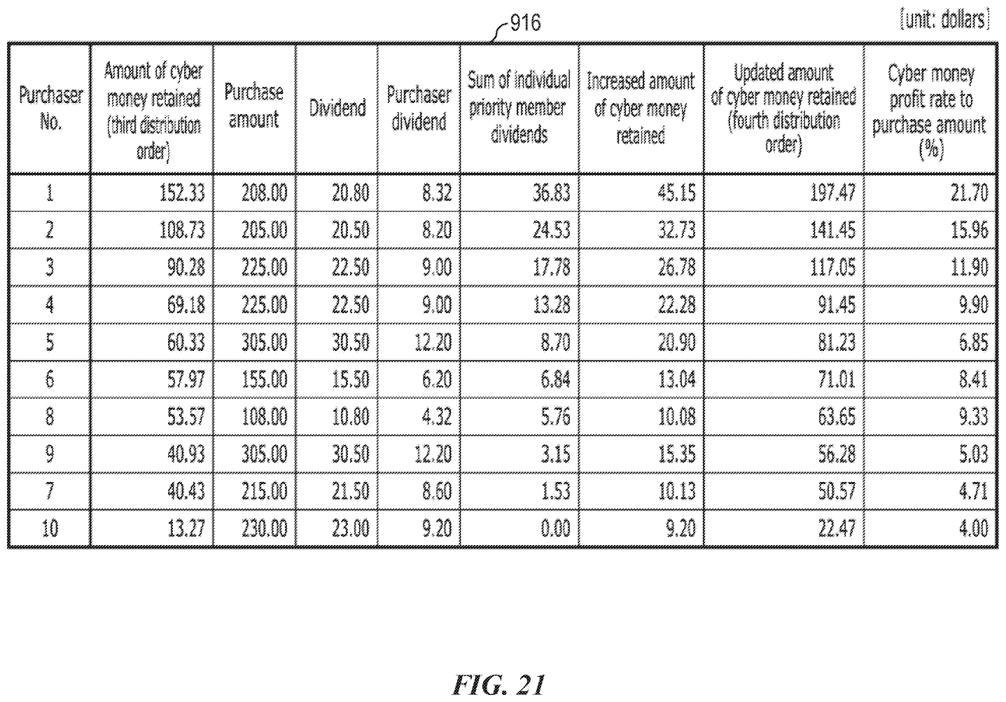

FIG. 21 shows the amounts to be distributed to the purchasers for the third order calculation period of time.

In the second distribution order, the amount of cyber money retained in the purchaser 7 is 35.62 dollars, and the amount of cyber money retained in the purchaser 9 is 29.35 dollars, so that the purchaser 7 is higher in order than the purchaser 9. Through the dividend distribution for the second period of time of order calculation, however, the amount of cyber money retained in the purchaser 7 is 40.43 dollars, and the amount of cyber money retained in the purchaser 9 is 40.93 dollars, so that the purchaser 9 is higher in order than the purchaser 7 in the third distribution order which is a dividend distribution standard for the third period of time of order calculation.

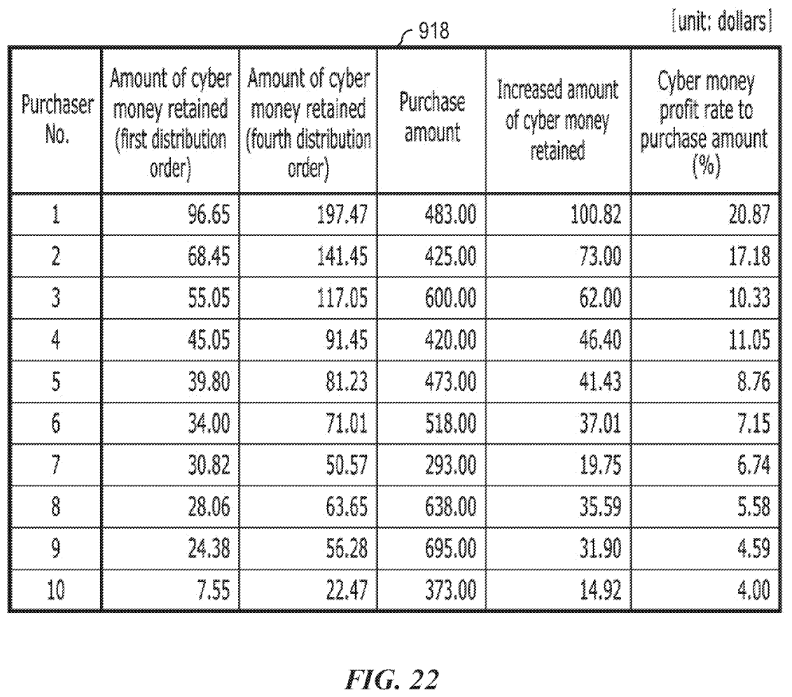

FIG. 22 is an exemplary table showing the cyber money profit rates to the purchase amounts of the purchasers during the event.

While the purchaser 1 is retaining the cyber money of 96.65 dollars before the event, he or she purchases 9 pieces of clothing at the lowest online price of 483.00 dollars during the event for three days, so that additionally, the cyber money of the purchaser 1 is increased to 100.82 dollars. The cyber money profit rate to the purchase amount of the purchaser 1 is 20.87%. It can be also checked that the amounts of cyber money of other purchasers are increased. With a payment of the withdrawal fee, the cyber money may be transferred to the cash account from the cyber money account in the form of cash or may be withdrawn directly from the cyber money account in the form of cash, so that the cash assets of the purchaser can be increased. Further, the distribution order of the purchaser can be upgraded by means of the amount of cyber money distributed to him or her, thereby providing a big possibility that a larger amount of dividend on another event is distributed to him or her.

If the payment of the purchaser is made through the use of an interest-free installment program provided by a credit card company, the profit of the purchaser will be maximized. If the purchaser buys 483.00 dollar clothing in the conventional purchase system, he or she must prepare 483.00 dollars, which makes him or her feel burdened so that he or she is refrained from purchasing the clothing. Through the product sales promotion system 100 of the disclosed technology, the sales price is paid in interest-free installments, and next, the installment amount may be paid with the dividend distributed to the purchaser, thereby lessening the burden of the purchaser. Such an advantage is obtained because the value of time is turned into the cyber money. Particularly, if the dividend distribution rate is raised by the seller, the amounts to be distributed to the purchasers are increased, so that the consumption will and event join will of the members become high.

In the product sales promotion system and method according to an implementation of the disclosed technology, the high-order priority member does not always have a higher cyber money profit rate to the purchase amount than the low-order priority member. While the purchaser 4 is retaining the cyber money of 45.05 dollars before the event, he or she purchases 9 pieces of clothing at the lowest online price of 420.00 dollars during the event for three days, so that 46.40 dollars are additionally increased in the cyber money of the purchaser 4. The cyber money profit rate to the purchase amount of the purchaser 4 is 11.05%. The purchaser 4 pays the amount less than the purchaser 3 as the priority member, but the cyber money profit rate to the purchase amount of the purchaser 4 is higher than that of the purchaser 3. Further, the purchaser 8 pays the amount less than the purchaser 7 as the priority member, but the distribution order of the purchaser 8 is upgraded one step from the step before the event, so that there is a big possibility that the purchaser 8 is under better conditions in the dividend distribution of other events. Through such exceptionality of the cyber money profit rate to the purchase amount, even the low-order purchasers in the distribution order hope that they will have the cyber money profit rate to the purchase amount higher than the priority members and also their distribution order will be raised, so that the purchase of all of the purchasers who are in the distribution order can be promoted.

The seller accomplishes a substantially larger amount of sales than an amount of sales in the past, for a short period of time, thereby obtaining a great sales profit, and even if the dividend is distributed, an amount of sales over several months to years can be obtained within the short period of time, so that no damage occurs. Also, the dividend, as a sales agency commission, is the amount paid to the system provider of the conventional system, and therefore, the seller does not have any substantial damage even if seller distributes the dividend. So as to increase the amount of sales in a short period of time, the dividend distribution rate may be selectively raised by the seller, which strongly stimulates the event join desires of the members to rapidly and reliably achieve a desired amount of product sales.

The product sales promotion system of an implementation of the disclosed technology may obtain profits with the system usage fee received from the seller when the event is activated by the seller and with the withdrawal fees received from the members when the cyber money is withdrawn from the cyber money accounts by the members. Further, if the number of events activated by numerous sellers over the world is uncountably large, the cash balance in the system account unit 150, which is obtained by the events, is kept to a very large amount of money. Therefore, a cyber money mortgage or secondary outsourcing investment may be conducted by means of the system usage fees, the withdrawal fees, and the cash balance in the system account, thereby creating great profits.

The members may withdraw the cyber money from their cyber money accounts and exchange the cyber money into the cash, or they may get a loan with their cyber money as collateral from the product sales promotion system. The members may exchange their cyber money into the cash with a payment of the withdrawal fees, but in this case, the amount of cyber money retained in the cyber money account is decreased and this may cause a disadvantage in ranking of the dividend distribution order of an event. So as to allow the member to exchange the cyber money into the cash in the state where the amount of cyber money retained is kept, the product sales promotion system may lend the cash of the system account unit to the members with the cyber money of the members as collateral. As a result, the product sales promotion system may provide a financial business.

It may be appreciated that the product sales promotion system according to an implementation of the disclosed technology provides a consuming-tech (consumption+financial technology) system that increases wealth through consumption, and as increased consumption may increase wealth, so that consumption, commercial exchange, and turnover rate are optimized to achieve significant advance in E-commerce unlike the conventional one.

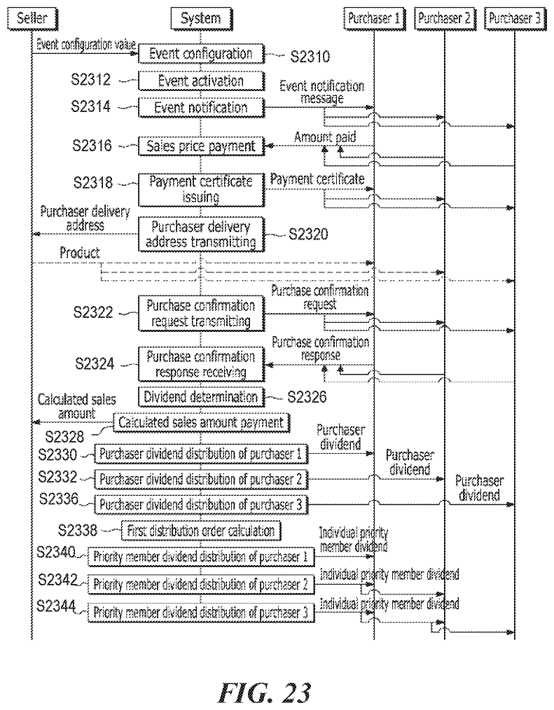

FIG. 23 is an exemplary flowchart showing processes of selling products and distributing a dividend in the product sales promotion system according to an implementation of the disclosed technology. The elements of the product sales promotion system will be referred to the system shown in FIG. 10, while the detailed operations processed by the elements are different in this implementation.

The seller is connected to the product sales promotion system using the seller terminal 1110 and he or she selects an event configuration menu so as to set an event through which the dividend corresponding to a portion of the paid sales price is distributed to the purchaser and other members. The event configuration unit 1210 displays, on the seller terminal 1110, an input screen where, as event configuration values, a product category, a product name, the number of products to be sold, a period of time for product sales, a usage period of a product, a sales price of a product, a dividend distribution rate, a purchaser distribution rate, a priority member distribution rate, and an period of time of order calculation, and so on are inputted, and the seller inputs, on the seller terminal 1110, the event configuration values as required through the seller terminal 1110. The values inputted to the event configuration unit 1210 through the seller terminal 10 are stored in the event configuration unit 1210, thereby completing setting the event (at step S1310).

The event configuration values may be arbitrarily determined by the seller, and some of them may be suggested with appropriate values by means of the product sales promotion system. Further, some of them are, in advance, calculated as optimized values by means of the product sales promotion system and provided as fixed values.

The event may be finished if the products to be sold are completely sold or the period of time for product sales ends, and it is possible that the number of products to be sold and the period of time for product sales are not set. The usage period of a product means a period of time during which a product (for example, coupon) can be effectively used. The sales price of the product may be a normal retail price of the product or a price discounted by a discount rate arbitrarily determined by the seller. The dividend distribution rate, the purchaser distribution rate, the priority member distribution rate, and the order calculation period will be explained later.

The event management unit 1220 activates the event set on the event configuration unit 1210 by the seller through the seller terminal 1110 (at step S2312).

If the event is activated, the event management unit 1220 transmits an event notification message to the terminals of the members joined in the product sales promotion system (at step S2316). The members may register the products in which they are interested on member information, and the event management unit 1220 may transmit the event notification message only to the members who have registered the products under the event as their interested products.

For the conveniences of the description, only purchasers 1, 2 and 3 are illustrated in FIG. 23, and the exemplary case wherein their first distribution order is determined in the order of the purchasers 1, 2 and 3 will be explained below.

So as to purchase the product, the purchaser makes a payment for the sales price of the product on the payment screen provided on the purchaser terminal 1120 by the product payment unit 1230 (at step S2316), and the paid amount for the sales price is deposited into the system account unit 1270. The payment may be made by the cyber money and/or the cash withdrawn from the cyber money account and/or cash account of the purchaser, the card sales amount received from a credit card company of the purchaser, and the payment amount received from a smart phone communication company of the purchaser. The payment may be made in various ways including online/offline payment method, and a detailed explanation on the payment method will be omitted.

If the payment for the product is made, the event management unit 120 issues a payment certificate and transfers the payment certificate to the purchaser terminal 1120 (at step S2318). The payment certificate may have a form of an electronic image.

The delivery management unit 1280 may transmit a delivery address and a payment certificate of the purchaser who makes a payment for the sales price of the product to the seller terminal 10 to allow the seller to deliver the product to the purchaser (at step S2320). A delivery method may include a delivery service and a direct delivery to the purchaser, and if the product is delivered directly to the purchaser, the seller scans bar codes on the payment certificate provided by the purchaser. After the purchaser is identified, accordingly, the product is taken over to the purchaser.

The purchase confirmation management unit 1290 may transmit a purchase confirmation request to the purchaser who receives the product through the delivery service or directly receives the product from the seller (at step S2322).

The purchase confirmation management unit 1290 may receive the response to the purchase confirmation request from the purchaser (at step S2324). The response to the purchase confirmation request is either a purchase confirmation response or a purchase cancel response. The purchase cancel response is the purchaser's expression to get a refund in case where the product purchased is unsatisfied. In this case, the event management unit 1220 pays the paid amount as a refund to the purchaser who transmits the purchase cancel response. The refund is withdrawn from the amount kept in the system account unit 1270 and is thus transferred to the cash account of the purchaser who transmits the purchase cancel response. Hereinafter, an explanation on the case where the response to the purchase confirmation request is the purchase confirmation response will be given.

If a first period of time of order calculation ends after the event is activated, the dividend distribution unit 1260 multiplies the sum of the paid amounts of the purchaser who performs the purchase confirmation response within the first period of time of order calculation by the dividend distribution rate to determine the dividend generated by the purchaser (at step S2326)

The period of time of order calculation may be set with a given period of time or in real time, and the given period of time may be set with a period of 12 hours, one day, or one week. If the period of time of order calculation ends, the distribution order is updated. If the period of time of order calculation is set in real time, the distribution order is updated right after the payments and purchase confirmations of the purchasers are finished.

The event management unit 1220 may pay the amount of product sales calculated by subtracting the dividends from the total amount of product sales (which is calculated by multiplying the sales price by the number of purchase confirmed products) to the cash account of the seller (at step S2328).

A portion of the dividend determined at the step S2326 is first distributed to the purchaser himself or herself. Hereinafter, the dividend distributed to the purchaser is called “purchaser dividend”.

The dividend distribution unit 1260 may multiply the dividend calculated by multiplying the sum of amounts paid by the purchaser 1 within the first period of time of order calculation by the dividend distribution rate by the purchaser distribution rate to calculate the purchaser dividend, and transfer the purchaser dividend to the cyber money account of the purchaser 1 (at step S2330).

The dividend distribution unit 1260 may multiply the dividend calculated by multiplying the sum of amounts paid by the purchaser 2 within the first period of time of order calculation by the dividend distribution rate by the purchaser distribution rate to calculate the purchaser dividend, and transfer the purchaser dividend to the cyber money account of the purchaser 2 (at step S2332).

The dividend distribution unit 1260 multiplies the dividend calculated by multiplying the sum of amounts paid by the purchaser 3 for the first period of time of order calculation by the dividend distribution rate, by the purchaser distribution rate to calculate the purchaser dividend, and transfers the purchaser dividend to the cyber money account of the purchaser 3 (at step S2336).

In this case, an explanation on the steps S2330 to S2336 which are sequentially performed is given, but the steps may be performed concurrently or in a reverse order to each other.

The order calculation unit 1250 calculates a first distribution order on the basis of the dividends distributed to the purchasers (at step S2338). The distribution order is the order of the members that is determined according to the amounts of cyber money deposited into the cyber money accounts of the members joined in the product sales promotion system. The first distribution order is the order determined after adding the purchaser dividend distributed to the member as the purchaser for the first period of time of order calculation to the amount of cyber money deposited into the cyber money account of the member before the activation of the event. In this case, the member may exchange cash into the cyber money and transfer the cyber money to the cyber money account, thereby increasing the amount of cyber money in the cyber money account.

The rest of dividend calculated by subtracting the purchaser dividend from the dividend determined at the step S2326 is distributed to the members who rank ahead the purchaser in the first distribution order (hereinafter, referred to as “priority members”) and the purchaser according to a predetermined priority member distribution way. The dividend distributed to each of the priority members and the purchaser according to the priority member distribution way, which is the amount calculated by subtracting the purchaser dividend from the dividend, is called “priority member dividend”, and a priority member dividend distributed by individual is called “individual priority member dividend”. The individual priority member dividends are transferred to the cyber money accounts of the purchaser and the priority members in the form of cyber money.

The recipients of the priority member dividends may be selected among the all members joined in the product sales promotion system or only among the purchasers who purchase the products sold through the event. That is, the distribution order may be calculated with respect to the all members or only the purchasers who purchase the products sold through the event.

If the first distribution order is determined, the dividend distribution unit 1260 has to distribute the priority member dividend which is the remaining amount calculated by subtracting the purchaser dividend from the dividend generated by the purchaser 1 to the priority members to the purchaser 1 and the purchaser 1 according to the priority member distribution way. Since the priority members to the purchaser 1 do not exist, however, the priority member dividend is distributed only to the purchaser 1 as the top priority member (at step S2340).

The dividend distribution unit 1260 may distribute the priority member dividend which is the remaining amount after subtracting the purchaser dividend from the dividend generated by the purchaser 2 to the priority member (that is, the purchaser 1) who ranks ahead the purchaser 2 and the purchaser 2 according to the priority member distribution method (at step S2342).

The dividend distribution unit 1260 may distribute the priority member dividend which is the remaining amount after subtracting the purchaser dividend from the dividend generated by the purchaser 3 to the priority members (that is, the purchaser 1 and the purchaser 2) who rank ahead the purchaser 3 and the purchaser 3 according to the priority member distribution method (at step S2344).

The purchaser dividends and the priority member dividends are withdrawn from the amount kept in the system account unit 1270 and are transferred to the cyber money accounts of the purchasers. The purchaser dividends and the priority member dividends are paid in cyber money, but it is possible that those are transferred in cash to the cash accounts of the purchasers.

Next, a second period of time of order calculation starts, and the steps S2316 to S2336 are repeatedly carried out. Second distribution order, which is used for the distribution of the priority member dividends for the second period of time of order calculation, is determined on the basis of the individual priority member dividends transferred to the cyber money accounts of the purchasers for the first period of time of order calculation and the purchaser dividends transferred to the cyber money accounts of the purchasers for the second period of time of order calculation. Updating the distribution order is performed in a such way whenever the order calculation periods of time pass.

In the product sales promotion system and method according to an implementation of the disclosed technology, the priority member distribution method is freely determined by the seller or the system. A desirable example of the priority member distribution method may be as follows.

The dividend distribution unit 1260 may arrange the priority members and the purchasers in the order of the distribution. Next, a first individual priority member dividend calculated by multiplying the priority member dividend by the priority member distribution rate is paid to a first member who is the first in distribution order, and a second individual priority member dividend calculated by multiplying the amount remaining after subtracting the first individual priority member dividend from the priority member dividend by the priority member distribution rate is paid to a second member who is the second in the distribution order.

In this example, only the first and second priority members are exemplified, but in the same manner as above, the individual priority member dividends may be paid to the priority members who are next to the first and second priority members. For example, a third individual priority member dividend calculated by multiplying the amount remaining after subtracting the first individual priority member dividend and the second individual priority member dividend from the priority member dividend by the priority member distribution rate is paid to a third member who is the third in the distribution order.

If the priority member dividend remains even after the individual priority member dividends are paid to all of the priority members and the purchasers, the priority member dividend calculated by multiplying the remaining priority member dividend by the priority member distribution rate may be paid in the order of the priority members from the first members in the same manner as above. However, if the remaining priority member dividend is less than a predetermined amount, the dividend distribution unit 1260 may transfer the remaining priority member dividend to the system account unit 1270 and finish the priority member dividend distribution.

According to another desirable example of the priority member distribution method, the priority member dividend may be divided into N (wherein N=the number of priority members+1), and the divided priority member dividends may be paid equally to the priority members and the purchaser.

If the purchasers purchase the products during the event through the product sales promotion system and method according to an implementation of the disclosed technology, the purchaser dividends and the priority member dividends are continuously distributed, so that the assets of the purchasers are increased through their purchase and the purchase of other members. Now, the effects obtained by the system and method according to the disclosed technology will be explained with an exemplary case.

A seller A who sells clothing in America determines to sell 7 kinds of clothes at the lowest price on online through the product sales promotion system according to an implementation of the disclosed technology, and the sales prices of the 7 kinds of clothes to be sold by the seller A are 5, 8, 10, 20, 50, 100 and 200 dollars respectively. The following event configuration values are inputted by the seller A.
Target period of product sales: three days
Period of time of order calculation: one day
Dividend distribution rate: 10%
Purchaser distribution rate: 40%
Priority member distribution method: Even distribution to N including purchasers

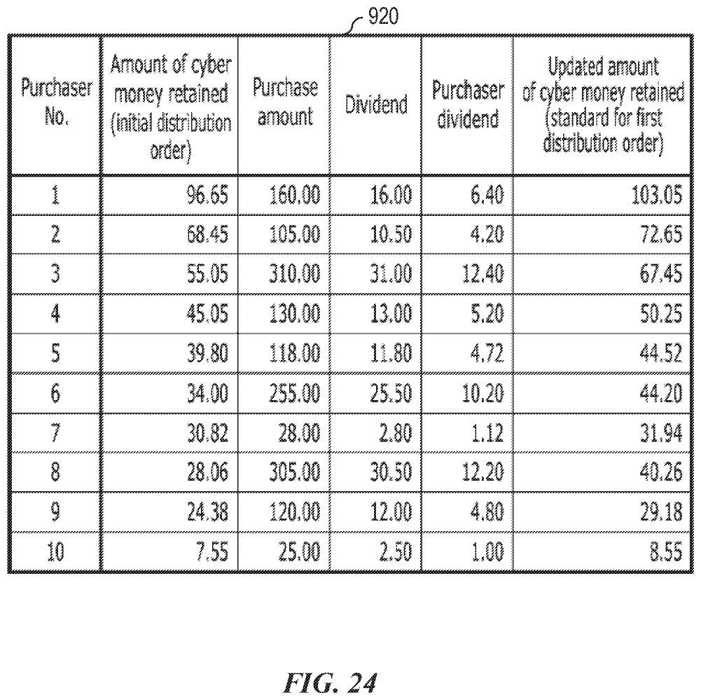

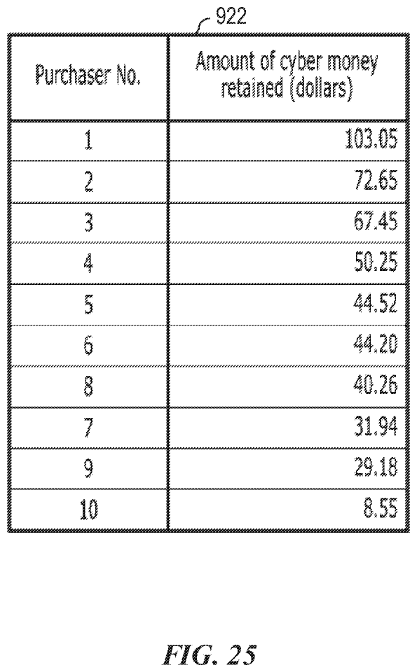

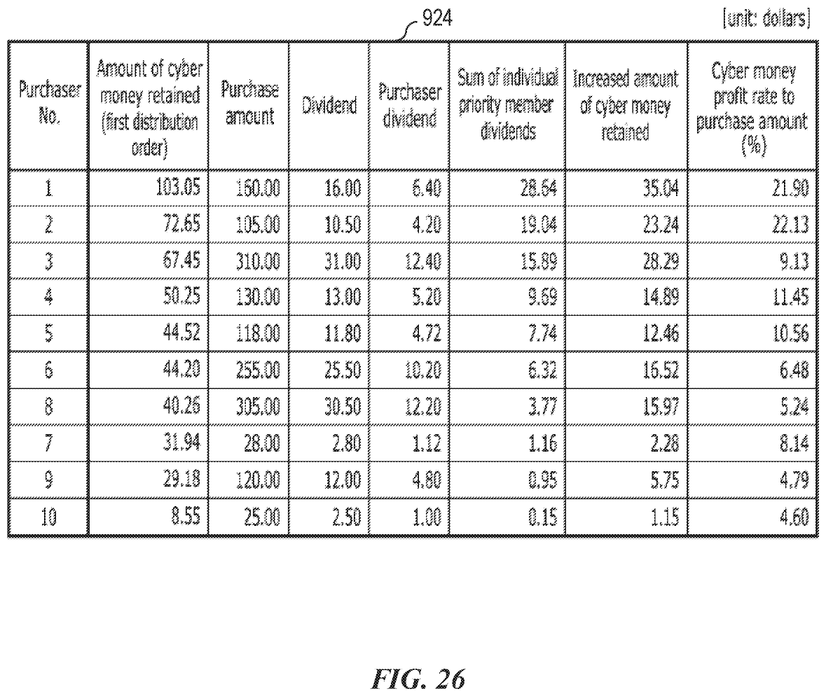

FIG. 24 is an exemplary table showing the purchaser dividends transferred to the purchasers for a first period of time of order calculation and the amounts of cyber money retained updated on the basis of the purchaser dividends, which will be a standard for the first distribution order. FIG. 25 is an exemplary table showing the first distribution order. FIG. 26 is an exemplary table showing amounts transferred to the purchasers and profit rates of the purchasers for the first period of time of order calculation.

The purchaser 1 is the first purchaser in the initial distribution order and buys 160 dollars clothing for the first period of time of order calculation. As soon as the first period of time of order calculation passes, 16.00 dollars corresponding to 10% (dividend distribution rate) of 160 dollars paid by the purchaser 1 are determined as the dividend generated by the purchaser 1. Next, 6.40 dollars, as a purchaser dividend, corresponding to 40% (purchaser distribution rate) of the dividend are transferred to the cyber money account of the purchaser 1. Through the increment of the purchaser dividend, the amount of cyber money of 96.65 dollars of the purchaser 1 is increased to 103.05 dollars. The purchaser 8 pays 305.00 dollars, and 12.20 dollars as the purchaser dividend are transferred to the cyber money account of the purchaser 8. As a result, the amount of cyber money of 28.06 dollars of the purchaser 8 is increased to 40.26 dollars, which is greater than the amount of cyber money of 31.94 dollars of the purchaser 7 who pays 28.00 dollars, so that the first distribution order of the purchaser 8 is upgraded one step. Accordingly, the purchaser increases his or her purchase amount to upgrade his or her distribution order, thereby obtaining a substantially large amount of individual priority member dividend.

The first distribution order is determined on the basis of the updated amounts of cyber money, and the individual priority member dividend is distributed on the basis of the first distribution order. In detail, 9.60 dollars corresponding to the amount calculated after subtracting the purchaser dividend from the dividend are transferred only to the cyber money account of the purchaser 1 because the priority members to the purchaser 1 do not exist. Also, the priority member dividend is calculated after subtracting the purchaser dividend from the dividend corresponding to 10% (dividend distribution rate) of the amount paid by each of the purchasers 2 to 10, and the individual priority member dividend is the amount calculated after dividing the priority member dividend by the number of purchasers and priority members (that is, the amounts divided by N parts; N=the number of priority members+1). The individual priority member dividends are transferred to the cyber money account of the purchaser 1. That is, the purchaser 1 has 28.64 dollars as the sum of the individual priority member dividends (the priority member dividend of the purchaser 1 of 9.60 dollars, the individual priority member dividend of 3.15 dollars transferred from the purchaser 2, the individual priority member dividend of 6.20 dollars transferred from the purchaser 3, the individual priority member dividend of 1.95 dollars transferred from the purchaser 4, the individual priority member dividend of 1.42 dollars transferred from the purchaser 5, the individual priority member dividend of 2.55 dollars transferred from the purchaser 6, the individual priority member dividend of 0.21 dollars transferred from the purchaser 7, the individual priority member dividend of 2.61 dollars transferred from the purchaser 8, the individual priority member dividend of 0.80 dollars transferred from the purchaser 9, and the individual priority member dividend of 0.15 dollars transferred from the purchaser 10).

The purchaser 1 has purchased clothing of 160 dollars at the lowest price on online for the first period of time of order calculation, so that his or her assets of 35.04 dollars (the sum of the purchaser dividend of 6.40 dollars and the sum of the individual priority member dividends of 28.64 dollars) are increased. Also, a cyber money profit rate to the purchase amount of the purchaser 1 for the first period of time of order calculation is 21.90%. The purchaser 2 is the second purchaser in the initial distribution order and spends 105 dollars on clothing for the first period of time of order calculation. As soon as the first period of time of order calculation passes, 10.50 dollars corresponding to 10% (dividend distribution rate) of 105 dollars paid by the purchaser 2 is determined as the dividend generated by the purchaser 2. Next, 4.20 dollars, as a purchaser dividend, corresponding to 40% (purchaser distribution rate) of the dividend are transferred to the cyber money account of the purchaser 2. Through the increment of the purchaser dividend, the amount of cyber money of 68.45 dollars of the purchaser 2 is increased to 72.65 dollars.

That is, 6.30 dollars corresponding to the amount calculated after subtracting the purchaser dividend from the dividend are equally distributed to the purchaser 1 as the priority member to the purchaser 2 and the purchaser 2, so that 3.15 dollars are transferred to the cyber money accounts of the purchaser 1 and the purchaser 2, respectively. Also, the priority member dividend is calculated after subtracting the purchaser dividend from the dividend corresponding to 10% (dividend distribution rate) of the amount paid by each of the purchasers 3 to 10, and the individual priority member dividend is the amount calculated after dividing the priority member dividend by the number of purchasers and priority members (that is, the amounts divided by N parts; N=the number of priority members+1). The individual priority member dividends are transferred to the cyber money account of the purchaser 2. That is, the purchaser 2 has 19.04 dollars as the sum of the individual priority member dividends (the individual priority member dividend of 3.15 dollars of the purchaser 2, the individual priority member dividend of 6.20 dollars transferred from the purchaser 3, the individual priority member dividend of 1.95 dollars transferred from the purchaser 4, the individual priority member dividend of 1.42 dollars transferred from the purchaser 5, the individual priority member dividend of 2.55 dollars transferred from the purchaser 6, the individual priority member dividend of 0.21 dollars transferred from the purchaser 7, the individual priority member dividend of 2.61 dollars transferred from the purchaser 8, the individual priority member dividend of 0.80 dollars transferred from the purchaser 9, and the individual priority member dividend of 0.15 dollars transferred from the purchaser 10).

The purchaser 2 has purchased clothing with the amount less than the purchase amount of the purchaser 1 for the first period of time of order calculation, but a cyber money profit rate to the purchase amount of the purchaser 2 for the first period of time of order calculation is 22.13%, which is higher than the cyber money profit rate to the purchase amount of the purchaser 1 of 21.90%. Further, the purchaser 7 has purchased clothing of 28 dollars for the first period of time of order calculation, and that is, the 28 dollars are just the amount corresponding to 9.2% of the purchase amount of 305.00 dollars of the purchaser 8. In this case, however, a cyber money profit rate to the purchase amount of the purchaser 7 is 8.14%, which is higher than the cyber money profit rate to the purchase amount of the purchaser 8 of 5.24%. Therefore, the product sales promotion system according to an implementation of the disclosed technology has different structures and effects from the conventional point saving system in which points proportional to purchase amounts are simply saved. Under the product sales promotion system according to an implementation of the disclosed technology, even if the purchaser purchases the products with a relatively low purchase amount, his or her cyber money profit rate to the purchase amount can be higher than other purchasers.

Through such exceptionality of the cyber money profit rate to the purchase amount, even the low-order purchasers in the distribution order hope that they will have the cyber money profit rate to the purchase amount higher than the priority members and also their distribution order will be raised, so that the purchase of all of the purchasers who are in the distribution order can be promoted.

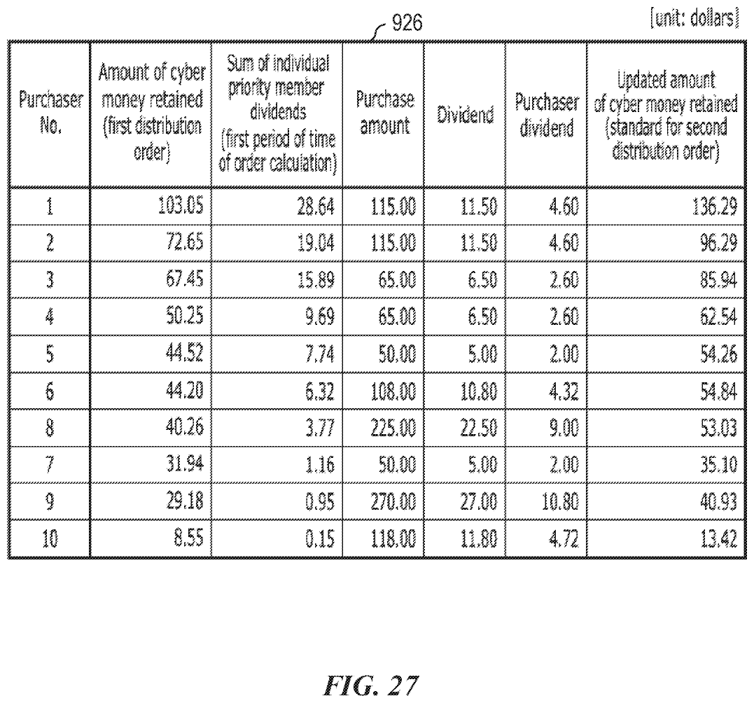

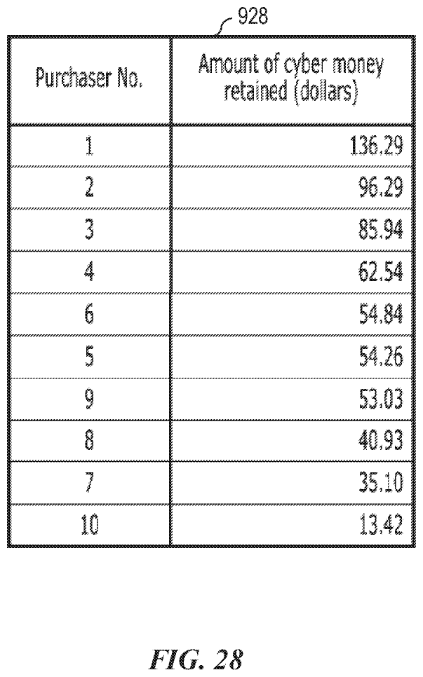

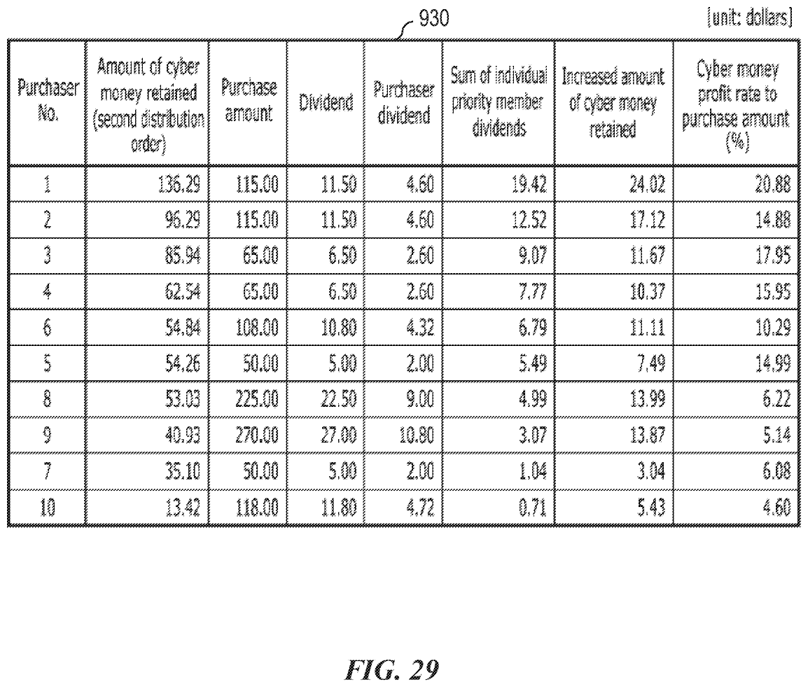

FIG. 27 is an exemplary table showing the purchaser dividends transferred to the purchasers for a second period of time of order calculation and the amounts of cyber money retained updated on the basis of the sum of individual priority member dividends for the first period of time of order calculation and the purchaser dividends for the second period of time of order calculation, which will be a standard for the second distribution order. FIG. 28 is an exemplary table showing the second distribution order. FIG. 29 is an exemplary table showing amounts transferred to the purchasers and profit rates of the purchasers for the second period of time of order calculation.

In the first distribution order, the amount of cyber money of the purchaser 7 is 31.94 dollars and that of the purchaser 9 is 29.18 dollars, and accordingly, the first distribution order of the purchaser 7 is higher than that of the purchaser 9. Through the sum of individual priority member dividends for the first period of time of order calculation and the purchaser dividends for the second period of time of order calculation, the amount of cyber money of the purchaser 7 is 35.10 dollars and that of the purchaser 9 is 40.93 dollars, so that the purchaser 9 is higher than the purchaser 7 in the second distribution order as a dividend distribution standard for the second period of time of order calculation.

The purchaser 5 has purchased clothing of 50.00 dollars for the second period of time of order calculation, and that is, the 50.00 dollars are just the amount corresponding to 43.5% of the purchase amount of 115.00 dollars of the purchaser 2. In this case, however, a cyber money profit rate to the purchase amount of the purchaser 5 is 14.99%, which is higher than the cyber money profit rate to the purchase amount of the purchaser 2 of 14.88%. It can be appreciated again that under the product sales promotion system according to an implementation of the disclosed technology, therefore, even if the purchaser purchases the products with a relatively low purchase amount, his or her cyber money profit rate to the purchase amount can be higher than other purchasers.

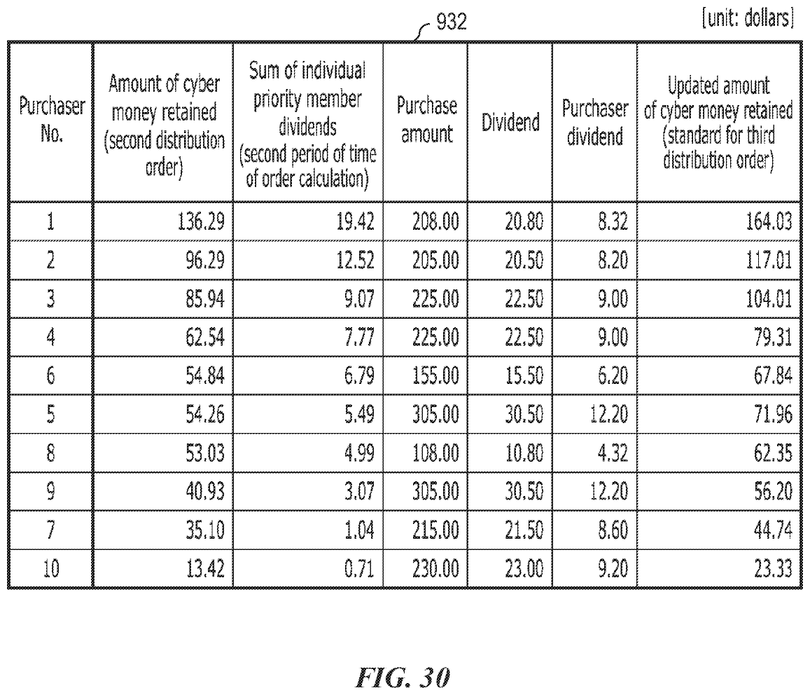

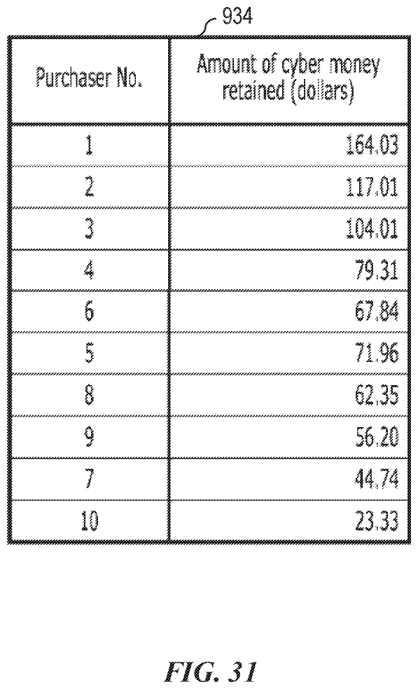

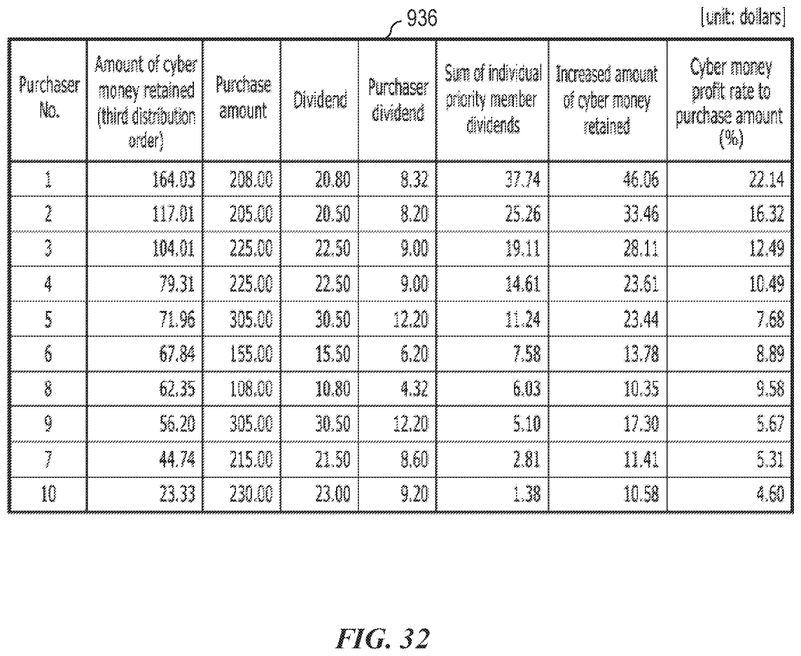

FIG. 30 is an exemplary table showing the purchaser dividends transferred to the purchasers for a third period of time of order calculation and the amounts of cyber money retained updated on the basis of the sum of individual priority member dividends for the second period of time of order calculation and the purchaser dividends for the third period of time of order calculation, which will be a standard for the third distribution order. FIG. 31 is an exemplary table showing the third distribution order. FIG. 32 is an exemplary table showing amounts transferred to the purchasers and profit rates of the purchasers for the third period of time of order calculation.

In the second distribution order, the amount of cyber money of the purchaser 6 is 54.84 dollars and that of the purchaser 5 is 54.26 dollars, and accordingly, the second distribution order of the purchaser 6 is higher than that of the purchaser 5. Through the sum of individual priority member dividends for the second period of time of order calculation and the purchaser dividends for the third period of time of order calculation, the amount of cyber money of the purchaser 6 is 67.84 dollars and that of the purchaser 5 is 71.96 dollars, so that the purchaser 5 is higher than the purchaser 6 in the third distribution order as a dividend distribution standard for the third period of time of order calculation.

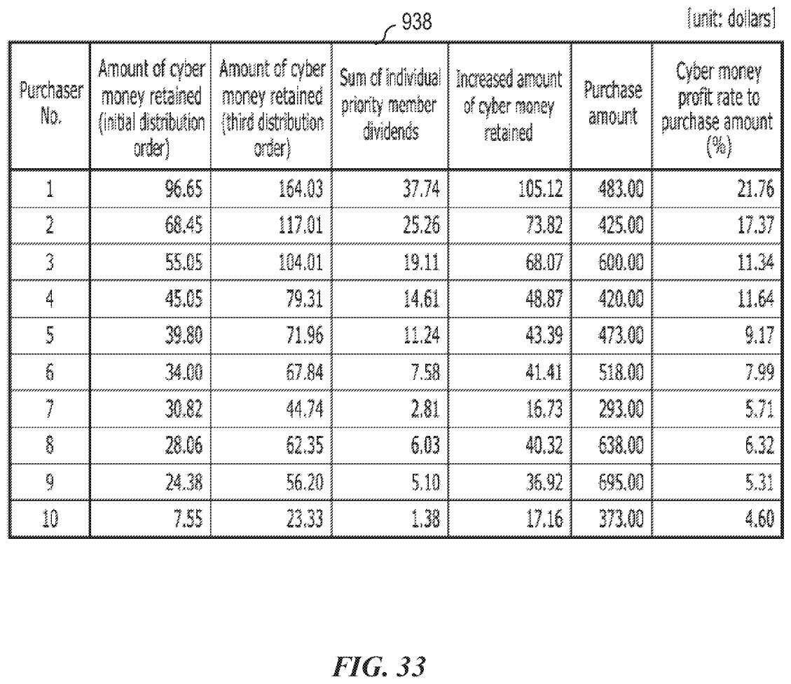

FIG. 33 is an exemplary table showing cyber money profit rates to the purchase amounts of the purchasers during an event.

While the purchaser 1 is retaining the cyber money of 96.65 dollars before the event, he or she purchases 9 pieces of clothing at the lowest online price of 483.00 dollars during the event for three days, so that additionally, the cyber money of the purchaser 1 is increased to 105.12 dollars. The cyber money profit rate to the purchase amount of the purchaser 1 is 21.76%. It can be also checked that the amounts of cyber money of other purchasers are increased. With a payment of the withdrawal fee, the cyber money may be transferred to the cash account from the cyber money account in the form of cash or may be withdrawn directly from the cyber money account in the form of cash, so that the cash assets of the purchaser can be increased. Further, the distribution order of the purchaser can be upgraded by means of the amount of cyber money distributed to him or her, thereby providing a big possibility that a larger amount of dividend on another event is distributed to him or her.

If the payment of the purchaser is made through the use of an interest-free installment program provided by a credit card company, the profit of the purchaser will be maximized. If the purchaser buys 483.00 dollar clothing in the conventional purchase system, he or she must prepare 483.00 dollars, which makes him or her feel burdened so that he or she is refrained from purchasing the clothing. Through the product sales promotion system 100 of the disclosed technology, the sales price is paid in interest-free installments, and next, the installment amount may be paid with the dividend distributed to the purchaser, thereby lessening the burden of the purchaser. Such an advantage is obtained because the value of time is turned into the cyber money. Particularly, if the dividend distribution rate is raised by the seller, the amounts to be distributed to the purchasers are increased, so that the consumption will and event join will of the members become high.

The seller accomplishes a substantially larger amount of sales than an amount of sales in the past, for a short period of time, thereby obtaining a great sales profit, and even if the dividend is distributed, an amount of sales over several months to years can be obtained within the short period of time, so that no damage occurs. Also, the dividend, as a sales agency commission, is the amount paid to the system provider of the conventional system, and therefore, the seller does not have any substantial damage even if seller distributes the dividend. So as to increase the amount of sales in a short period of time, the dividend distribution rate may be selectively raised by the seller, which strongly stimulates the event join desires of the members to rapidly and reliably achieve a desired amount of product sales.

The product sales promotion system of an implementation of the disclosed technology may obtain profits with the system usage fee received from the seller when the event is activated by the seller and with the withdrawal fees received from the members when the cyber money is withdrawn from the cyber money accounts by the members. Further, if the number of events activated by numerous sellers over the world is uncountably large, the cash balance in the system account unit 150, which is obtained by the events, is kept to a very large amount of money. Therefore, a cyber money mortgage or secondary outsourcing investment may be conducted by means of the system usage fees, the withdrawal fees, and the cash balance in the system account, thereby creating great profits.

The members may withdraw the cyber money from their cyber money accounts and exchange the cyber money into the cash, or they may get a loan with their cyber money as collateral from the product sales promotion system. The members may exchange their cyber money into the cash with a payment of the withdrawal fees, but in this case, the amount of cyber money retained in the cyber money account is decreased and this may cause a disadvantage in ranking of the dividend distribution order of an event. So as to allow the member to exchange the cyber money into the cash in the state where the amount of cyber money retained is kept, the product sales promotion system may lend the cash of the system account unit to the members with the cyber money of the members as collateral. As a result, the product sales promotion system may provide a financial business.

It may be appreciated that the product sales promotion system according to an implementation of the disclosed technology provides a consuming-tech (consumption+financial technology) system that increases wealth through consumption, and as increased consumption may increase wealth, so that consumption, commercial exchange, and turnover rate are optimized to achieve significant advance in E-commerce unlike the conventional one.

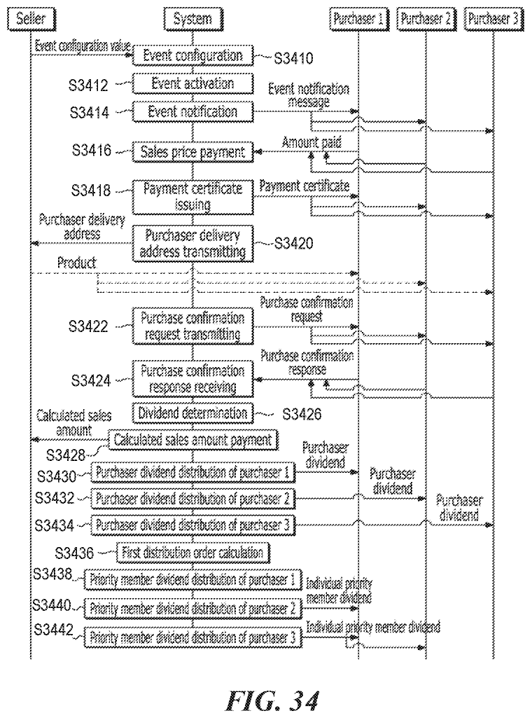

The disclosed technology can be implemented to provide another example of a process for distributing a dividend in the product sales promotion system according to an implementation of the disclosed technology. FIG. 34 shows an exemplary flowchart showing processes of distributing a dividend in the product sales promotion system based on some implementations of the disclosed technology. The elements of the product sales promotion system will be referred to the system shown in FIG. 10, while the detailed operations processed by the elements are different in this implementation. In the below, the differences of the operations in FIG. 34 and those in FIG. 23 will be mainly discussed, while omitting the repeated descriptions.

The event configuration unit displays, on the seller terminal 1110, an input screen where, as event configuration values, a product category, a product name, the number of products to be sold, a period of time for product sales, a usage period of a product, a sales price of a product, a dividend distribution rate, a purchaser distribution rate, a priority member distribution rate, an period of time of order calculation, a priority member distribution range and soon are inputted, and the seller inputs, on the seller terminal 110, the event configuration values as required through the seller terminal 10. The values inputted to the event configuration unit 1110 through the seller terminal 10 are stored in the event configuration unit 1110, thereby completing setting the event (at step S3410).

The event may be finished if the products to be sold are completely sold or the period of time for product sales ends, and it is possible that the number of products to be sold and the period of time for product sales are not set. The usage period of a product means a period of time during which a product (for example, coupon) can be effectively used. The sales price of the product may be a normal retail price of the product or a price discounted by a discount rate arbitrarily determined by the seller. The dividend distribution rate, the purchaser distribution rate, the priority member distribution rate, the order calculation period and the priority member distribution range will be explained later.

The order calculation unit 1250 calculates a first distribution order on the basis of the purchaser dividends distributed to the purchasers (at step S3436). The distribution order is the order of the members that is determined according to the amounts of cyber money deposited into the cyber money accounts of the members joined in the product sales promotion system. The first distribution order is the order determined after adding the purchaser dividend distributed to the member as the purchaser for the first period of time of order calculation to the amount of cyber money deposited into the cyber money account of the member before the activation of the event. In this case, the member may exchange cash into the cyber money and transfer the cyber money to the cyber money account, thereby increasing the amount of cyber money in the cyber money account.

The rest of dividend calculated by subtracting the purchaser dividend from the dividend determined at the step S3426 is distributed to all or some of the members who rank ahead the purchaser in the first distribution order (hereinafter, referred to as “priority members”) according to a predetermined priority member distribution way. The dividend distributed to all or some of the priority members according to the priority member distribution way, which is the amount calculated by subtracting the purchaser dividend from the dividend, is called “priority member dividend”, and a priority member dividend distributed by individual is called “individual priority member dividend”. The individual priority member dividends are transferred to the cyber money accounts of all or some of the priority members in the form of cyber money.

The recipients of the priority member dividends may be selected among the all members joined in the product sales promotion system or only among the purchasers who purchase the products sold through the event. That is, the distribution order may be calculated with respect to the all members or only the purchasers who purchase the products sold through the event.

The priority member distribution range means the range of the priority members who receive the distribution among the priority members, and “distribution to all of the priority members” and “distribution to some of the priority members” may be selected by the seller or the system. Hereinafter, an explanation on the case where the dividend distribution unit 160 distributes the priority member dividend to all of the priority members will be given.

If the first distribution order is determined, the dividend distribution unit 160 has to distribute the priority member dividend which is the remaining amount calculated by subtracting the purchaser dividend from the dividend generated by the purchaser 1 to the priority members to the purchaser 1 according to the priority member distribution way. Since the priority members to the purchaser 1 do not exist, however, the priority member dividend is transferred to the system account unit 1270 (at step S3430).

The dividend distribution unit 1260 may distribute the priority member dividend which is the remaining amount after subtracting the purchaser dividend from the dividend generated by the purchaser 2 to the priority member (that is, the purchaser 1) who ranks ahead the purchaser 2 according to the priority member distribution method (at step S3432).

The dividend distribution unit 1260 may distribute the priority member dividend which is the remaining amount after subtracting the purchaser dividend from the dividend generated by the purchaser 3 to the priority members (that is, the purchaser 1 and the purchaser 2) who rank ahead the purchaser 3 according to the priority member distribution method (at step S3434).

The purchaser dividends and the priority member dividends are withdrawn from the amount kept in the system account unit 1270 and are transferred to the cyber money accounts of the purchasers and the priority members. The purchaser dividends and the priority member dividends are paid in cyber money, but it is possible that those are transferred in cash to the cash accounts of the purchasers and the priority members.

Next, a second period of time of order calculation starts, and the steps S3416 to S3434 are repeatedly carried out. Second distribution order, which is used for the distribution of the priority member dividends for the second period of time of order calculation, is determined on the basis of the individual priority member dividends transferred to the cyber money accounts of the priority members for the first period of time of order calculation and the purchaser dividends transferred to the cyber money accounts of the purchasers for the second period of time of order calculation. Updating the distribution order is performed in a such way whenever the order calculation periods of time pass.

The dividend distribution unit 1260 may distribute the priority member dividend only to some of the priority members. In this case, the some of the priority members are selected according to the distribution order in order from the top priority member or are randomly selected.

An exemplary case where some of the priority members are selected as the priority member distribution range according to the distribution order from the top priority member will be explained. For example, the priority member dividend generated by the purchase who is the 100th in the distribution order is not distributed to all of the 99 priority members, but to some of the priority members such as the priority members who are first to 70th, first to 50th, or first to 30th are firstly selected, the priority member dividends may be distributed only to the selected priority members according to the priority member distribution method on the basis of the distribution order.

An exemplary case where some of the priority members are randomly selected as the priority member distribution range will be explained. For example, the priority member dividend generated by the purchase of the purchaser who is the 100th in the distribution order is not distributed to all of the 99 priority members, but to 70, 50, or 30 priority members who are randomly selected from the 99 priority members, the priority member dividends are distributed only to the selected priority members according to the priority member distribution method on the basis of the distribution order.

In the product sales promotion system and method according to an implementation of the disclosed technology, the priority member distribution method is freely determined by the seller or the system. A desirable example of the priority member distribution method may be as follows.

The dividend distribution unit 1260 may arrange the priority members in the order of the distribution. Next, a first individual priority member dividend calculated by multiplying the priority member dividend by the priority member distribution rate is paid to a first member who is the first in distribution order, and a second individual priority member dividend calculated by multiplying the amount remaining after subtracting the first individual priority member dividend from the priority member dividend by the priority member distribution rate is paid to a second member who is the second in the distribution order.

In this example, only the first and second priority members are exemplified, but in the same manner as above, the individual priority member dividends may be paid to the priority members who are next to the first and second priority members. For example, a third individual priority member dividend calculated by multiplying the amount remaining after subtracting the first individual priority member dividend and the second individual priority member dividend from the priority member dividend by the priority member distribution rate is paid to a third member who is the third in the distribution order.

If the priority member dividend remains even after the individual priority member dividends are paid to all of the priority members, the priority member dividend calculated by multiplying the remaining priority member dividend by the priority member distribution rate may be paid in the order of the priority members from the first members in the same manner as above. However, if the remaining priority member dividend is less than a predetermined amount, the dividend distribution unit 1260 may transfer the remaining priority member dividend to the system account unit 170 and finish the priority member dividend distribution.

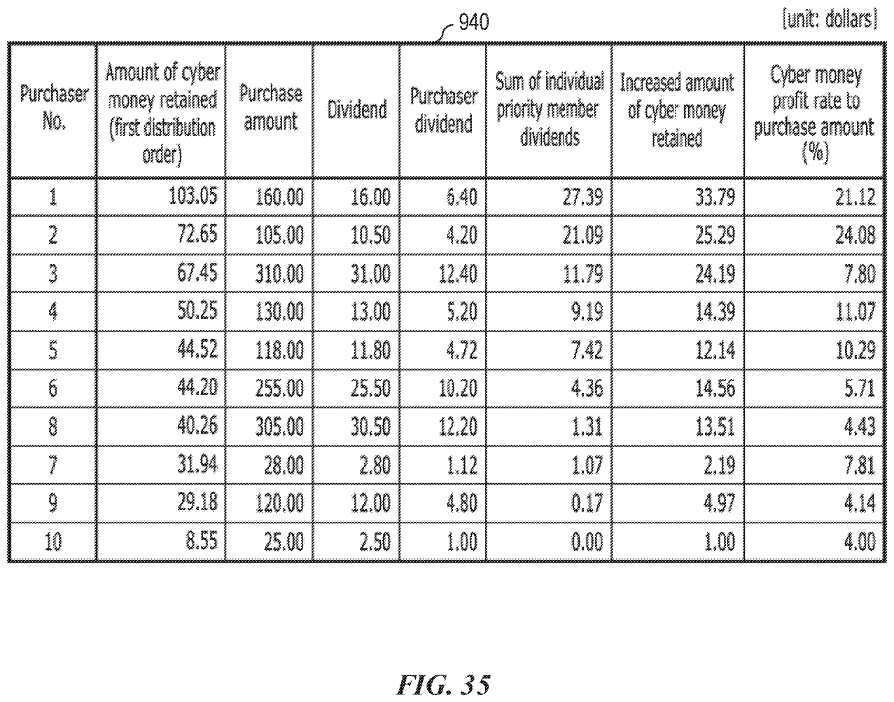

FIG. 35 is an exemplary table showing amounts transferred to the purchasers and profit rates of the purchasers for the first period of time of order calculation.

The purchaser 1 is the first purchaser in the initial distribution order and buys 160 dollars clothing for the first period of time of order calculation. As soon as the first period of time of order calculation passes, 16.00 dollars corresponding to 10% (dividend distribution rate) of 160 dollars paid by the purchaser 1 are determined as the dividend generated by the purchaser 1. Next, 6.40 dollars, as a purchaser dividend, corresponding to 40% (purchaser distribution rate) of the dividend are transferred to the cyber money account of the purchaser 1. Through the increment of the purchaser dividend, the amount of cyber money of 96.65 dollars of the purchaser 1 is increased to 103.05 dollars. The purchaser 8 pays 305.00 dollars, and 12.20 dollars as the purchaser dividend are transferred to the cyber money account of the purchaser 8. As a result, the amount of cyber money of 28.06 dollars of the purchaser 8 is increased to 40.26 dollars, which is greater than the amount of cyber money of 31.94 dollars of the purchaser 7 who pays 28.00 dollars, so that the first distribution order of the purchaser 8 is upgraded one step. Accordingly, the purchaser increases his or her purchase amount to upgrade his or her distribution order, thereby obtaining a substantially large amount of individual priority member dividend.

The first distribution order is determined on the basis of the updated amounts of cyber money, and the individual priority member dividend is distributed on the basis of the first distribution order. In detail, 9.60 dollars corresponding to the amount calculated after subtracting the purchaser dividend from the dividend are transferred to the system account unit because the priority members to the purchaser 1 do not exist. Also, the priority member dividend is calculated after subtracting the purchaser dividend from the dividend corresponding to 10% (dividend distribution rate) of the amount paid by each of the purchasers 2 to 10, and the individual priority member dividend is the amount calculated after dividing the priority member dividend by the number of priority members (that is, the amounts divided by N parts; N=the number of priority members). The individual priority member dividends are transferred to the cyber money account of the purchaser 1. That is, the purchaser 1 has 27.39 dollars as the sum of the individual priority member dividends (the individual priority member dividend of 6.30 dollars transferred from the purchaser 2, the individual priority member dividend of 9.30 dollars transferred from the purchaser 3, the individual priority member dividend of 2.60 dollars transferred from the purchaser 4, the individual priority member dividend of 1.77 dollars transferred from the purchaser 5, the individual priority member dividend of 3.06 dollars transferred from the purchaser 6, the individual priority member dividend of 0.24 dollars transferred from the purchaser 7, the individual priority member dividend of 3.05 dollars transferred from the purchaser 8, the individual priority member dividend of 0.90 dollars transferred from the purchaser 9, and the individual priority member dividend of 0.17 dollars transferred from the purchaser 10).

The purchaser 1 has purchased clothing of 160 dollars at the lowest price on online for the first period of time of order calculation, so that his or her assets of 33.79 dollars (the sum of the purchaser dividend of 6.40 dollars and the sum of the individual priority member dividends of 27.39 dollars) are increased. Also, a cyber money profit rate to the purchase amount of the purchaser 1 for the first period of time of order calculation is 21.12%.

The purchaser 2 is the second purchaser in the initial distribution order and spends 105 dollars on clothing for the first period of time of order calculation. As soon as the first period of time of order calculation passes, 10.50 dollars corresponding to 10% (dividend distribution rate) of 105 dollars paid by the purchaser 2 is determined as the dividend generated by the purchaser 2. Next, 4.20 dollars, as a purchaser dividend, corresponding to 40% (purchaser distribution rate) of the dividend are transferred to the cyber money account of the purchaser 2. Through the increment of the purchaser dividend, the amount of cyber money of 68.45 dollars of the purchaser 2 is increased to 72.65 dollars.

That is, 6.30 dollars corresponding to the amount calculated after subtracting the purchaser dividend from the dividend of the purchaser 2 are transferred to the cyber money account of the purchaser 1 as the priority member to the purchaser 2. Also, the priority member dividend is calculated after subtracting the purchaser dividend from the dividend corresponding to 10% (dividend distribution rate) of the amount paid by each of the purchasers 3 to 10, and the individual priority member dividend is the amount calculated after dividing the priority member dividend by the number of priority members (that is, the amounts divided by N parts; N=the number of priority members). The individual priority member dividends are transferred to the cyber money account of the purchaser 2. That is, the purchaser 2 has 21.09 dollars as the sum of the individual priority member dividends (the individual priority member dividend of 9.30 dollars transferred from the purchaser 3, the individual priority member dividend of 2.60 dollars transferred from the purchaser 4, the individual priority member dividend of 1.77 dollars transferred from the purchaser 5, the individual priority member dividend of 3.06 dollars transferred from the purchaser 6, the individual priority member dividend of 0.24 dollars transferred from the purchaser 7, the individual priority member dividend of 3.05 dollars transferred from the purchaser 8, the individual priority member dividend of 0.90 dollars transferred from the purchaser 9, and the individual priority member dividend of 0.17 dollars transferred from the purchaser 10).

The purchaser 3 is the third purchaser in the initial distribution order and spends 310 dollars on clothing for the first period of time of order calculation. As soon as the first period of time of order calculation passes, 31.00 dollars corresponding to 10% (dividend distribution rate) of 310 dollars paid by the purchaser 3 are determined as the dividend generated by the purchaser 3. Next, 12.40 dollars, as a purchaser dividend, corresponding to 40% (purchaser distribution rate) of the dividend are transferred to the cyber money account of the purchaser 3. The purchaser dividend of the purchaser 3 is increased so that the amount of cyber money of 55.05 dollars is increased to 67.45 dollars.

Next, 18.60 dollars corresponding to the amount calculated after subtracting the purchaser dividend from the dividend of the purchaser 3 are transferred to the cyber money accounts of the purchaser 1 and the purchaser 2 as the priority members, so that 9.30 dollars are transferred to the cyber money accounts of the purchaser 1 and the purchaser 2, respectively. Also, the priority member dividend is calculated after subtracting the purchaser dividend from the dividend corresponding to 10% (dividend distribution rate) of the amount paid by each of the purchasers 4 to 10, and the individual priority member dividend is the amount calculated after dividing the priority member dividend by the number of priority members (that is, the amounts divided by N parts; N=the number of priority members). The individual priority member dividends are transferred to the cyber money account of the purchaser 3. That is, the purchaser 3 has 11.79 dollars as the sum of the individual priority member dividends (the individual priority member dividend of 2.60 dollars transferred from the purchaser 4, the individual priority member dividend of 1.77 dollars transferred from the purchaser 5, the individual priority member dividend of 3.06 dollars transferred from the purchaser 6, the individual priority member dividend of 0.24 dollars transferred from the purchaser 7, the individual priority member dividend of 3.05 dollars transferred from the purchaser 8, the individual priority member dividend of 0.90 dollars transferred from the purchaser 9, and the individual priority member dividend of 0.17 dollars transferred from the purchaser 10).

The purchaser 4 is the fourth purchaser in the initial distribution order and spends 130 dollars on clothing for the first period of time of order calculation. As soon as the first period of time of order calculation passes, 13.00 dollars corresponding to 10% (dividend distribution rate) of 130 dollars paid by the purchaser 4 are determined as the dividend generated by the purchaser 4. Next, 5.20 dollars, as a purchaser dividend, corresponding to 40% (purchaser distribution rate) of the dividend are transferred to the cyber money account of the purchaser 4. The purchaser dividend of the purchaser 4 is increased so that the amount of cyber money of 45.05 dollars is increased to 50.25 dollars.

Next, 7.80 dollars corresponding to the amount calculated after subtracting the purchaser dividend from the dividend of the purchaser 4 are transferred to the cyber money accounts of the purchaser 1, the purchaser 2 and the purchaser 3 as the priority members, so that 2.60 dollars are transferred into the cyber money accounts of the purchaser 1, the purchaser 2, and the purchaser 3, respectively. Also, the priority member dividend is calculated after subtracting the purchaser dividend from the dividend corresponding to 10% (dividend distribution rate) of the amount paid by each of the purchasers 5 to 10, and the individual priority member dividend is the amount calculated after dividing the priority member dividend by the number of priority members (that is, the amounts divided by N parts; N=the number of priority members). The individual priority member dividends are transferred to the cyber money account of the purchaser 4. That is, the purchaser 4 has 9.19 dollars as the sum of the individual priority member dividends (the individual priority member dividend of 1.77 dollars transferred from the purchaser 5, the individual priority member dividend of 3.06 dollars transferred from the purchaser 6, the individual priority member dividend of 0.24 dollars transferred from the purchaser 7, the individual priority member dividend of 3.05 dollars transferred from the purchaser 8, the individual priority member dividend of 0.90 dollars transferred from the purchaser 9, and the individual priority member dividend of 0.17 dollars transferred from the purchaser 10).

The purchaser 4 has purchased clothing of 130 dollars for the first period of time of order calculation, and that is, the 130 dollars are just the amount corresponding to 41.9% of the purchase amount (310 dollars) of the purchaser 3. In this case, however, a cyber money profit rate to the purchase amount of the purchaser 4 is 11.07%, which is higher than the cyber money profit rate to the purchase amount of the purchaser 3 of 7.80%. The purchaser 7 has purchased clothing of 28 dollars for the first period of time of order calculation, and that is, the 28 dollars are just the amount corresponding to 9.2% of the purchase amount (305.00 dollars) of the purchaser 8. In this case, however, a cyber money profit rate to the purchase amount of the purchaser 7 is 7.81%, which is higher than the cyber money profit rate to the purchase amount of the purchaser 8 of 4.43%. Therefore, the product sales promotion system according to an implementation of the disclosed technology has different structures and effects from the conventional point saving system in which points proportional to purchase amounts are simply saved. Under the product sales promotion system according to an implementation of the disclosed technology, even if the purchaser purchases the products with a relatively low purchase amount, his or her cyber money profit rate to the purchase amount can be higher than other purchasers.

Through such exceptionality of the cyber money profit rate to the purchase amount, even the low-order purchasers in the distribution order hope that they will have the cyber money profit rate to the purchase amount higher than the priority members and also their distribution order will be raised, so that the purchase of all of the purchasers who are in the distribution order can be promoted.

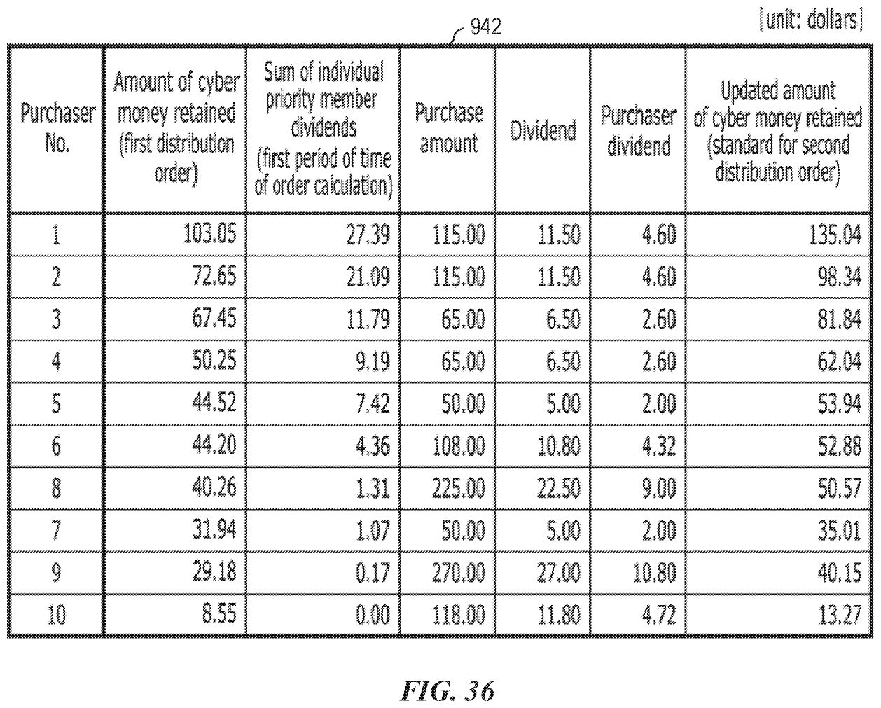

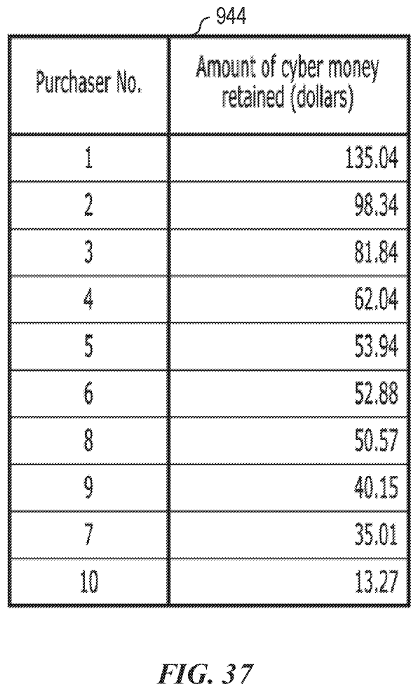

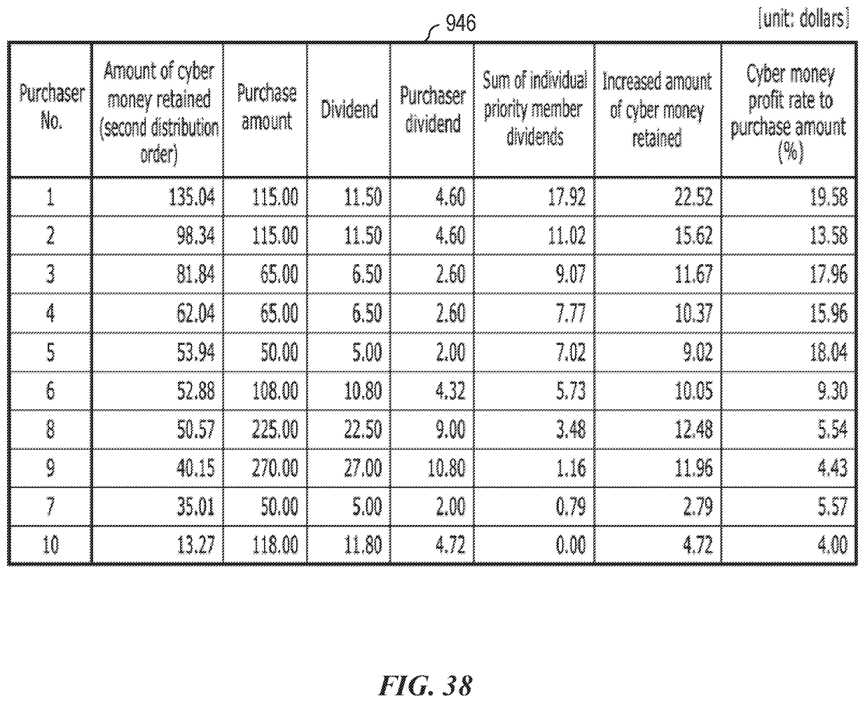

FIG. 36 is an exemplary table showing the purchaser dividends transferred to the purchasers for a second period of time of order calculation and the amounts of cyber money retained updated on the basis of the sum of individual priority member dividends for the first period of time of order calculation and the purchaser dividends for the second period of time of order calculation, which will be a standard for the second distribution order. FIG. 37 is an exemplary table showing the second distribution order. FIG. 38 is an exemplary table showing amounts transferred to the purchasers and profit rates of the purchasers for the second period of time of order calculation.

In the first distribution order, the amount of cyber money of the purchaser 7 is 31.94 dollars and that of the purchaser 9 is 29.18 dollars, and accordingly, the first distribution order of the purchaser 7 is higher than that of the purchaser 9. Through the sum of individual priority member dividends for the first period of time of order calculation and the purchaser dividends for the second period of time of order calculation, the amount of cyber money of the purchaser 7 is 35.01 dollars and that of the purchaser 9 is 40.15 dollars, so that the purchaser 9 is higher than the purchaser 7 in the second distribution order as a dividend distribution standard for the second period of time of order calculation.

The purchaser 5 has purchased clothing of 50.00 dollars for the second period of time of order calculation, and that is, the 50.00 dollars are just the amount corresponding to 43.5% of the purchase amount of 115.00 dollars of the purchaser 2. In this case, however, a cyber money profit rate to the purchase amount of the purchaser 5 is 18.04%, which is higher than the cyber money profit rate to the purchase amount of the purchaser 2 of 13.58%. Also, the purchaser 3 has purchased clothing of 65.00 dollars for the second period of time of order calculation, and that is, the 65.00 dollars are just the amount corresponding to 56.5% of the purchase amount of 115.00 dollars of the purchaser 2. In this case, however, a cyber money profit rate to the purchase amount of the purchaser 3 is 17.96%, which is higher than the cyber money profit rate to the purchase amount of the purchaser 2 of 13.58%. It can be appreciated again that under the product sales promotion system according to an implementation of the disclosed technology, therefore, even if the purchaser purchases the products with a relatively low purchase amount, his or her cyber money profit rate to the purchase amount can be higher than other purchasers.

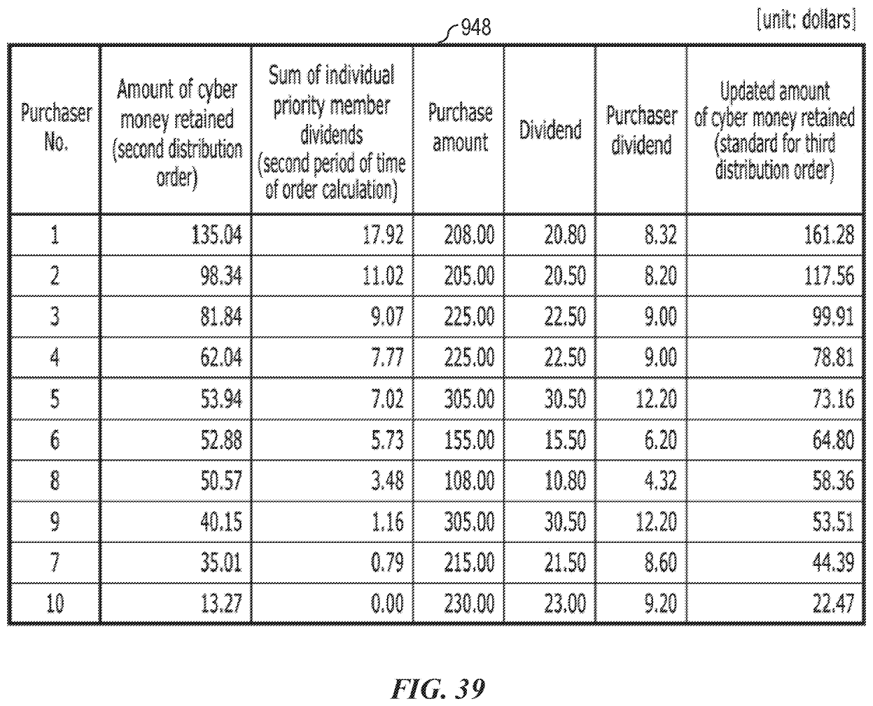

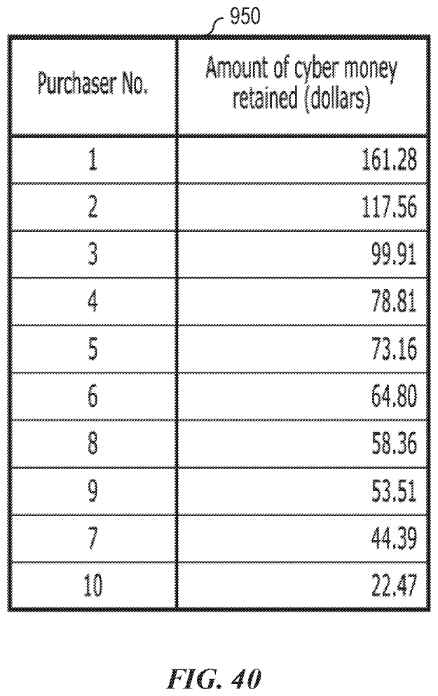

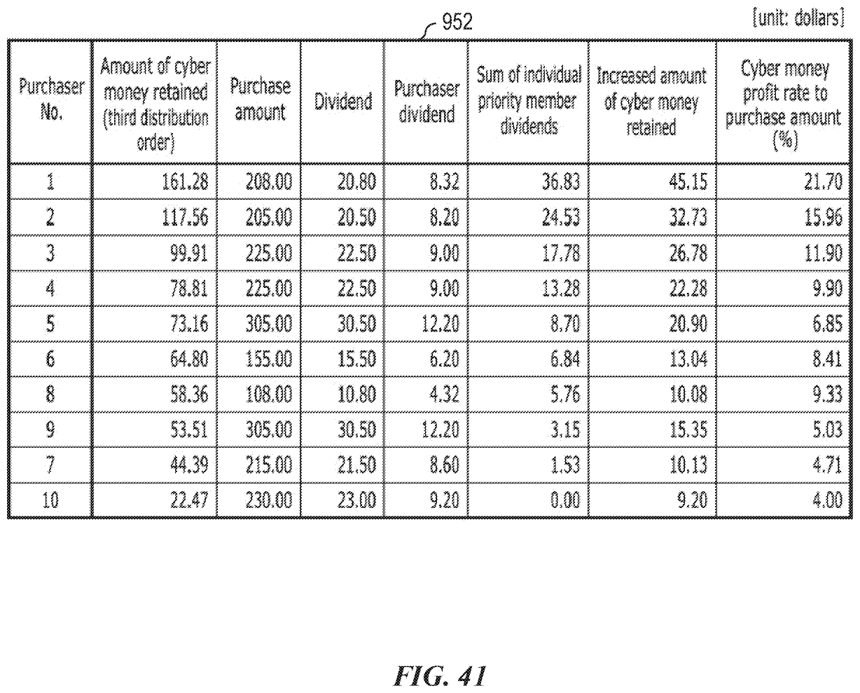

FIG. 39 is an exemplary table showing the purchaser dividends transferred to the purchasers for a third period of time of order calculation and the amounts of cyber money retained updated on the basis of the sum of individual priority member dividends for the second period of time of order calculation and the purchaser dividends for the third period of time of order calculation, which will be a standard for the third distribution order. FIG. 40 is an exemplary table showing the third distribution order. FIG. 41 is an exemplary table showing amounts transferred to the purchasers and profit rates of the purchasers for the third period of time of order calculation.

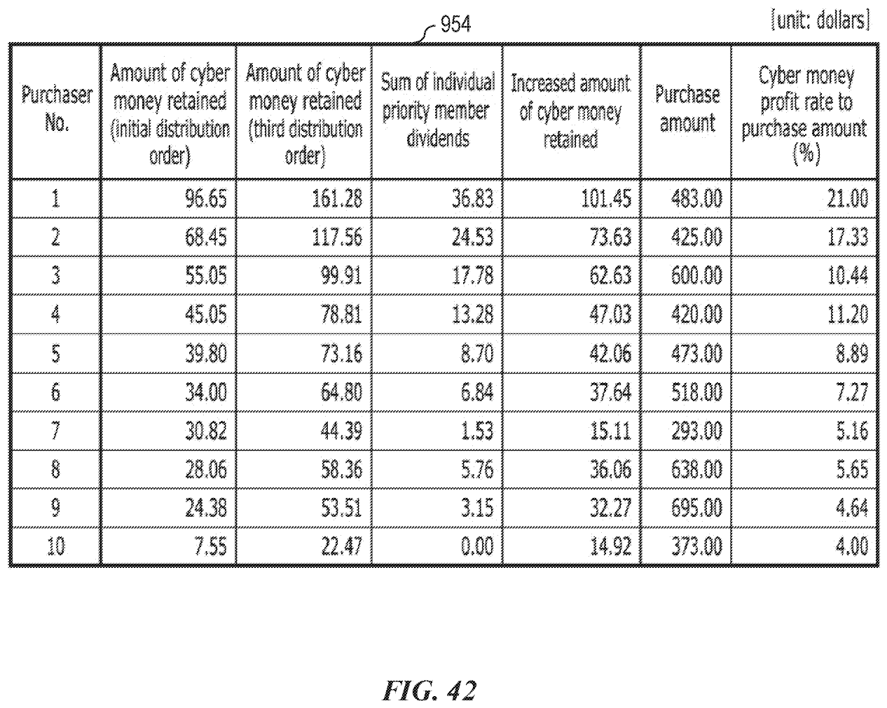

FIG. 42 is an exemplary table showing cyber money profit rates to the purchase amounts of the purchasers during an event.

While the purchaser 1 is retaining the cyber money of 96.65 dollars before the event, he or she purchases 9 pieces of clothing at the lowest online price of 483.00 dollars during the event for three days, so that additionally, the cyber money of the purchaser 1 is increased to 101.45 dollars. The cyber money profit rate to the purchase amount of the purchaser 1 is 21.00%. It can be also checked that the amounts of cyber money of other purchasers are increased. With a payment of the withdrawal fee, the cyber money may be transferred to the cash account from the cyber money account in the form of cash or may be withdrawn directly from the cyber money account in the form of cash, so that the cash assets of the purchaser can be increased. Further, the distribution order of the purchaser can be upgraded by means of the amount of cyber money distributed to him or her, thereby providing a big possibility that a larger amount of dividend on another event is distributed to him or her.

If the payment of the purchaser is made through the use of an interest-free installment program provided by a credit card company, the profit of the purchaser will be maximized. If the purchaser buys 483.00 dollar clothing in the conventional purchase system, he or she must prepare 483.00 dollars, which makes him or her feel burdened so that he or she is refrained from purchasing the clothing. Through the product sales promotion system 100 of the disclosed technology, the sales price is paid in interest-free installments, and next, the installment amount may be paid with the dividend distributed to the purchaser, thereby lessening the burden of the purchaser. Such an advantage is obtained because the value of time is turned into the cyber money. Particularly, if the dividend distribution rate is raised by the seller, the amounts to be distributed to the purchasers are increased, so that the consumption will and event join will of the members become high.

The seller accomplishes a substantially larger amount of sales than an amount of sales in the past, for a short period of time, thereby obtaining a great sales profit, and even if the dividend is distributed, an amount of sales over several months to years can be obtained within the short period of time, so that no damage occurs. Also, the dividend, as a sales agency commission, is the amount paid to the system provider of the conventional system, and therefore, the seller does not have any substantial damage even if seller distributes the dividend. So as to increase the amount of sales in a short period of time, the dividend distribution rate may be selectively raised by the seller, which strongly stimulates the event join desires of the members to rapidly and reliably achieve a desired amount of product sales.

The product sales promotion system of an implementation of the disclosed technology may obtain profits with the system usage fee received from the seller when the event is activated by the seller and with the withdrawal fees received from the members when the cyber money is withdrawn from the cyber money accounts by the members. Further, if the number of events activated by numerous sellers over the world is uncountably large, the cash balance in the system account unit 150, which is obtained by the events, is kept to a very large amount of money. Therefore, a cyber money mortgage or secondary outsourcing investment may be conducted by means of the system usage fees, the withdrawal fees, and the cash balance in the system account, thereby creating great profits.

The members may withdraw the cyber money from their cyber money accounts and exchange the cyber money into the cash, or they may get a loan with their cyber money as collateral from the product sales promotion system. The members may exchange their cyber money into the cash with a payment of the withdrawal fees, but in this case, the amount of cyber money retained in the cyber money account is decreased and this may cause a disadvantage in ranking of the dividend distribution order of an event. So as to allow the member to exchange the cyber money into the cash in the state where the amount of cyber money retained is kept, the product sales promotion system may lend the cash of the system account unit to the members with the cyber money of the members as collateral. As a result, the product sales promotion system may provide a financial business.

It may be appreciated that the product sales promotion system according to an implementation of the disclosed technology provides a consuming-tech (consumption+financial technology) system that increases wealth through consumption, and as increased consumption may increase wealth, so that consumption, commercial exchange, and turnover rate are optimized to achieve significant advance in E-commerce unlike the conventional one.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve described results. Moreover, the separation of various system components in the embodiments described in this patent document should not be understood as requiring such separation in all embodiments. Only a few implementations and examples are described. Other implementations, enhancements and variations can be made based on what is described and illustrated in this patent document.

What is claimed is:

1. A sales profit distribution system for distributing a distribution profit to purchasers who purchase a product, the sales profit distribution system is configured by a computer to perform a method comprising:
(a1) receiving, from a seller, an event configuration request to configure a sales event, together with a target amount of product sales, a target period of time for the sales event and a distribution profit to be distributed to the purchasers;
(a2) activating the sales event based on the event configuration request;
(a3) receiving a payment for the product from a terminal of at least one of the purchasers;
(a4) determining, in response to receiving the payment for the product, whether sales of the product have reached the target amount of the product sales, the distribution profit to be distributed in response to a determination that the sales of the product have reached the target amount of the product sales;
(a5) transmitting, to a purchaser, a purchase confirmation request to allow the purchaser to respond with either a purchase confirmation indication or a purchase cancellation indication;
(a6) determining, in response to the purchase confirmation indication, whether sales of the product have reached to the target amount of the product sales;
(b) providing, upon a determination in the step (a6) that the sales of the product have reached to the target amount of the product sales, an individual distribution profit to the purchaser from the distribution profit.

2. The sales profit distribution system according to claim 1, wherein the computer is further configured to perform the step (b) comprising the steps of:
arranging the purchasers in an order of payment;
paying a first individual distribution profit calculated by multiplying the distribution profit by a distribution rate of the distribution profit to a first purchaser who performs an earliest payment among the purchasers; and
paying a second individual distribution profit calculated by multiplying an amount remained after subtracting the first individual distribution profit from the distribution profit by the distribution rate of the distribution profit to a second purchaser who performs a second earliest payment among the purchasers.

3. The sales profit distribution system according to claim 1, further comprising a member account storage allocated to a member who is joined in the sales profit distribution system to deposit at least one of cyber money and cash thereinto,
wherein the computer is further configured to perform the step (b) comprising the steps of:
arranging the purchasers in an order of a cyber money amount deposited into member account storage of the purchaser;
paying a first individual distribution profit calculated by multiplying the distribution profit by the distribution rate of the distribution profit to a first purchaser who has a largest cyber money amount among the purchasers; and
paying a second individual distribution profit calculated by multiplying an amount remained after subtracting the first individual distribution profit from the distribution profit by the distribution rate of the distribution profit to a second purchaser who has a second largest cyber money amount among the purchasers.

4. The sales profit distribution system according to claim 1, further comprising a member account storage allocated to a member who is joined in the sales profit distribution system to deposit at least one of cyber money and cash thereinto,
wherein the computer is further configured to perform the step (b) comprising the steps of:
arranging the purchasers in an order of a value calculated by multiplying a cyber money amount deposited into the member account storage of the purchaser by the number of the payments of the purchaser;
paying a first individual distribution profit calculated by multiplying the distribution profit by the distribution rate of the distribution profit to a first purchaser who has a largest value among the purchasers; and
paying a second individual distribution profit calculated by multiplying an amount remained after subtracting the first individual distribution profit from the distribution profit by the distribution rate of the distribution profit to a second purchaser who has a second largest value among the purchasers.

5. The sales profit distribution system according to claim 1, wherein the computer is further configured to perform the step (b) comprising the steps of:
arranging the purchasers in an order of purchase confirmation response;
paying a first individual distribution profit calculated by multiplying the distribution profit by the distribution rate of the distribution profit to a first purchaser who transmits an earliest purchase confirmation response among the purchasers; and
paying a second individual distribution profit calculated by multiplying an amount remained after subtracting the first individual distribution profit from the distribution profit by the distribution rate of the distribution profit to a second purchaser who transmits a second earliest purchase confirmation response among the purchasers.

6. A sales profit distribution method for distributing a distribution profit to purchasers who purchase a product, the method comprising the steps of:
(a1) receiving, from a seller, an event configuration request to configure a sales event, together with a target amount of product sales, a target period of time for the sales event and a distribution profit to be distributed to the purchasers;
(a2) activating the sales event based on the event configuration request:
(a3) receiving a payment for the product from a terminal of at least one of the purchasers;
(a4) determining, in response to receiving the payment for the product, whether sales of the product have reached the target amount of the product sales, the distribution profit to be distributed in response to a determination that the sales of the product have reached the target amount of the product sales;
(a5) transmitting, to a purchaser, a purchase confirmation request to allow the purchaser to respond with either a purchase confirmation indication or a purchase cancellation indication;
(a6) determining, in response to the purchase confirmation indication, whether sales of the product have reached to the target amount of the product sales;
(b) providing, upon a determination in the step (a6) that the sales of the product have reached to the target amount of the product sales, an individual distribution profit to the purchaser from the distribution profit.

7. The sales profit distribution method according to claim 6, wherein the step (b) comprises the steps of:
arranging the purchasers in an order of payment;
paying a first individual distribution profit calculated by multiplying the distribution profit by a distribution rate of the distribution profit to a first purchaser who performs an earliest payment among the purchasers; and
paying a second individual distribution profit calculated by multiplying an amount remained after subtracting the first individual distribution profit from the distribution profit by the distribution rate of the distribution profit to a second purchaser who performs a second earliest payment among the purchasers.

8. The sales profit distribution method according to claim 6, wherein the step (b) comprises the steps of:
arranging the purchasers in an order of a cyber money amount deposited into member account storage of the purchaser;
paying a first individual distribution profit calculated by multiplying the distribution profit by the distribution rate of the distribution profit to a first purchaser who has a largest cyber money amount among the purchasers; and
paying a second individual distribution profit calculated by multiplying an amount remained after subtracting the first individual distribution profit from the distribution profit by the distribution rate of the distribution profit to a second purchaser who has a second largest cyber money amount among the purchasers.

9. The sales profit distribution method according to claim 6, wherein the step (b) comprises the steps of:
arranging the purchasers in an order of a value calculated by multiplying a cyber money amount deposited into the member account storage of the purchaser by the number of the payments of the purchaser;
paying a first individual distribution profit calculated by multiplying the distribution profit by the distribution rate of the distribution profit to a first purchaser who has a largest value among the purchasers; and
paying a second individual distribution profit calculated by multiplying an amount remained after subtracting the first individual distribution profit from the distribution profit by the distribution rate of the distribution profit to a second purchaser who has a second largest value among the purchasers.

10. The sales profit distribution method according to claim 6, wherein the step (b) comprises the steps of:
arranging the purchasers in an order of purchase confirmation response;
paying a first individual distribution profit calculated by multiplying the distribution profit by the distribution rate of the distribution profit to a first purchaser who transmits an earliest purchase confirmation response among the purchasers; and
paying a second individual distribution profit calculated by multiplying an amount remained after subtracting the first individual distribution profit from the distribution profit by the distribution rate of the distribution profit to a second purchaser who transmits a second earliest purchase confirmation response among the purchasers.
